(19) United States
(12) Patent Application Publication
(10) Pub. No.: US 2024/0165624 A1
(43) Pub. Date: May 23, 2024

(54) MICROFLUIDICS SYSTEMS, DEVICES, AND METHODS

(71) Applicant: PLENO, INC., San Diego, CA (US)

(72) Inventors: Pieter VAN ROOYEN, San Diego, CA (US); Lorenzo BERTI, San Diego, CA (US); Jeffrey BRODIN, San Diego, CA (US); Michael POLLACK, San Diego, CA (US)

(21) Appl. No.: 18/359,237

(22) Filed: Jul. 26, 2023

Related U.S. Application Data
(63) Continuation of application No. PCT/US2022/014036, filed on Jan. 27, 2022.
(60) Provisional application No. 63/142,032, filed on Jan. 27, 2021.
(60) Provisional application No. 63/142,037, filed on Jan. 27, 2021.
(60) Provisional application No. 63/144,759, filed on Feb. 2, 2021.
(60) Provisional application No. 63/147,626, filed on Feb. 9, 2021.
(60) Provisional application No. 63/147,639, filed on Feb. 9, 2021.
(60) Provisional application No. 63/152,008, filed on Feb. 22, 2021.
(60) Provisional application No. 63/157,871, filed on Mar. 8, 2021.
(60) Provisional application No. 63/162,047, filed on Mar. 17, 2021.
(60) Provisional application No. 63/173,953, filed on Apr. 12, 2021.
(60) Provisional application No. 63/173,963, filed on Apr. 12, 2021.
(60) Provisional application No. 63/188,440, filed on May 13, 2021.
(60) Provisional application No. 63/224,383, filed on Jul. 21, 2021.
(60) Provisional application No. 63/224,397, filed on Jul. 21, 2021.
(60) Provisional application No. 63/241,155, filed on Sep. 7, 2021.

(51) Int. Cl. B01L 3/00; G01N 27/414

(52) U.S. Cl. CPC B01L 3/502792; G01N 27/4146; G01N 27/4148; B01L 2300/0645; B01L 2300/0829; B01L 2300/0893; B01L 2300/0896; B01L 2300/161; B01L 2400/0427

(57) ABSTRACT

A droplet manipulation device comprising, which may, for example, include (a) a first substrate having a first layer comprising a first array of electrowetting electrodes, and a second layer atop a region of the first layer comprising a second array of electrowetting electrodes; and (b) a second substrate separated from the first substrate forming a droplet operations gap between the first and second substrates.

### CROSS-REFERENCE TO RELATED PATENT APPLICATIONS

This application is a continuation application of International Application No. PCT/US2022/014036, filed Jan. 27, 2022, which claims priority to U.S. Provisional Applications. Nos. 63/142,032, filed on Jan. 27, 2021; 63/142,037, filed on Jan. 27, 2021, 63/144,759, filed on Feb. 2, 2021, 63/147,626, filed on Feb. 9, 2021, 63/147,639, filed on Feb. 9, 2021; 63/152,008, filed on Feb. 22, 2021, 63/157,871, filed on Mar. 8, 2021; 63/162,047, filed on Mar. 17, 2021; 63/173,953, filed on Apr. 12, 2021; 63/173,963, filed on Apr. 12, 2021, 63/188,440, filed on May 13, 2021, 63/224,383, filed on Jul. 21, 2021, 63/224,397, filed on Jul. 21, 2021; 63/241,155, filed on Sep. 7, 2021, all of which are incorporated by reference herein.

### FIELD OF THE INVENTION

The disclosure provides microfluidics systems, devices, and methods for preparing and assaying analytes.

### BACKGROUND OF THE INVENTION

Microfluidic systems and devices are used in a variety of applications to manipulate, process and/or analyze analytes, such as biological analytes. There is a need in the art for microfluidic systems and devices that are capable of processing and/or assaying large numbers of analytes.

### BRIEF DESCRIPTION OF DRAWINGS

FIG. 1 is a block diagram of an example of a microfluidics system including a sample partitioning process for bioanalysis.

FIG. 2 is a block diagram of an example of a droplet operations device and system including a sample partitioning process for bioanalysis.

FIG. 3A and FIG. 3B are a plan view and a cross-sectional view of an example of a DMF structure on which the droplet operations device may be based.

FIG. 4, FIG. 5, FIG. 6, FIG. 7, and FIG. 8 illustrate plan views of examples of nanowell arrays for sample partitioning.

FIG. 9 shows a plan view of an example of an electrode arrangement including a nanowell array for use in a sample partitioning process.

FIG. 10A, FIG. 10B, and FIG. 10C are plan views of an example of using the electrode arrangement and nanowell array shown in FIG. 9.

FIG. 11A, FIG. 11B, FIG. 11C, and FIG. 11D are plan views of another example of using the electrode arrangement and nanowell array shown in FIG. 9.

FIG. 12A, FIG. 12B, and FIG. 12C are plan views of yet another example of using the electrode arrangement and nanowell array shown in FIG. 9.

FIG. 13 is a plan view of another example of an electrode arrangement including a nanowell array for use in a sample partitioning process.

FIG. 14A, FIG. 14B, FIG. 14C, and FIG. 14D are plan views of an example of using the electrode arrangement and nanowell array shown in FIG. 13.

FIG. 15 is a plan view of an example of an electrode arrangement including a nanowell array arranged within a single droplet operations electrode.

FIG. 16A, FIG. 16B, and FIG. 16C show plan views of an example of using the electrode arrangement and nanowell array shown in FIG. 15.

FIG. 17 is a plan view of another example of an electrode arrangement including a nanowell array arranged within a single droplet operations electrode.

FIG. 18A through FIG. 18F are side views of a of a droplet operations device and an example of a process of using a nanowell array in a sample partitioning process.

FIG. 19 is a flow diagram of an example of a method of using nanowell arrays for sample partitioning in the microfluidics system.

FIG. 20 is a plan view of an example of a of a nanowell array during optical detection operations.

FIG. 21A and FIG. 21B illustrate cross-sectional views of a of a nanowell array and showing more details thereof.

FIG. 22 is a plan view of an example of an electrode arrangement including multiple nanowell arrays.

FIG. 23A is a plan view of an example of an electrode arrangement including a nanopost array for use in a sample partitioning process.

FIG. 23B is a top view and side view of a of the nanopost array shown in FIG. 23A.

FIG. 24 is a top view and side view of an example of using the nanopost array shown in FIG. 23A and FIG. 23B.

FIG. 25 is a side view of an example of a of a nano-array that includes both hydrophilic nanowells and hydrophilic nanoposts.

FIG. 26A and FIG. 26B are a side view and a plan view of a of the droplet operations device and an example of a nanowell array installed in the top substrate.

FIG. 27A, FIG. 27B, and FIG. 27C show plan views of other configurations of nanowell arrays and/or nanopost arrays.

FIG. 28A, FIG. 28B, and FIG. 28C illustrate plan views of an example of an electrode arrangement including an example of hydrophilic wicking features in relation to nanowell arrays.

FIG. 29A through FIG. 30B are views of examples of other hydrophilic guiding and/or wicking features in relation to nanowell arrays.

FIG. 31A and FIG. 31B are a top view and a side view of an example of a vacuum source arranged in relation to a nanowell array.

FIG. 32 is a simplified block diagram of an example of a POC instrument for processing consumable DMF cartridges (or devices) that may be used for processes of partitioning samples for bioanalysis.

FIG. 33 is a flow diagram of an example of a sample-to-answer workflow that may be performed on POC instrument shown in FIG. 32.

FIG. 34 and FIG. 35 are plan views of examples of a CMOS DMF device of the microfluidics system.

FIG. 36 is a block diagram of an example of the microfluidics system including a DMF flip-chip cartridge.

FIG. 37 is a side view of a of an example of a DMF flip-chip cartridge.

FIG. 38A and FIG. 38B are a plan view and a cross-sectional view another example of a DMF flip-chip cartridge and wherein the DMF flip-chip cartridge includes one top substrate.

FIG. 39 is a side view of a Detail A of FIG. 38A and FIG. 38B and showing more details of the transition of the DMF flip-chip cartridge from the bulk DMF to the DMF operations of the DMF flip-chip.

FIG. 40A and FIG. 40B are a plan view and a cross-sectional view showing more details of yet another example of a DMF flip-chip cartridge and wherein the DMF flip-chip cartridge includes two top substrates.

FIG. 41 is a schematic diagram of an example of a hypercoded padlock probe that may be performed using the microfluidics systems.

FIG. 42 is a perspective view of an example of a simplified well loading process using DMF and coding that may be performed using the microfluidics systems.

FIG. 43A is a schematic diagram of an example of standardized coding biochemistry.

FIG. 43B is a schematic diagram of an example of an end-to-end digital counting process.

FIG. 44 is a block diagram of an example of a visual software toolkit that may be used in an assay development environment of the microfluidics systems.

FIG. 45 is schematic diagrams comparing a standard dPCR droplet assay with a DMF-based assay that may be performed using the microfluidics systems.

FIG. 46 is a schematic diagram of an example of a CNV detection process that may be performed using the microfluidics systems.

FIG. 47 is a schematic diagram of an example of a standard mmPCR-NGS assay.

FIG. 48 is a schematic diagram of an example of an equivalent DMF-based assay that may be performed using the microfluidics systems.

FIG. 49A and FIG. 49B are schematic diagrams of an example, of a molecular sensor of the microfluidics system.

FIG. 50A and FIG. 50B are schematic diagrams showing an example of a process of using the molecular sensor shown in FIG. 49A and FIG. 49B.

FIG. 51 is a plan view of an example of an electrode configuration that may include an arrangement of droplet operations electrodes with respect to a single molecular sensor.

FIG. 52 is a plan view of an example of an electrode configuration that may include an arrangement of droplet operations electrodes with respect to an array of molecular sensors.

FIG. 53 is a plan view of an example of an electrode configuration that may include a single molecular sensor arranged with respect to a single droplet operations electrode.

FIG. 54 is a plan view of an example of an electrode configuration that may include an array of molecular sensors arranged with respect to a single droplet operations electrode.

FIG. 55 is a plot showing an example of the electrical response of a molecular sensor in a process of detecting a methylation marker (e.g., methylated cytosine) in a targeted DNA sequence as described with reference to FIG. 50A and FIG. 50B.

FIG. 56 is a flow diagram of an example of a methylation analysis workflow for determining the methylation status of a DNA sample using the molecular sensors of the microfluidics system.

FIG. 57A and FIG. 57B are side views comparing the topology of PCB technology with active-matrix technology.

FIG. 58 is a plan view and a side view of an example of a droplet operations device including both a PCB-based DMF and an active matrix-based DMF portion.

FIG. 59 is a cross-sectional view taken along ling A-A of the droplet operations device shown in FIG. 58.

FIG. 60 is a flow diagram of an example of a method of using the microfluidics system and droplet operations device including active-matrix technology for improved reliability and performance.

FIG. 61 is a plan view of an example of a CMOS-based sensor integrated with a droplet operations device, and

FIG. 62A, FIG. 62B, and FIG. 62C illustrate side views of example methods of integrating a droplet operations device and a CMOS sensor.

### SUMMARY OF THE INVENTION

The disclosure provides a droplet manipulation device. The droplet manipulation device may include a first substrate. The first substrate may include a first layer including a first array of electrowetting electrodes. The first substrate may include a second layer atop a region of the first layer including a second array of electrowetting electrodes. The droplet manipulation device may include a second substrate separated from the first substrate forming a droplet operations gap between the first and second substrates.

In certain embodiments, the first layer includes a printed circuit board. In certain embodiments, the second layer includes a semiconductor layer. In certain embodiments, the first layer includes a printed circuit board, and the second layer includes a semiconductor layer. In certain embodiments, the semiconductor layer includes a CMOS layer.

The first gap height may, for example, range from about 200 μm to about 1600 μm. In other embodiments, the first gap height may range from about 250 μm to about 350 μm. In other embodiments, the first gap height may be about 300 μm.

The second gap height may, for example, range from about 100 to about 200 μm. In other embodiments, the second gap height may range from about 125 to about 175 μm. In other embodiments, the second gap height may be about 150 μm.

In certain embodiments, the electrowetting electrodes of the first layer are larger than the electrowetting electrodes of the second layer. In certain embodiments, the electrowetting electrodes of the first layer are at least about 1.5 times larger than the electrowetting electrodes of the second layer. In certain embodiments, the electrowetting electrodes of the first layer are at least about 1.75 times larger than the electrowetting electrodes of the second layer. In certain embodiments, the electrowetting electrodes of the first layer are at least about 2 times larger than the electrowetting electrodes of the second layer.

In certain embodiments, the electrowetting electrodes of the first layer include thin-film transistors.

In certain embodiments, the electrowetting electrodes of the first layer are arranged to permit electrowetting-mediated transport of a droplet on the first layer into sufficient proximity with the second layer that the electrowetting electrodes of the second layer are capable of conducting electrowetting mediated droplet operations using the droplet or a portion of the droplet. In certain embodiments, the electrowetting electrodes of the first layer are arranged to permit electrowetting-mediated transport of a droplet on the first layer into contact with the second layer.

In certain embodiments, the CMOS layer includes an array of nanofeatures.

In some cases, the nanofeatures are selected from the group consisting of indentations, wells, protrusions, domes, posts, beads, beads-in-wells, spots, hydrophilic spots, and combinations of any of the foregoing. In some cases, the nanofeatures include nanowells. In some cases, the array of nanofeatures includes an array of nanoposts overlapping an array of nanowells.

In certain embodiments, the array of nanofeatures includes one or more hydrophilic guiding and/or wicking features arranged to assist transporting aqueous media from the array of nanowells. In certain embodiments, the array of nanofeatures includes at least 1,000 of the nanofeatures. In certain embodiments, the array of nanofeatures includes at least 10,000 of the nanofeatures. In certain embodiments, the array of nanofeatures includes at least 100,000 of the nanofeatures. In certain embodiments, the array of nanofeatures includes at least 1 million of the nanofeatures.

In various embodiments, the nanofeatures include wells, and each of the wells is capable of holding from about one femtoliter to about 10 picoliters of liquid. In certain embodiments, each of the nanofeatures is associated with a sensor fabricated in the second layer with a corresponding one or more of the nanofeatures.

In various embodiments, the nanofeatures include wells, and each of the wells is associated with a sensor fabricated in the second layer with a corresponding one or more of the nanofeatures.

The disclosure provides method of conducting a droplet operation. The method may include providing the droplet manipulation device described herein. The method may include conducting droplet operations using the first array of electrowetting electrodes to provide a droplet into contact with the second layer and conducting droplet operations using the second array of electrowetting electrodes to dispense a sub-droplet from the droplet atop the second layer.

The disclosure provides a method of partitioning a droplet. The method may include providing the droplet manipulation device described herein. The method may include conducting droplet operations using the first array of electrowetting electrodes to provide a droplet into contact with the second layer and conducting droplet operations using the second array of electrowetting electrodes to provide a sub-droplet of the droplet atop the second layer and associate an aliquot of the droplet with each of the nanofeatures. The method may include transporting the sub-droplet away from the second layer. The method may include using electrowetting-mediated droplet operations mediated by the first array of electrowetting electrodes to transport the sub-droplet away from the second layer.

In certain embodiments, the droplet is a sample droplet. The sample droplet may include more target analytes. In some cases, at least a subset of the aliquots each includes a single of the targeted analyte molecule. In some cases, the analyte molecule is a nucleic acid molecule. In some cases, the analyte is a cell. In some cases, at least a subset of the aliquots each includes a single one of the targeted cells.

In certain embodiments, the first array of electrowetting electrodes is operated at a higher voltage than a voltage used to operate the second array of electrowetting electrodes. In certain embodiments, the second array of electrowetting electrodes is controlled to conduct the droplet operations using an active matrix combined with passive controls.

The disclosure provides a molecular sensor for direct detection of a single molecule target. The molecular sensor may include a first contact electrically coupled to a first electrode. The molecular sensor may include a second contact electrically coupled to a second electrode. The first and second electrodes may be separated by a sensor gap and the sensor gap may be spanned by a bridge molecule such that interaction of the bridge molecule with the targeted single molecule generates a detectable electrical signal.

In certain embodiments, the substrate surface is a substrate surface of a digital microfluidic device. In certain embodiments, the substrate includes a silicon substrate including integrated microelectronics.

In certain embodiments, the substrate further includes an arrangement of droplet operations electrodes arranged to permit droplet operations to deliver by electrowetting based droplet operations sample and/or reagent droplets to the molecular sensor for analysis.

In certain embodiments, the first and second electrodes are formed of metal selected from the list consisting of: platinum, palladium, rhodium, gold, or titanium.

In certain embodiments, the sensor gap has a gap height ranging from about 5 nm to about 30 nm.

In certain embodiments, the bridge molecule includes a protein. In certain embodiments, the protein includes an alpha helix protein. In certain embodiments, the protein is attached to the first and second contacts through an antigen-antibody linkage. In certain embodiments, the protein is attached to the first and second contacts through streptavidin-biotin linkage.

In certain embodiments, the bridge molecule includes a biopolymer. In certain embodiments, the biopolymer includes double-stranded DNA. In certain embodiments, the double-stranded DNA is attached to the first and second contacts through a thiol-gold linkage.

In some cases, the bridge molecule further includes a probe molecule that is specific for the targeted single molecule. In some cases, the probe molecule includes a molecule that exhibits a change in physical, chemical, and/or electrical properties in response to binding the single molecule target. In some cases, the probe molecule is attached to the bridge molecule through a streptavidin-biotin linkage. In some cases, the probe molecule is a single-stranded nucleic acid molecule. In some cases, the nucleic acid molecule is a single-stranded DNA molecule.

In certain embodiments, at least 1,000 of the molecular sensors configured for performing a multiplexed detection assay. In certain embodiments, at least 1,000 of the molecular sensors configured for performing a multiplexed detection assay. In certain embodiments, at least 10,000 of the molecular sensors configured for performing a multiplexed detection assay. In certain embodiments, at least 100,000 of the molecular sensors configured for performing a multiplexed detection assay. In certain embodiments, at least 1,000,000 of the molecular sensors configured for performing a multiplexed detection assay.

The disclosure provides a method of detecting a single molecule. The method may include providing a molecular sensor as described herein. The method may include introducing a sample droplet potentially including the single molecule target of interest to the molecular sensor, wherein interaction of the single molecule target and the bridge molecule of the molecular sensor generates a detectable change in an electrical characteristic of the molecular sensor. The method may include measuring a change in an electrical characteristic of the molecular sensor to determine the presence of the single molecule target.

In certain embodiments, detecting the single molecule target in the sample droplet further includes determining the presence or absence of a modification to the single molecule target. In certain embodiments, the single molecule target is a DNA molecule. In certain embodiments, the DNA molecule is a cfDNA molecule. In certain embodiments, the modification includes a methylated cytosine.

In certain embodiments, determining the presence or absence of a modification to the single molecule target includes introducing a reagent droplet including a methylation-specific probe, wherein interaction of the methylation-specific probe and the DNA molecule on the molecular sensor generates a detectable change in an electrical characteristic of the molecular sensor, and measuring a detectable change in an electrical characteristic of the molecular sensor that is generated from the interaction of the methylation-specific probe and the DNA molecule to determine the presence of the modified nucleotide.

### DETAILED DESCRIPTION OF THE INVENTION

### 6.1. Definitions

“A,” “an” and “the” include their plural forms unless the context clearly dictates otherwise.

“About” means approximately, roughly, around, or in the region of. When “about” is used with a numerical range, it modifies that range by extending the boundaries above and below the numerical values indicated. “About” can modify a numerical value above and below the stated value by a variance of, e.g., 10 percent up or down (higher or lower).

“Activate,” with reference to one or more electrodes, means affecting a change in the electrical state of the one or more electrodes which, in the presence of a droplet, results in a droplet operation.

“Droplet Actuator” means a fluid handling device for use in manipulating droplets. Examples include electrowetting devices, dielectrophoresis devices, robotics devices, microfluidics devices, and manual devices for manipulating droplets.

“Features or nanofeatures” with reference to the CMOS detector, may be any arrayed topographical feature, including without limitation, indentations, wells, protrusions, domes, posts, beads, beads-in-wells, spots, hydrophilic spots, etc. Features may be nano-sized, such as nanowells.

“Droplet operation” means any manipulation of a droplet on or by a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. “Electrically connected,” “electrical connection,” “electrically coupled,” and the like are intended to refer to a connection that is capable of transmitting electricity, e.g., a wired connection.

“Electronically connected,” “electronic connection,” “electronically coupled” and the like are intended to include both wired and wireless connections, including without limitation connections that are capable of transmitting data signals, e.g., electrical signals, electromagnetic signals, and optical signals. A component electronically coupled to another component may located together, e.g., in a common device or instrument, or in the same room or facility, or may be located separately and electronically connected via a network. Similarly, an “electronic signal” means any signal, whether transmitted electrically, optically or wirelessly.

“Filler fluid” means a fluid associated with a droplet operations substrate of a droplet actuator, which fluid is sufficiently immiscible with a droplet phase to render the droplet phase subject to electrode-mediated droplet operations.

“Include,” “including,” and the like are to be construed in an inclusive sense as opposed to an exclusive or exhaustive sense; that is to say, in the sense of “including, but not limited to.”

“Invention,” “the invention” and the like are intended to refer to various embodiments or aspects of subject matter disclosed herein and are not intended to limit the invention to the specific embodiments or aspects of the invention referred to.

“Linked” with respect to two nucleic acids means not only a fusion of a first moiety to a second moiety at the C-terminus or the N-terminus, but also includes insertion of the first moiety to the second moiety into a common nucleic acid. Thus, for example, the nucleic acid A may be linked directly to nucleic acid B such that A is adjacent to B (-A-B-), but nucleic acid A may be linked indirectly to nucleic acid B, by intervening nucleotide or nucleotide sequence C between A and B (e.g., -A-C-B- or -B-C-A-). The term “linked” is intended to encompass these various possibilities.

“On” or “loaded on” with respect to a droplet on a droplet actuator indicates that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

“Optimum,” “optimal,” “optimize” and the like are not intended to limit the invention to the absolute optimum state of the aspect or characteristic being optimized but will include improved but less than optimum states.

“Reservoir” means an enclosure or partial enclosure configured for holding, storing, or supplying liquid. A droplet actuator may include reservoirs. For example, a pipette tip or feature on a multiwell plate may be a reservoir. An electrowetting device may include reservoirs, which may be on or off-cartridge reservoirs.

“Sample” means a source of target or analyte. Examples of samples include biological samples, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes.

“Set” includes sets of one or more elements or objects. A “subset” of a set includes any number elements or objects from the set, from one up to all of the elements of the set.

“Subject” includes any mammal, including without limitation, humans.

“Target” with respect to a nucleic acid includes wild-type and mutated nucleic acid sequences, including for example, point mutations (e.g., substitutions, insertions and deletions), chromosomal mutations (e.g., inversions, deletions, duplications), and copy number variations (e.g., gene amplifications). “Target” with respect to a polypeptide includes wild-type and mutated polypeptides of any length, including proteins and peptides.

“Washing” with respect to washing a surface, such as a hydrophilic surface, means reducing the amount and/or concentration of one or more substances in contact with the surface or exposed to the surface from a droplet in contact with the surface. The reduction in the amount and/or concentration of the substance may be partial, substantially complete, or even complete. The substance may be any of a wide variety of substances; examples include target substances for analysis, and unwanted substances, such as components of a sample, contaminants, and/or excess reagent or buffer. Examples of bead washing protocols are set forth in U.S. Pat. No. 8,637,324, entitled “Bead incubation and washing on a droplet actuator,” issued on 2014 Jan. 28, the entire disclosure of which is incorporated herein by reference.

Headings are included herein for reference and to aid in locating the various sections. These headings are not intended to limit the scope of the concepts described with respect to the headings.

The description and examples should not be construed as limiting the scope of the invention to the embodiments and examples described herein, but as encompassing all modifications and alternatives falling within the true scope and spirit of the invention.

### 6.2. Introduction

The disclosure relates to microfluidics systems, devices, and methods for processing and analyzing analytes, such as biological materials.

The disclosure provides systems, devices and methods for partitioning volumes of liquid. The volumes of liquid may, for example, be samples. The partitioned volumes of liquid may be used as input samples for assays, such as bioassays (e.g., digital PCR).

Partitioning may be accomplished using a nano-array, such as an array of nanofeatures. The nanofeatures may, for example, be detection nanofeatures. For example, indentations, wells, protrusions, domes, posts, beads, beads-in-wells, spots, or hydrophilic spots. The nanofeatures may be hydrophilic. The nanofeatures may be surrounded by hydrophobic regions. The nanofeatures may be immersed in a filler fluid, such as a hydrophobic filler fluid. The nanofeatures may be facing a droplet operations gap of a droplet actuator.

The nanofeatures may be arranged in arrays of 1,000 or more features. The nanofeatures may be arranged in arrays of 10,000 or more features. The nanofeatures may be arranged in arrays of 100,000 or more features. The nanofeatures may be arranged in arrays of 1,000,000 or more features.

The nanofeatures may include nanowells. Each hydrophilic nanowell may, for example, hold a volume of liquid ranging from about one femtoliter (e.g., about 1 μm×1 μm square or 1 μm diameter well) to about 10 picoliters (e.g., about 10 μm×10 μm square or 10 μm diameter well).

The nanofeatures may include reagents or have reagents bound to the features. For example, the nanofeatures may include PCR primers or probes. The nanofeatures may include dried reagents.

In some embodiments, the microfluidics systems, devices, and methods may use droplet operations (i.e., electrowetting) operating in a hydrophobic environment to transport an aqueous sample to an array of the hydrophilic features.

A method may include:
(1) transporting an aqueous sample across a hydrophilic nanofeature array using droplet operations;
(2) transporting the aqueous sample off the hydrophilic nanofeature array using droplet operations and/or other means;
thereby leaving behind a small-volume sample or droplet associated with each hydrophilic nanofeature.

A method may include:
(1) transporting an aqueous sample across a hydrophilic nanowell array using droplet operations;
(2) transporting the aqueous sample off the hydrophilic nanowell array using droplet operations and/or other means;
thereby leaving behind a small-volume sample or droplet in each nanowell.

A method may include displacing the aqueous sample atop the nanofeature or nanowell array with a filler fluid (e.g., silicone oil) that is immiscible with the aqueous sample.

A method may include performing an assay on the nanofeature or in the nanowell. The assay may be quantitative and/or qualitative.

A method may include using the aqueous sample to reconstitute or solubilize a dried reagent on each nanofeature or in each nanowell of the array.

The disclosure provides a droplet operations device including an array of nanofeatures or nanowells with hydrophilic guiding and/or wicking features to assist the transport of aqueous media to or from the array. For example, the aqueous media may include an aqueous sample. Following transport away from the nanofeatures or nanowells, an aliquot of the media or sample may remain in each of the nanofeatures or nanowells.

The electrowetting forces of the droplet operations electrodes and the hydrophilic forces of the nanowell array may be balanced to allow the aqueous sample to be “transported” off the nanowell array using droplet operations while at the same time leaving behind a small-volume sample or droplet at each nanowell.

The arrays of the invention may include multiple nanofeature types, e.g., two or more of the following: indentations, wells, protrusions, domes, posts, beads, beads-in-wells, spots, hydrophilic spots.

The disclosure provides molecular sensors for direct detection of single molecules.

The disclosure includes molecular sensor arrays integrated into the droplet operations device and wherein the droplet operations device provides capability to transport individual droplets to the molecular sensors for detection and analysis of the targeted single molecules.

In some embodiments, the microfluidics systems, devices, and methods may utilize a hybrid approach that combines the advantages of both printed circuit board (PCB) technology and active-matrix technology (i.e., CMOS device).

The disclosure provides a droplet operations device that includes both a PCB-based DMF and an active matrix-based DMF (i.e., CMOS device).

The disclosure provides a droplet operations device that includes a PCB-based DMF that may be used, for example, for gross fluid manipulation and sample/reagent delivery.

The disclosure provides a droplet operations device that includes an active matrix-based DMF (i.e., CMOS device) that may be used, for example, for fine fluid manipulation and execution of complex assay protocols.

The disclosure provides a droplet operations device including active-matrix technology (i.e., CMOS device) providing a droplet operations surface that may be highly planar and uniform and therefore lending well to reliable droplet operations.

The disclosure provides CMOS-based sensors integrated with a droplet operations device.

### 6.3. Microfluidics System and DMF Technology

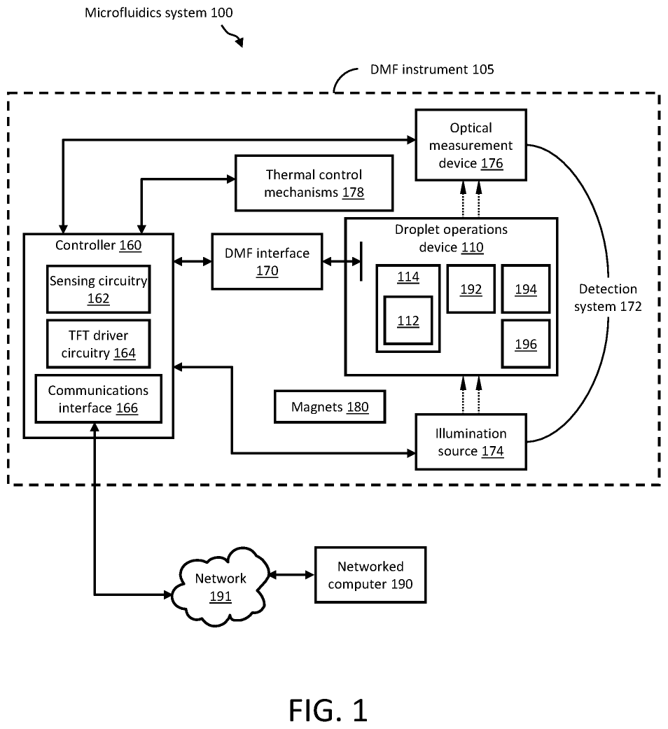

FIG. 1 is a block diagram of an example of a microfluidics system 100 for performing bioanalysis using a DMF-based sample partitioning process. Microfluidics system 100 combines DMF and droplet digital PCR for performing a sample partitioning process that yields precise quantitative PCR results.

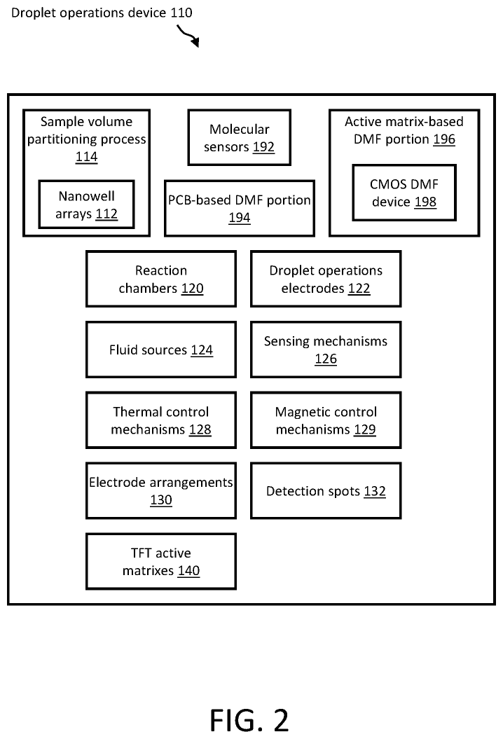

In various embodiments, the microfluidics system 100 may include a droplet operations device 110 that may support automated processes to manipulate, process and/or analyze biological materials. Droplet operations device 110 may be, for example, any DMF device or cartridge, droplet actuator, and the like that may be used to facilitate DMF capabilities for fluidic actuation. Droplet operations device 110 of microfluidics system 100 may be provided, for example, as a disposable and/or reusable DMF device or cartridge. More details of an example of droplet operations device 110 are shown and described with reference to FIG. 2.

DMF capabilities may include, but are not limited to, transporting, merging, mixing, splitting, dispensing, diluting, agitating, deforming (shaping), and other types of droplet operations. Applications of these DMF capabilities may include, for example, sample preparation and waste removal. Microfluidics system 100 and droplet operations device 110 may be used to process biological materials. However, particular to microfluidics system 100, in one example the DMF capabilities of droplet operations device 110 may be used to perform a sample partitioning process 114 using one or more nanowell arrays 112 (or microwell arrays 112), as described with reference to FIG. 2 through FIG. 48. It will be appreciated that the nanowells may be replaced with other nanofeatures.

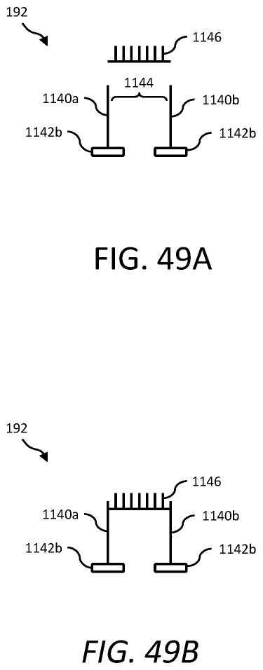

In another example, a droplet operations device 110 may be configured to perform a DMF-based process for the direct detection of single molecules using one or more arrangements of molecular sensors 192. For example, using molecular sensors 192 of droplet operations device 110, specific DNA sequences may be analyzed to determine epigenetic modifications, such as methylation of cytosine in CpG dinucleotides. Examples of molecular sensors 192 are shown and described with reference to FIG. 49A through FIG. 56.

Droplet operations device 110 may include both a PCB-based DMF 194 and an active matrix-based DMF 196. In this example, the characteristics of active matrix-based DMF 196 compared with those of PCB-based DMF 194 lend well to improved reliability and performance due to the presence of active-matrix technology in active matrix-based DMF 196.

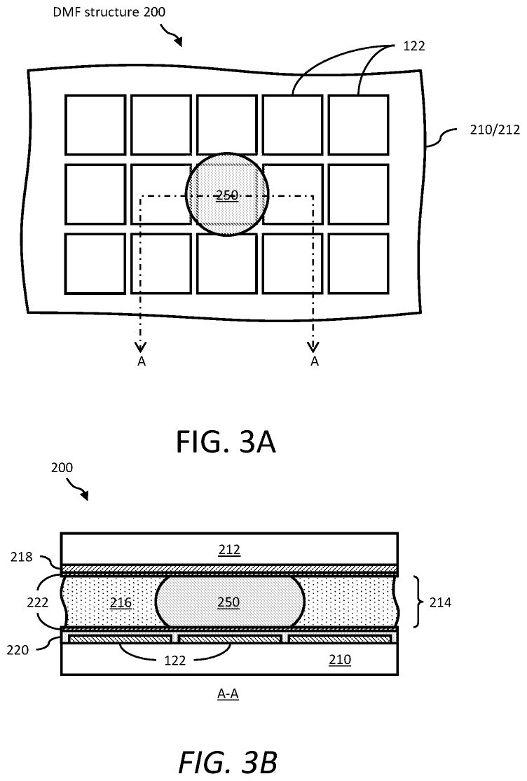

Droplet operations device 110 may combine the advantages of both active-matrix technology (e.g., a CMOS device) and PCB technology. PCB-based DMF 194 may be used for gross fluid manipulation and sample/reagent delivery while active matrix-based DMF 196 may be used for fine fluid manipulation and execution of complex assay protocols. More details of an example of droplet operations device 110 are shown and described, for example, with reference to FIG. 2 through FIG. 3.

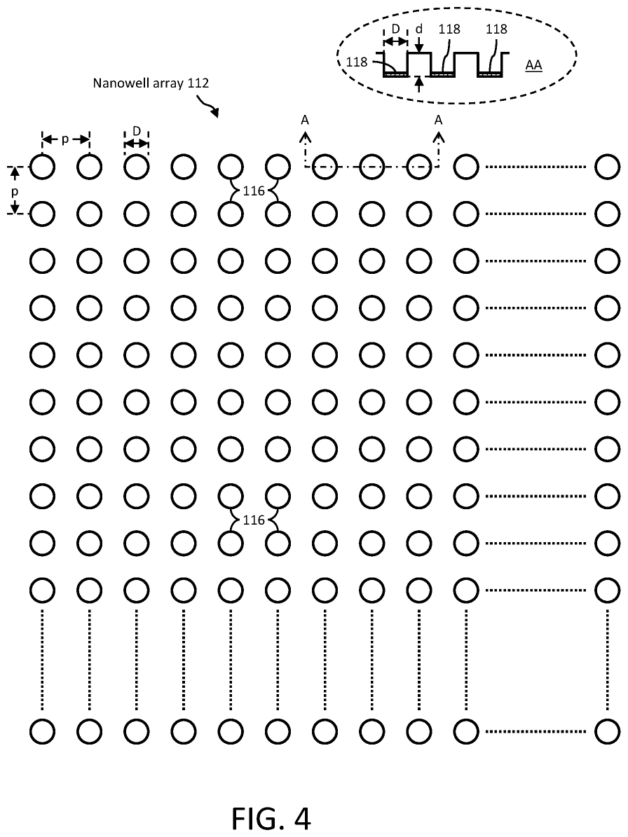

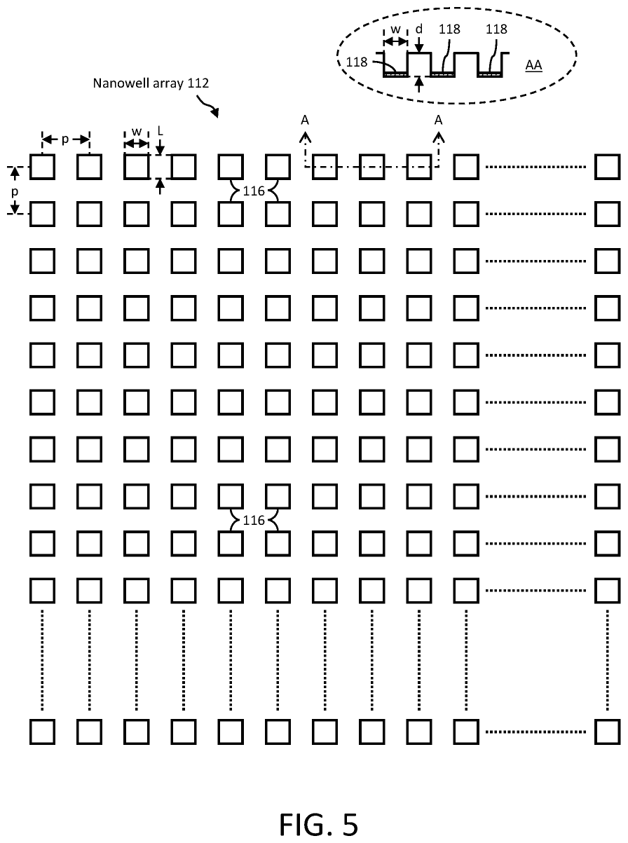

In microfluidics system 100 and/or droplet operations device 110, each of the one or more nanowell arrays 112 is an array of hydrophilic nanowells arranged with respect to the droplet operations gap in the otherwise hydrophobic environment of droplet operations device 110. Each of the nanowell arrays 112 may include, for example, from about thousands, tens of thousands, hundreds of thousands or even more than a million hydrophilic nanowells 116 (or microwells 116), as shown for example in FIG. 4 through FIG. 8. Each hydrophilic nanowell 116 may hold a volume of liquid from, for example, about one femtoliter to about 10 picoliters. Each hydrophilic nanowell may include a dried reagent that is specific for a particular target.

In microfluidics system 100 and/or droplet operations device 110, sample partitioning process 114 uses a nanowell array 112 (i.e., an array of hydrophilic nanowells 116) in the otherwise hydrophobic environment of droplet operations device 110 to form an array of sub-sample droplets (i.e., sub-droplets). Sample partitioning process 114 may include, but is not limited to, the steps of:
(1) transporting an aqueous sample across the nanowell array 112 using droplet operations;
(2) transporting the aqueous sample off the nanowell array 112 using droplet operations and/or other means;
thereby leaving behind a small-volume sample or droplet in each nanowell 116.

Sample partitioning process 114 may include displacing the aqueous sample atop the nanowell array 112 with an immiscible filler fluid (e.g., silicone oil).

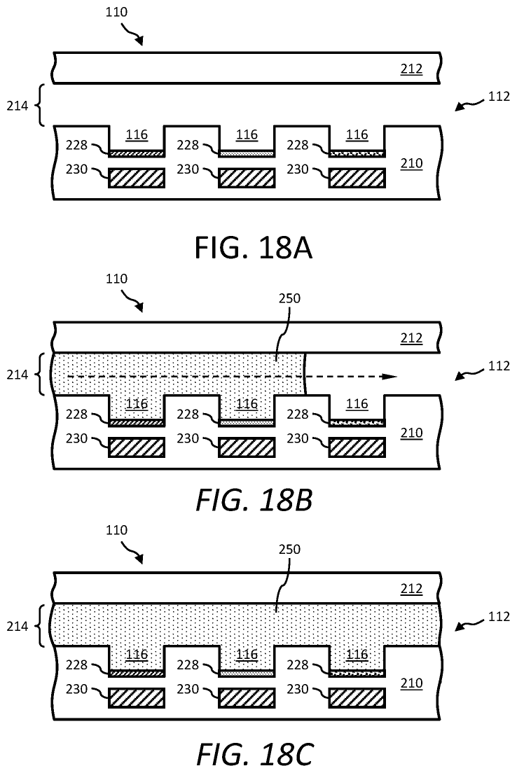

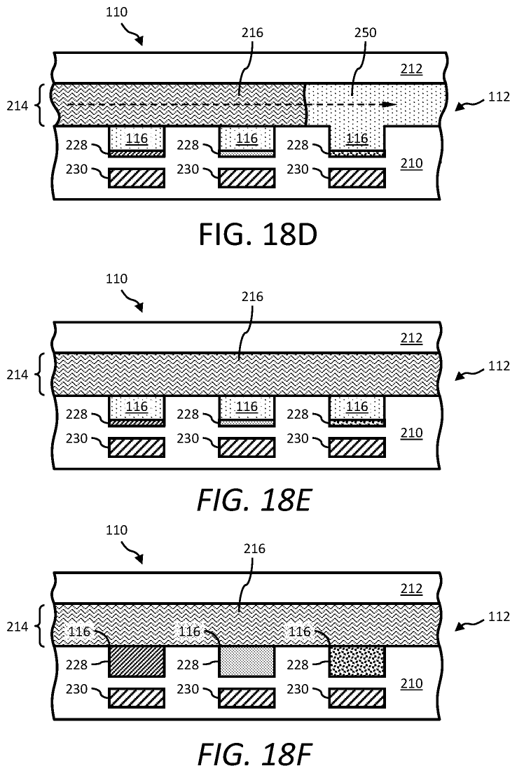

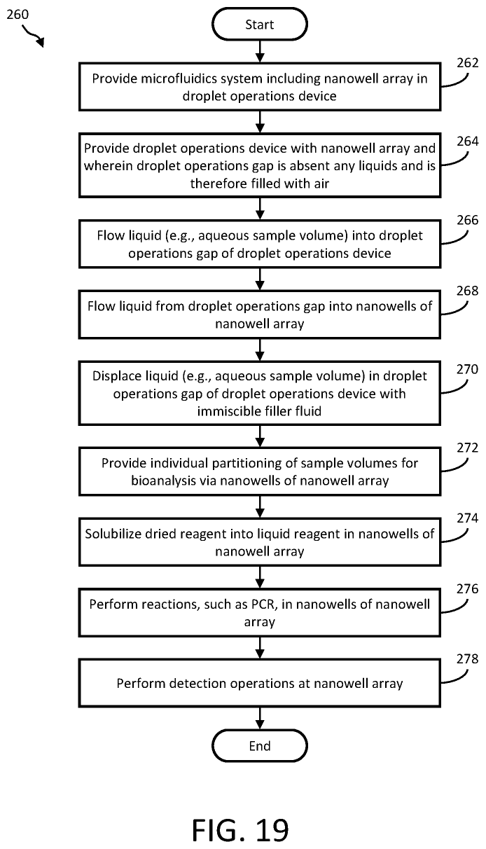

In sample partitioning process 114, the process of moving the sample over the hydrophilic nanowells 116 of the nanowell array 112 and leaving droplets behind in the nanowells 116 can be called digitization or partitioning. More details of an example of sample partitioning process 114 are shown and described with reference to FIG. 18A, FIG. 18B, and FIG. 19.

Microfluidics system 100 may further include a controller 160, a DMF interface 170, a detection system 172, and thermal control mechanisms 178. Controller 160 may be electrically coupled to the various hardware components of microfluidics system 100, such as to droplet operations device 110, detection system 172, thermal control mechanisms 178, and magnets 180. In particular, controller 160 may be electrically coupled to droplet operations device 110 via DMF interface 170, wherein DMF interface 170 may be, for example, a pluggable interface for connecting mechanically and electrically to droplet operations device 110.

Detection system 172 may be any detection mechanism that can be used to accurately determine the presence or absence of a defined analyte and/or target component in different materials and to sensitively quantify the amount of analyte and/or target components present in a sample. Detection system 172 may be, for example, an optical measurement system that includes an illumination source 174 and an optical measurement device 176. For example, detection system 172 may be a fluorimeter that provides both excitation and detection. In this example, illumination source 174 and optical measurement device 176 may be arranged with respect to droplet operations device 110.

The illumination source 174 may be, for example, a light source for the visible range (400-800 nm), such as, but not limited to, a white light-emitting diode (LED), a halogen bulb, an arc lamp, an incandescent lamp, lasers, and the like. Illumination source 174 is not limited to a white light source. Illumination source 174 may be any color light that is useful in microfluidics system 100. Optical measurement device 176 may be used to obtain light intensity readings. Optical measurement device 176 may be, for example, a charge coupled device, a photodetector, a spectrometer, a photodiode array, or any combinations thereof. Microfluidics system 100 is not limited to one detection system 172 only (e.g., one illumination source 174 and one optical measurement device 176 only). Microfluidics system 100 may include multiple detection systems 172 (e.g., multiple illumination sources 174 and/or multiple optical measurement devices 176) to support multiple detection spots.

In another example, detection system 172 may support other detection mechanisms, such as the molecular sensors 192 of droplet operations device 110, which are electronic molecular sensing devices.

In some embodiments, droplet operations device 110 may include feedback mechanisms, such as impedance and/or capacitance sensing or imaging techniques, that may be used to determine or confirm the outcome of a droplet operation. Controller 160 may further include sensing circuitry 162 for managing any feedback mechanism. In one example, a signal may be generated or detected by a capacitive sensor that can detect droplet position, velocity, and size. In another example, droplet operations device 110 may include a camera or other optical device to provide an optical measurement of the droplet position, velocity, and size. These droplet sensing mechanisms may be used to trigger controller 160 to re-route the droplets at appropriate positions. This feedback may be used to create a closed-loop control system to optimize droplet actuation rate and verify droplet operations are completed successfully. Controller 160 may include thin-film transistor (TFT) driver circuitry 164 for controlling, for example, a TFT-based active matrix that may be provided in droplet operations device 110.

Most chemical and biological processes require precise and stable temperature control for optimal efficiency and performance. Thermal control mechanisms 178 may be any mechanisms for controlling the operating temperature of droplet operations device 110. For example, thermal control mechanisms 178 may be resistive heaters and/or thermoelectric (e.g., Peltier) devices arranged externally in thermal contact with droplet operations device 110.

Magnets 180 may be, for example, permanent magnets and/or electromagnets. In one example, magnets 180 may be external to droplet operations device 110. In another example, magnets 180 may be on-chip magnetics of droplet operations device 110. In the case of external electromagnets, controller 160 may be used to control the electromagnets 180.

Together, droplet operations device 110, controller 160, DMF interface 170, detection system 172 (e.g., illumination source 174 and optical measurement device 176), and thermal control mechanisms 178 may comprise a DMF instrument 105. Optionally, DMF instrument 105 may be connected to a network. For example, a communications interface 166 of controller 160 may be in communication with a networked computer 190 via a network 191. Networked computer 190 may be, for example, any centralized server or cloud-based server. Network 191 may be, for example, a local area network (LAN) or wide area network (WAN) for connecting to the internet.

Communications interface 166 may be any wired and/or wireless communication interface for connecting to a network (e.g., network 191) and by which information may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, cellular networks, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+(Advanced Network Tools) technology, radio frequency (RF), Infrared Data Association (IrDA) compatible protocols, Local Area Networks (LAN), Wide Area Networks (WAN), Shared Wireless Access Protocol (SWAP), any other types of wireless networking protocols, and any combinations thereof.

Controller 160 may, for example, be a general-purpose computer, special purpose computer, personal computer, microprocessor, or other programmable data processing apparatus. Controller 160 may provide processing capabilities, such as storing, interpreting, and/or executing software instructions, as well as controlling the overall operations of microfluidics system 100. The software instructions may comprise machine readable code stored in non-transitory memory that is accessible by the controller 160 for the execution of the instructions. Controller 160 may be configured and programmed to control data and/or power aspects of microfluidics system 100. Data storage (not shown) may be built into or provided separate from controller 160.

Controller 160 may be used to manage any functions of microfluidics system 100. For example, controller 160 may be used to manage the operations of sensing circuitry 162, TFT driver circuitry 164, communications interface 166, detection system 172 (e.g., illumination source 174 and optical measurement device 176), thermal control mechanisms 178, magnets 180, and any other instrumentation (not shown) in relation to droplet operations device 110. With respect to droplet operations device 110, controller 160 may control droplet manipulation by activating/deactivating electrodes. Controller 160 may be used, for example, to authenticate droplet operations device 110, to verify that droplet operations device 110 is not expired, to confirm the cleanliness of droplet operations device 110 by running a protocol for that purpose, and so on.

In other embodiments of microfluidics system 100, the functions of controller 160, sensing circuitry 162, TFT driver circuitry 164, communications interface 166, detection system 172 (e.g., illumination source 174 and optical measurement device 176), thermal control mechanisms 178, magnets 180, and/or any other instrumentation may be integrated directly into droplet operations device 110 rather than provided separately from droplet operations device 110.

FIG. 2 is a block diagram of an example of droplet operations device 110 of the microfluidics system 100. Droplet operations device 110 may include one or more nanowell arrays 112 for use in any DMF-based sample partitioning process 114 for performing bioanalysis. It will be appreciated that the nanowell arrays may be replaced with nanofeature arrays. Droplet operations device 110 may include molecular sensors 192, which are electronic molecular sensing devices. Molecular sensors 192 of droplet operations device 110 may be used in a process for the direct detection of single molecules.

DMF devices may include two substrates separated by a gap (see FIG. 3A and FIG. 3B) that forms a chamber in which the droplet operations are performed. In one example, a DMF device may include a silicon or printed circuit board (PCB) substrate and a glass or plastic substrate separated by a gap.

Droplet operations device 110 may be configured to perform any sample partitioning process 114 using one or more nanowell arrays 112, which may be an example of a DMF-based process for performing bioanalysis. Each of the one or more nanowell arrays 112 is an array of hydrophilic nanowells arranged with respect to the droplet operations gap in the otherwise hydrophobic environment of droplet operations device 110.

Sample partitioning process 114 may include:
(1) transporting an aqueous sample across the nanowell array 112 using droplet operations;
(2) transporting the aqueous sample off the nanowell array 112 using droplet operations and/or other means;
thereby leaving behind a small-volume sample or droplet in each nanowell 116.

Optionally, the aqueous sample atop the nanowell array 112 may be displaced with an immiscible filler fluid (e.g., silicone oil).

A—droplet operations device 110 may be configured to perform a DMF-based process for the direct detection of single molecules using molecular sensors 192. More details of example methods of using molecular sensors 192 of droplet operations device 110 in a process for the direct detection of single molecules are provided, with reference to FIG. 49A through FIG. 56.

Droplet operations device 110 may include various other components for forming and/or supporting sample partitioning process 114 using one or more nanowell arrays 112 and/or any other functions and/or processes of droplet operations device 110. Droplet operations device 110 may include various other components for forming and/or supporting the direct detection of single molecules using molecular sensors 192 and/or any other functions and/or processes of droplet operations device 110.

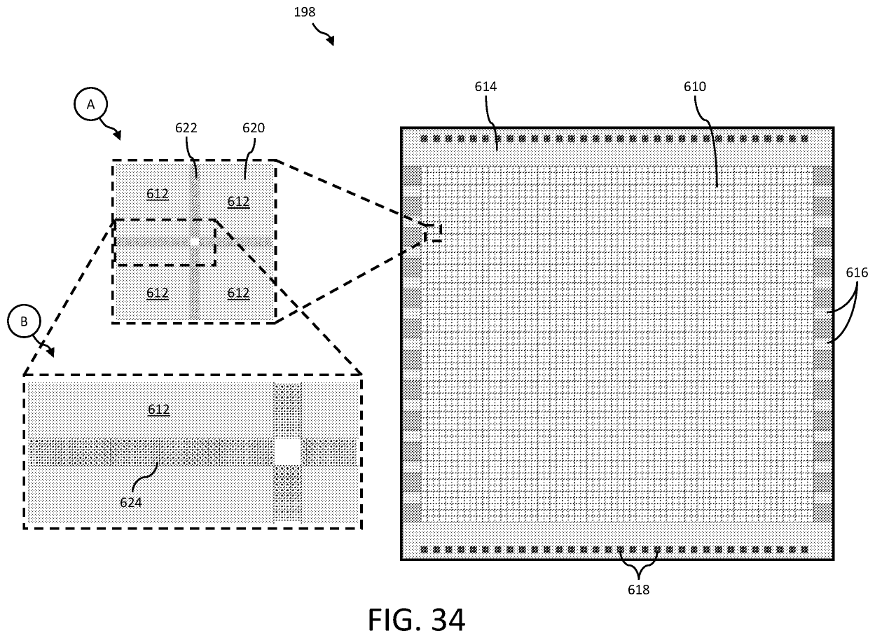

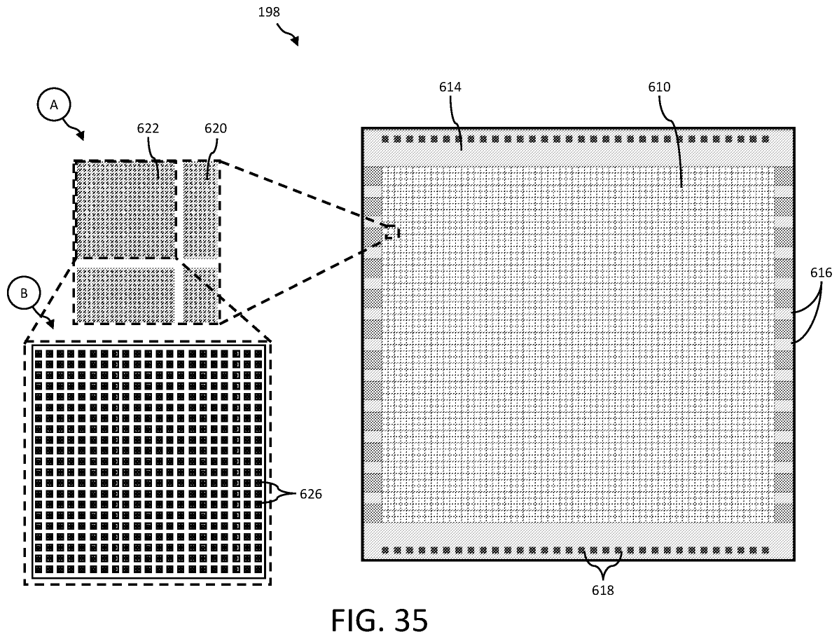

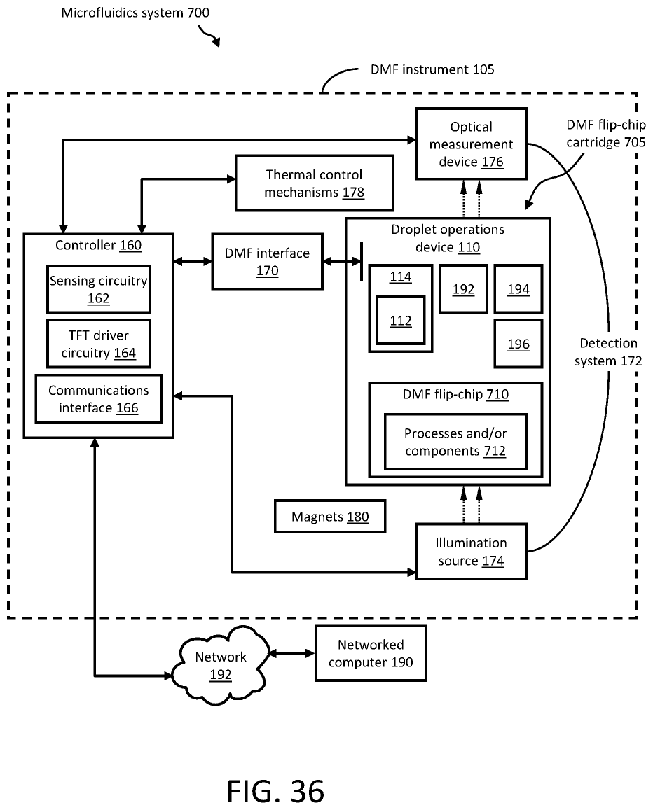

Droplet operations device 110 may include both PCB-based DMF 194 and active matrix-based DMF 196 that provides a hybrid approach that may combine the advantages of both active-matrix technology and PCB technology. In one example, active matrix-based DMF 196 of droplet operations device 110 may be implemented as a CMOS DMF device 198. That is, droplet operations device 110 may include a PCB substrate and CMOS DMF device 198 may be mounted atop the PCB substrate. In this example, any of the PCB substrate that is outside of CMOS DMF device 198 may be considered the PCB-based DMF 194 of droplet operations device 110. CMOS DMF device 198 may include active-matrix technology. Examples of CMOS DMF device 198 are shown with reference to FIG. 34 and FIG. 35. More details of an example of droplet operations device 110 including CMOS DMF device 198 mounted atop a PCB substrate, which is PCB-based DMF 194, are shown and described with reference to FIG. 36 through FIG. 40B.

PCB-based DMF 194 may be used for gross fluid manipulation and sample/reagent delivery while CMOS DMF device 198 may be used for fine fluid manipulation and execution of complex assay protocols. For example, PCB-based DMF 194 may be used to deliver various liquids or reagents to fluidic input wells of CMOS DMF device 198. Precise dispensing or aliquoting is performed on CMOS DMF device 198 so that the precision required of PCB-based DMF 194 may be greatly reduced. PCB-based DMF 194 may be used to ensure that the amount of liquid in the input wells of CMOS DMF device 198 is maintained between a minimum and a maximum volume. The requirement to store and have continual access to relatively large liquid volumes (i.e., 10's to 100's μL) potentially consumes large amounts of chip real-estate (i.e., several cm²) so that shifting this functionality to PCB-based DMF 194 reduces the required size of CMOS DMF device 198. More details of an example of droplet operations device 110 including PCB-based DMF 194 and CMOS DMF device 198 are shown and described, for example, with reference to FIG. 2 through FIG. 3.

Droplet operations device 110 may include various other components for forming and/or supporting PCB-based DMF 194, active matrix-based DMF 196 (e.g., CMOS DMF device 198), and/or any other functions and/or processes of droplet operations device 110.

For example, droplet operations device 110 may further include lines, paths, and/or arrays of droplet operations electrodes 122 for forming any number and configurations of reaction chambers 120, any number and configurations of fluid sources 124, any number and configurations of sensing mechanisms 126, any number and configurations of thermal control mechanisms 128, any number and configurations of electrode arrangements 130, any number and configurations of detection spots 132, and the like.

Droplet operations device 110 may include one or more reaction (or assay) chambers 120. Reaction chambers 120 may be supplied by arrangements (e.g., lines, paths, arrays) of droplet operations electrodes 122 (i.e., electrowetting electrodes). Droplet operations gap of droplet operations device 110 (e.g., the one or more reaction chambers 120) may be filled with a filler fluid (see FIG. 3B). The filler fluid may be a non-conductive immiscible fluid, such as a gas (e.g., air) or a liquid (e.g., an oil). Oils for use as filler fluids may, for example, include silicone oil, hexane, perfluorinated liquids, and combinations of the foregoing.

Reaction chambers 120 and arrangements of droplet operations electrodes 122 of droplet operations device 110 may be supplied by any arrangements of fluid sources 124. Fluid sources 124 may be any fluid sources integrated with or otherwise fluidly coupled to droplet operations device 110. Fluid sources 124 may include any number and/or arrangements of, for example, on-cartridge reservoirs, off-cartridge reservoirs, blister packs, fluid ports, and the like, and any combinations thereof. Fluid sources 124 may include any liquids, such as reagents, buffers, and the like, needed to support sample partitioning process 114 that may use one or more nanowell arrays 112, the direct detection of single molecules using molecular sensors 192, PCB-based DMF 194, active matrix-based DMF 196 (e.g., CMOS DMF device 198), and/or any other processes of droplet operations device 110.

Droplet operations device 110 may include sensing mechanisms 126. Sensing mechanisms 126 may be any components and/or elements built into droplet operations device 110 to support any feedback mechanisms, such as impedance or capacitance sensing. For example, sensors may be embedded at each droplet operations electrode 122 location to measure impedance, which enables monitoring and closed-loop control of droplet operations. Examples of other types of sensors may include temperature sensors, optical sensors, electrochemical sensors, voltage sensors, and current sensors. Sensing mechanisms 126 may be driven and/or controlled by sensing circuitry 162 of controller 160.

Droplet operations device 110 may include thermal control mechanisms 128. Thermal control mechanisms 128 may be any components and/or elements built into droplet operations device 110 to support any type of thermal control mechanisms 178. For example, closed loop control may be provided by thermal sensors embedded within the heater/cooler and a calibration step may be used to correlate the temperature within the heater/cooler to the temperature within the droplet operations gap of droplet operations device 110. In another example, resistive heaters may be integrated within droplet operations device 110. Examples include resistive wires or meandering traces at particular locations on the DMF device and/or discrete packaged components, such as surface mount resistors attached directly to droplet operations device 110. In another example, Joule heating or radiation may be used to heat the liquid droplets. Thermal control mechanisms 128 may be driven and/or controlled by controller 160.

Detection spots 132 of droplet operations device 110 may be any droplet operations electrodes 122 designated for detection operations via detection system 172. For example, in optical detection, illumination source 174 and optical measurement device 176 of detection system 172 may be provided in relation to a detection spot 132 at which a droplet to be analyzed may be transported to. Detection spots 132 may be associated with sample partitioning process 114 using one or more nanowell arrays 112. Other detection spots 132 may be associated with the direct detection of single molecules using molecular sensors 192. Other detection spots 132 may be associated with PCB-based DMF 194 and/or active matrix-based DMF 196 (e.g., CMOS DMF device 198) of droplet operations device 110. Other detection spots 132 may be associated with any other processes of droplet operations device 110.

Droplet operations device 110 may include TFT active-matrix technology, such as one or more TFT active matrixes 140. For example, a TFT active matrix 140 may be provided in relation to an arrangement of droplet operations electrodes 122. Any TFT active matrix 140 of droplet operations device 110 may be driven and/or controlled by TFT driver circuitry 164 of controller 160. Active-matrix DMF devices based on TFT can enable particularly flexible and high-throughput DMF devices to be realized. In TFT, individual transistors (i.e., CMOS) are fabricated underneath each electrode (i.e., pixel) enabling electronics, such as switches and sensors, to be embedded at each electrode location. The embedded switches enable row-column based addressing which significantly reduces the number of connections to the device and allows arbitrarily large arrays of electrodes to be independently operated with a fixed number of electrical inputs to the device. The embedded TFT circuitry also enables sensors (e.g., sensing mechanisms 126) to be embedded at each electrode location. For example, for measuring impedance which enables monitoring and closed-loop control of droplet operations. An example of TFT active-matrix technology that may be suitable for forming a TFT active matrix 140 in droplet operations device 110 may be the TFT active-matrix technology described in U.S. Pat. No. 7,163,612, entitled “Method, apparatus and article for microfluidic control via electrowetting, for chemical, biochemical and biological assays and the like,” issued on Jan. 16, 2007; the entire disclosure of which is incorporated herein by reference.

Droplet operations device 110 may be based on other DMF formats that are not based on traditional electrode arrays. For example, (1) Optical: In optoelectrowetting (OEW), a highly resistive a-Si:H layer switches the voltage on a virtual electrode defined by the pattern of illumination; (2) Magnetic: Ferrofluidic droplets or magnetic-bead containing droplets are manipulated by translating a permanent magnet or by using an array of electromagnets to create a magnetic field gradient. In a related implementation, droplets are manipulated indirectly by using a magnetic field to deform a film which creates topographical variation causing droplets to be operated on by gravitational forces; (3) Thermocapillary: Surface-tension driven flow based on a gradient of temperature. Example implementation is a PCB with an array of surface-mount resistors attached to the backside; and (4) Surface-acoustic wave.

In microfluidics system 100 that includes droplet operations device 110, various DMF materials may be utilized. For example, insulators may include polyimide, parylene, SU-8, Si3N4, SiO, SiOC, PDMS, Ta2O5, Al2O3, BST, ETFE. For example, hydrophobic coatings may include Cytop, Teflon AF, Fluoropel, Aquapel, SiOC. For example, substrates may include printed circuit board/FR4, glass, silicon, plastic, and paper. For example, transparent conducting coatings may include ITO, PEDOT, and CNT. Manufacturing technologies for DMF systems may be as follows: (1) Single layer—The simplest embodiments of DMF consist of a single conductive layer in which all electrodes, wires and pads are formed. Devices can be manufactured using lithography, screen-printing, inkjet printing, etc. (2) PCB technology—Provides multiple layers of electrical interconnect (e.g., 2-layer, 4-layer, 6-layer, 8-layer, etc.) which enables more complex designs and smaller features. Board-level integration with electronic components; and (3) TFT-based active-matrix technology as described herein.

FIG. 3A and FIG. 3B are a plan view and a cross-sectional view of an example of a DMF structure 200. In one example, the formation of droplet operations device 110 of microfluidics system 100 may be based on DMF structure 200. FIG. 3A shows that DMF structure 200 may include any arrangements (e.g., lines, paths, arrays) of droplet operations electrodes 122 (i.e., electrowetting electrodes).

FIG. 3B shows that DMF structure 200 may include a bottom substrate 210 and a top substrate 212 separated by a droplet operations gap 214. Droplet operations gap 214 may contain filler fluid 216, such as silicone oil. Bottom substrate 210 may be, for example, a silicon substrate or a PCB. Bottom substrate 210 may include an arrangement of droplet operations electrodes 122 (e.g., electrowetting electrodes). Droplet operations electrodes 122 may be formed, for example, of copper, gold, or aluminum. A dielectric layer 220 (e.g., parylene coating, silicon nitride) may be atop droplet operations electrodes 122. Top substrate 212 may be, for example, a glass or plastic substrate. Top substrate 212 may include a ground reference electrode 218. In one example, ground reference electrode 218 may be formed of indium tin oxide (ITO) and wherein ITO is substantially transparent to light. A hydrophobic layer 222 may be provided on both the side of bottom substrate 210 and the side of top substrate 212 that is facing droplet operations gap 214. Examples of hydrophobic materials or coatings may include, but are not limited to, polytetrafluoroethylene (PTFE), Cytop, Teflon™ AF (amorphous fluoropolymer) resins, FluoroPel™ coatings, silane, and the like. Droplet operations may be conducted atop droplet operations electrodes 122 on a droplet operations surface. For example, droplet operations may be conducted atop droplet operations electrodes 122 with respect to a droplet 250 (droplet operations electrodes 122 and droplet 250 not drawn to scale).

### 6.4. Partitioning of Samples for Digital PCR

Nanowell arrays 112 for use in sample partitioning process 114 of the microfluidics system 100 may include different densities, numbers, sizes, and/or footprints of nanowells 116, as shown below, for example, in FIG. 4, FIG. 5, FIG. 6, FIG. 7, and FIG. 8.

FIG. 4, FIG. 5, FIG. 6, FIG. 7, and FIG. 8 are plan views of examples of nanowell arrays 112 for use in sample partitioning process 114 of the microfluidics system 100. Each of the nanowell arrays 112 may include an array or other arrangement of nanowells 116, which are hydrophilic nanowells. any nanowell array 112 may include, for example, from about tens to about thousands of nanowells 116. In one example, a nanowell array 112 may include from about 18,000 to about 100,000 nanowells 116. For example, nanowell array 112 may be a one-dimensional (1D) array, such as a 1×n array, or a two-dimensional (2D) array, such as any n×n array. Examples of 2D nanowell arrays 112 may include a 144×144 array (i.e., 20,736 nanowells 116) and a 300×300 array (i.e., 90,000 nanowells 116). In the example of the 144×144 array, nanowell array 112 may be designed to test for 144 different targets. For example, nanowell array 112 may include 144 nanowells 116 for each of the 144 different targets, which is 20,736 nanowells 116. In the example of the 300×300 array, nanowell array 112 may be designed to test for 10 different targets. For example, nanowell array 112 may include 9,000 nanowells 116 for each of the 10 different targets, which is 90,000 nanowells 116.

Nanowells 116 of any nanowell array 112 may include any shape or footprint. For example, FIG. 4 shows an example of nanowell array 112 that includes circular-shaped nanowells 116. In this example, nanowells 116 may be set on the same horizontal and vertical pitch p. Also in this example, each nanowell 116 may have a diameter D and a depth d. Diameter D may range, for example, from about 1 μm to about 10 μm. Depth d may range, for example, from about 1 μm to about 10 μm.

FIG. 5 shows an example of nanowell array 112 that includes square-shaped nanowells 116. FIG. 6 shows an example of nanowell array 112 that includes octagon-shaped nanowells 116. FIG. 7 shows an example of nanowell array 112 that includes hexagon-shaped nanowells 116. FIG. 8 shows an example of nanowell array 112 that includes pentagon-shaped nanowells 116. Nanowells 116 are not limited to the shapes or footprints shown in FIG. 4, FIG. 5, FIG. 6, FIG. 7, and FIG. 8. These shapes or footprints are exemplary only.

In the examples shown in FIG. 5, FIG. 6, FIG. 7, and FIG. 8, nanowells 116 may be set on the same horizontal and vertical pitch p. Also in these examples, each nanowell 116 may have a width w, a length L, and a depth d. Width w may range, for example, from about 1 μm to about 10 μm. Length L may range, for example, from about 1 μm to about 10 μm. Depth d may range, for example, from about 1 μm to about 10 μm.

A cross-section A-A in each of FIG. 4, FIG. 5, FIG. 6, FIG. 7, and FIG. 8 shows that each nanowell 116 may hold some amount of dried reagent 118. For example, nanowell array 112 may be spotted with a reagent solution, which then dries into a patch (spot) or pellet of dried reagent 118. The dried reagent 118 in a nanowell 116 or group of nanowells 116 may be specific for a particular target. That is, nanowells 116 may contain an analysis reagent that may be unique to each individual nanowell 116 or to a subset of individual nanowells 116. For example, the analysis reagent may include a set of PCR primers or probes designed to amplify a particular DNA sequence. Additional components may be common to all nanowells 116, such as enzymes and buffers required for bioanalysis. During sample partitioning process 114, dried reagent 118 in each nanowell 116 may be reconstituted (or solubilized) and then a reaction (DNA amplification, such as PCR or loop-mediated isothermal amplification (LAMP)) may occur in each nanowell 116 of nanowell array 112.

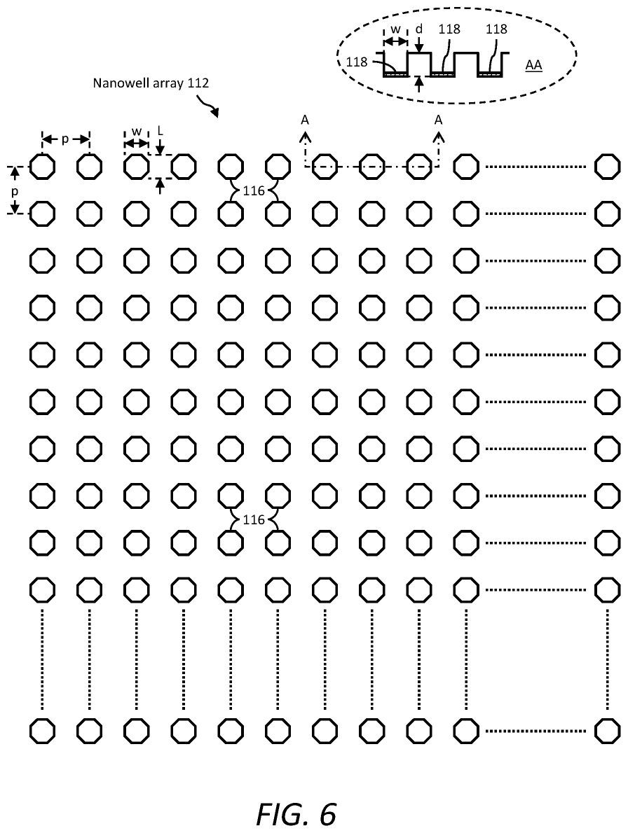

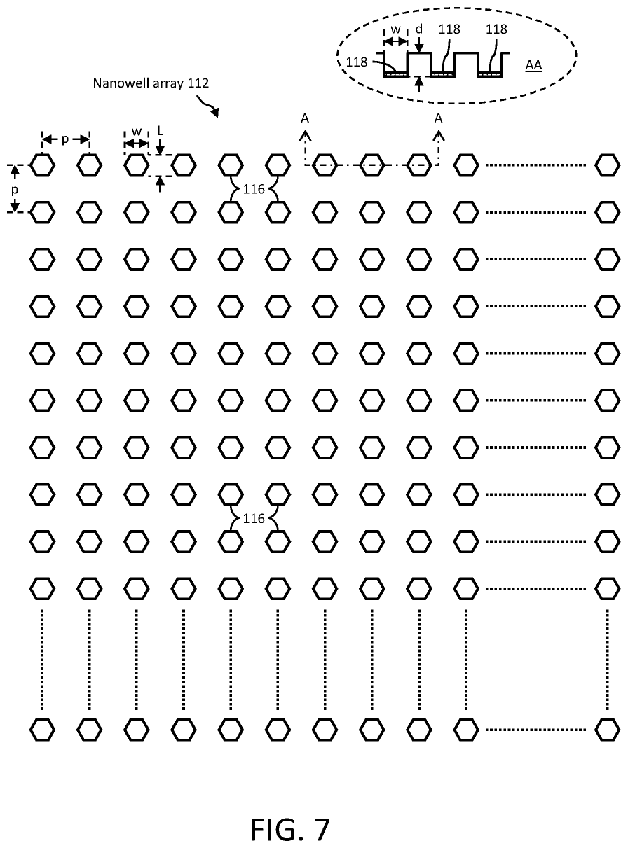

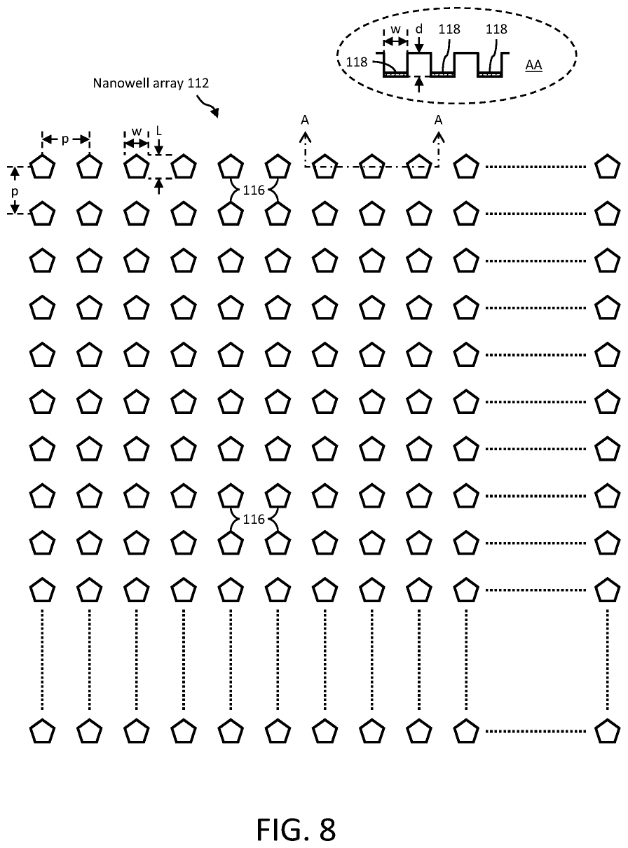

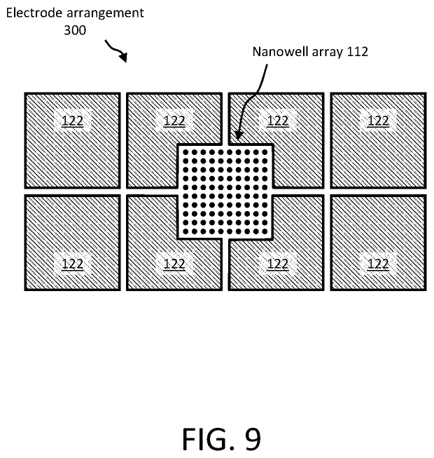

In microfluidics system 100 and/or droplet operations device 110, nanowell array 112 is an array of hydrophilic nanowells 116 arranged with respect to the droplet operations gap in the otherwise hydrophobic environment of droplet operations device 110. During sample partitioning process 114 there may be two opposing forces at work—(1) the electrowetting force of the droplet operations that is used to move the aqueous sample across and then off the nanowell array 112, and (2) the force of the small-volume droplets that want to stay in the hydrophilic nanowells 116. As a result, while the electrowetting force is trying to move the aqueous sample across and then away from the hydrophilic nanowells 116 of nanowell array 112, the hydrophilic nanowells 116 are pulling or holding the aqueous sample back. Microfluidics system 100, droplet operations device 110, and/or nanowell array 112 may be designed to balance these two forces (i.e., the electrowetting forces of droplet operations electrodes 122 and the hydrophilic forces of the nanowell array 112) in such a manner as to allow the aqueous sample to be transported off the nanowell array 112, e.g., using droplet operations, while at the same time leaving behind a small-volume sample or droplet in each nanowell 116. By way of example, FIG. 9 through FIG. 17 below show example electrode arrangements and nanowell arrays 112 for ensuring the proper balance of these two forces and thereby enabling sample partitioning process 114.

FIG. 9 is a plan view of an example of an electrode arrangement 300 including one nanowell array 112 (not to scale) for use in sample partitioning process 114. In this example, one nanowell array 112 may be provided among, for example, two lines of droplet operations electrodes 122. More specifically, one nanowell array 112 is sized and positioned substantially at the intersection of four droplet operations electrodes 122. In this example, the inner corner of each droplet operations electrode 122 may be cleared to accommodate nanowell array 112. in electrode arrangement 300, the four droplet operations electrodes 122 that are arranged with respect to nanowell array 112 may be used to transport (via droplet operations) an aqueous sample or droplet across and then away from nanowell array 112, while at the same time leaving behind a small-volume sample or droplet in each nanowell 116 of nanowell array 112.

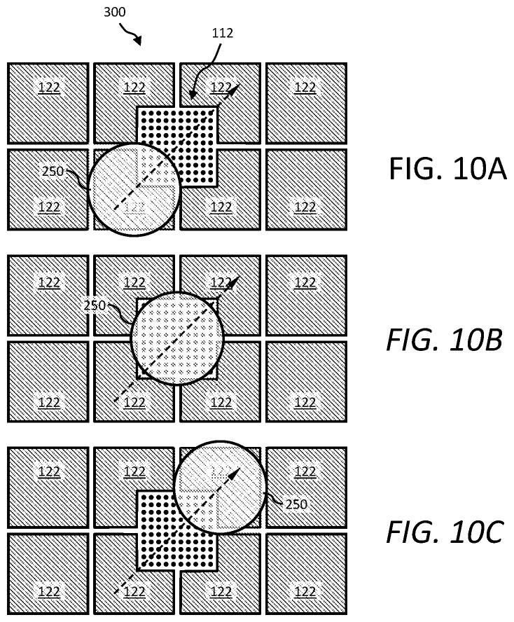

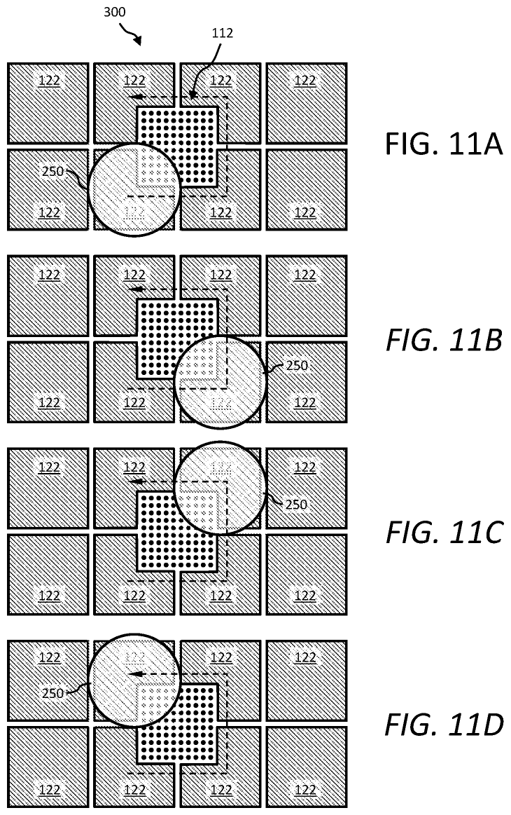

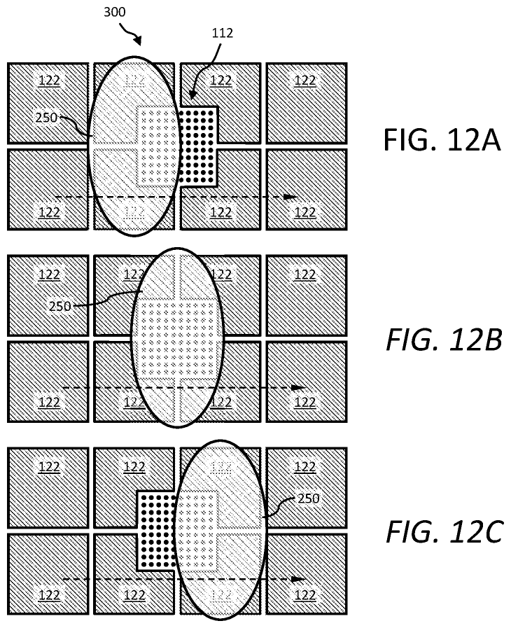

FIG. 10A, FIG. 10B, and FIG. 10C show an example of using electrode arrangement 300 shown in FIG. 9 in sample partitioning process 114. In this example, droplet operations electrodes 122 may be used to transport droplet 250 in diagonal fashion across and then off of nanowell array 112. FIG. 11A, FIG. 11B, FIG. 11C, and FIG. 11D show another example of using electrode arrangement 300 shown in FIG. 9 in sample partitioning process 114. In this example, droplet operations electrodes 122 may be used to transport droplet 250 in a rotating fashion around and then off of nanowell array 112. In this example, instead of droplet 250 covering substantially the entirety of nanowell array 112 (as shown in FIG. 10B) at one time, droplet 250 covers the corner portions of nanowell array 112 in sequential step fashion to eventually interact with the entirety of nanowell array 112. FIG. 12A, FIG. 12B, and FIG. 12C show yet another example of using electrode arrangement 300 shown in FIG. 9 in sample partitioning process 114. In this example, a droplet 250 may be provided that substantially spans two droplet operations electrodes 122. Then, using pairs of droplet operations electrodes 122, the elongated droplet 250 may be transported across and then off of nanowell array 112.

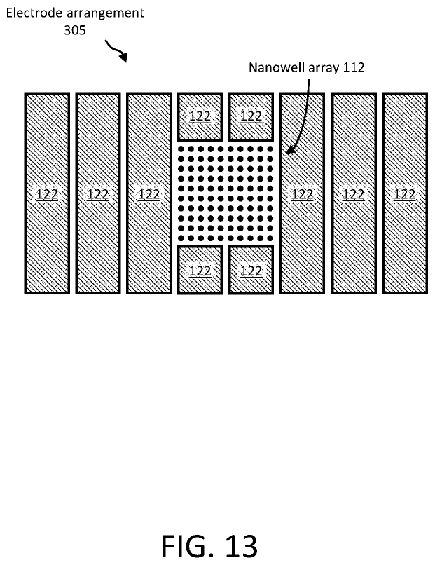

FIG. 13 is a plan view of another example of an electrode arrangement 305 including one nanowell array 112 (not to scale) for use in sample partitioning process 114. In this example, electrode arrangement 305 may include one nanowell array 112 that is flanked on one side (e.g., top side) by two small droplet operations electrodes 122 and then flanked on the opposite side (e.g., bottom side) with two other small droplet operations electrodes 122. In electrode arrangement 305 an arrangement of elongated droplet operations electrodes 122 may be provide on the remaining two sides (e.g., left and right sides) of nanowell array 112. For example, each of the elongated droplet operations electrodes 122 may span the full dimension of the nanowell array 112 flanked on two sides with small droplet operations electrodes 122.

In this example, the small droplet operations electrodes 122 flanking the two sides of nanowell array 112 may act as “handles” enabling the entire droplet to be moved across the nanowell array 112. These small droplet operations electrodes 122 may be specialized for performing this operation and may even be operated at higher voltages than the larger elongated droplet operations electrodes 122 to compensate for their smaller active areas. The array size and shape may be designed to match particular specialized electrodes shape to provide maximally efficient transport of liquid across the array surface.

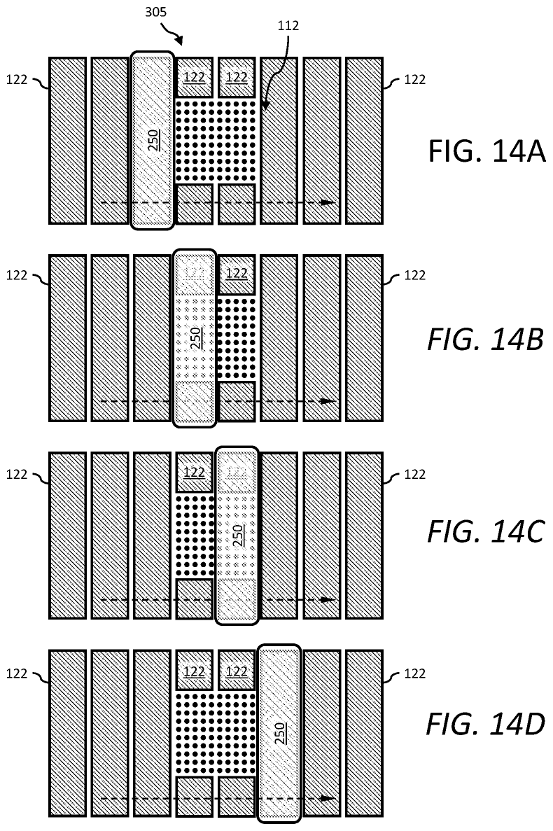

FIG. 14A, FIG. 14B, FIG. 14C, and FIG. 14D show an example of using electrode arrangement 305 shown in FIG. 13 in sample partitioning process 114. In this example, a droplet 250 may be provided that substantially spans the elongated droplet operations electrode 122 (see FIG. 14A). Then, using the elongated droplet operations electrodes 122, the elongated droplet 250 may be transported to the leading edge of nanowell array 112 (see FIG. 14A). Then, the smaller flanking droplet operations electrodes 122 takeover to transport the elongated droplet 250 across the area of nanowell array 112 (see FIG. 14B and FIG. 14C). Then, using other elongated droplet operations electrodes 122, the elongated droplet 250 may be transported off of and away from the trailing edge of nanowell array 112 (see FIG. 14D).

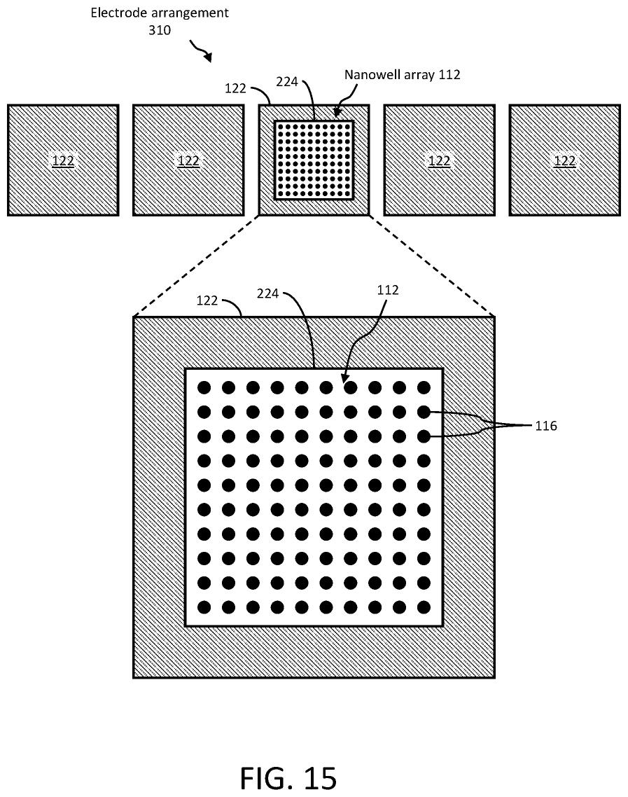

FIG. 15 is a plan view (not to scale) of an example of an electrode arrangement 310 including a nanowell array 112 arranged within a single droplet operations electrode 122. In this example, nanowell array 112 may be arranged directly in the droplet transport pathway for ease of moving the aqueous sample or droplet across nanowell array 112.

In one example, droplet operations electrode 122 may be from about 300 μm to about 1200 μm square. In one example, each nanowell 116 of nanowell array 112 may be from about 1 μm to about 10 μm square or in diameter. In electrode arrangement 310, nanowell array 112 may include, for example, from about tens to about thousands of nanowells 116. In one example, nanowell array 112 may include from about 18,000 to about 20,000 nanowells 116. In another example, nanowell array 112 may be a 144×144 array of nanowells 116, which is 20,736 nanowells 116.

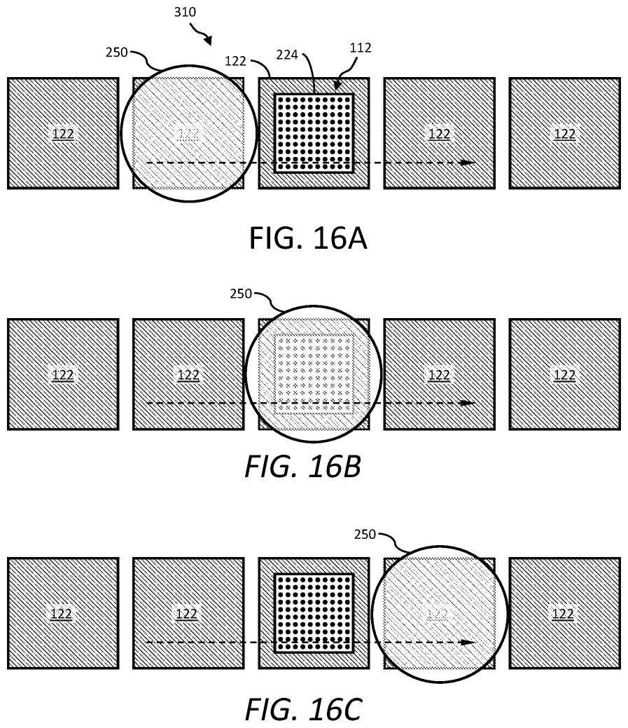

In electrode arrangement 310, a clearance region or window 224 is provided in droplet operations electrode 122 to accommodate the placement of nanowell array 112. In this way, metal of droplet operations electrode 122 essentially frames the nanowell array 112 and can be used for transporting (via droplet operations) the aqueous sample or droplet across nanowell array 112. FIG. 16A, FIG. 16B, and FIG. 16C show an example of using electrode arrangement 310 shown in FIG. 15 in sample partitioning process 114. For example, using droplet operations, droplet 250 may be transported to the leading edge of nanowell array 112 (see FIG. 16A). Then, using the droplet operations electrode 122 containing nanowell array 112, droplet 250 may be transported across the area of nanowell array 112 (see FIG. 16B). Then, using other droplet operations electrodes 122, droplet 250 may be transported off of and away from the trailing edge of nanowell array 112 (see FIG. 16C).

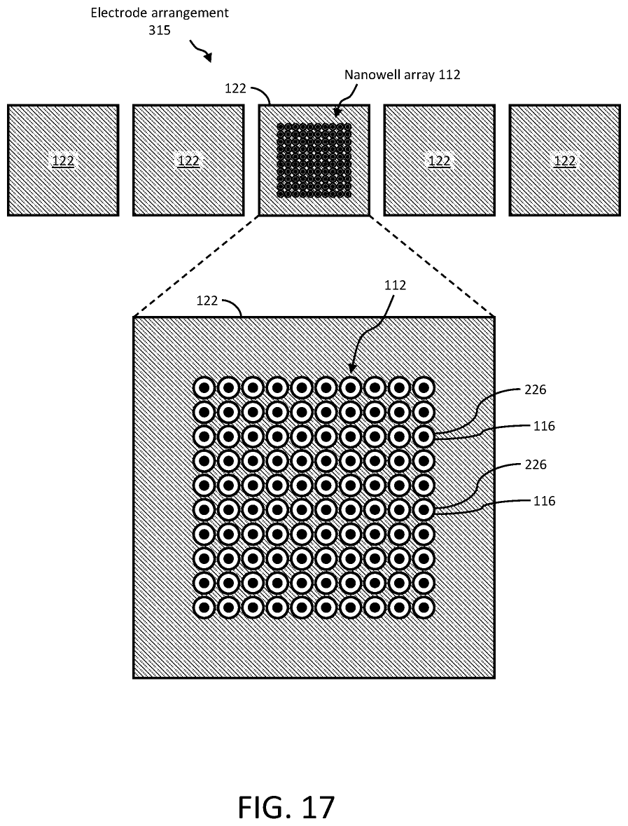

FIG. 17 is a plan view of another example of an electrode arrangement 315 including a nanowell array 112 arranged within a single droplet operations electrode 122. Electrode arrangement 315 may be substantially the same as electrode arrangement 310 shown in FIG. 15 except that instead of droplet operations electrode 122 including one large clearance region or window 224 to accommodate the placement of nanowell array 112, each nanowell 116 has its own individual clearance region 226. As compared with the large clearance region or window 224 of electrode arrangement 310, the droplet operations electrode 122 containing nanowell array 112 of electrode arrangement 315 may overall include a larger area of metal. This may be beneficial for assisting droplet operations for moving the aqueous sample or droplet across and/or off nanowell array 112.

FIG. 18A through FIG. 18F show side views of a of droplet operations device 110 and an example of a process of using nanowell array 112 in sample partitioning process 114. In this example, three nanowells 116 of nanowell array 112 are shown, each with a different dried reagent 228 therein. That is, nanowells 116 may contain an analysis reagent that may be unique to each individual nanowell 116 or to a subset of individual nanowells 116. For example, the analysis reagent may include a set of PCR primers or probes designed to amplify a particular DNA sequence. Additional components may be common to all nanowells 116, such as enzymes and buffers required for bioanalysis.

A sensor 230 may be provided in bottom substrate 210 at each nanowell 116. Sensors 230 are provided for detection purposes and to be used with detection system 172 shown in FIG. 1. For example, a sensor array (not shown) may be provided in which the arrangement of sensors 230 may substantially correspond to the arrangement of nanowells 116 of nanowell array 112.

In one example, sensors 230 may be optical sensors, such as photodiodes, that may require, for example, that top substrate 212 be substantially transparent. In another example, sensors 230 may be electrical sensors, such as an ion-sensitive field-effect transistor (ISFET), a fin field-effect transistor (FinFET), and the like. In this example, sensors 230 may be arranged in direct contact with the liquid in nanowells 116 and the substrates may not require transparency. Sensors 230 may be other types of sensors, such as electronic molecular sensors.

Droplet operations electrodes 122 (not shown) may be positioned with respect to nanowell array 112 for performing droplet operations. For example, droplet operations electrodes 122 may be provided with respect to nanowell array 112 as shown in electrode arrangement 300 of FIG. 9, electrode arrangement 305 of FIG. 13, electrode arrangement 310 of FIG. 15, and/or electrode arrangement 315 of FIG. 17.

FIG. 18A shows that droplet operations device 110 including the nanowell array 112 may be provided as manufactured and wherein droplet operations gap 214 may be filled with air.

FIG. 18B shows that liquid (e.g., aqueous sample or droplet 250) may be flowed through droplet operations gap 214 of droplet operations device 110 and over the nanowells 116 of nanowell array 112. This may be done, for example, using droplet operations and/or by pressure (e.g., pumps).

FIG. 18C shows that droplet operations gap 214 and each nanowell 116 of nanowell array 112 may be filled with liquid (e.g., aqueous sample or droplet 250). That is, the hydrophilic nature of each nanowell 116 may be used to pull a small-volume sample of the original or starting sample into each nanowell 116.

FIG. 18D and FIG. 18E show that the liquid (e.g., aqueous sample or droplet 250) may be moved out of droplet operations gap 214 and off nanowells 116 of nanowell array 112 via droplet operations and/or other means and at the same time the liquid in droplet operations gap 214 may be displaced by an immiscible filler fluid (e.g., filler fluid 216, such as silicone oil).

Referring still to FIG. 18E, the result is the individual partitioning of samples for bioanalysis in each of the nanowells 116 of nanowell array 112. That is, droplet operations gap 214 may be filled with filler fluid 216, while a small-volume sample of the original or starting sample may be left behind in each of the nanowells 116 because of the hydrophilic nature of each nanowell 116. For example, the small-volume sample in each of the nanowells 116 may be from about one femtoliter to about 10 picoliters.

FIG. 18F shows that the dried reagent 228 in each of the nanowells 116 may reconstitute (or solubilize) into liquid reagent 228. Then, reactions, such as PCR, may occur in each of the nanowells 116. In sample partitioning process 114 of microfluidics system 100, the dried reagent 228 may be designed to take a predetermined amount of time to solubilize. For example, it must be ensured that the water-soluble dried reagent 228 does not solubilize immediately and during the liquid transporting process shown in FIG. 18B, FIG. 18C, and FIG. 18D, which is the part of the process that the nanowells 116 may be in a common bath of liquid. Rather, the water-soluble dried reagent 228 may be designed to solubilize slowly in an amount of time that may correspond to the completion of the step shown in FIG. 18E, which is where droplet operations gap 214 may be fully filled with filler fluid 216. This is important to ensure that no mixing takes place between nanowells 116.

There may be ways to ensure that no mixing takes place between nanowells 116 during the liquid transporting process shown in FIG. 18B, FIG. 18C, and FIG. 18D. In one example, time—design the carrier material of the dried reagent to dissolve slower than the transporting process so that the solubilizing process takes longer than the transporting process. The transporting process may be, for example, less than about 1 second. For example, it may take a fraction of a second to sweep the liquid and then displace with oil, and about 1 minute to dissolve the dried reagent.

In another example, temperature—the carrier material of the dried reagent may be temperature sensitive. For example, in the first step of PCR the temperature may be ramped up to about 95° C. To take advantage of this, the dried reagent in each nanowell 116 may be embedded in, for example, wax that is provided in hardened state and then melts when the environment reaches 95° C., which is after the transporting process. The type of wax is such that it does not interfere with PCR.

FIG. 19 is a flow diagram of an example of a method 260 of using nanowell array 112 for partitioning of samples for bioanalysis. Method 260 may be an example of sample partitioning process 114 of the microfluidics system 100. Method 260 may include, but is not limited to, the following steps.

At a step 262, a microfluidics system including a nanowell array in a droplet operations device is provided. For example, the microfluidics system 100 including droplet operations device 110 that has nanowell array 112 is provided, as described herein with reference to FIG. 1 through FIG. 18F.

At a step 264, a droplet operations device with a nanowell array is provided in a state in which the droplet operations gap of the droplet operations device is absent any liquids and is therefore filled with air. For example and FIG. 18A, droplet operations device 110 with nanowell array 112 is provided in a state in which droplet operations gap 214 of droplet operations device 110 may be absent any liquids and is therefore filled with air.

At a step 266, liquid (e.g., aqueous sample) is flowed into the droplet operations gap of the droplet operations device. For example and FIG. 18B, liquid (e.g., aqueous sample or droplet 250) may be flowed through droplet operations gap 214 of droplet operations device 110 and over the nanowells 116 of nanowell array 112. This may be done, for example, using droplet operations and/or by pressure (e.g., pumps).

At a step 268, liquid (e.g., aqueous sample) may flow from the droplet operations gap into the nanowells of the nanowell array. For example and FIG. 18C, the liquid (e.g., aqueous sample or droplet 250) in droplet operations gap 214 may fill each nanowell 116 of nanowell array 112. That is, the hydrophilic nature of each nanowell 116 may be used to pull a small-volume sample of the original or starting sample 250 into each nanowell 116 of nanowell array 112.

At a step 270, liquid (e.g., aqueous sample) in droplet operations gap of droplet operations device is displaced with an immiscible filler fluid. For example and FIG. 18D and FIG. 18E, the liquid (e.g., aqueous sample or droplet 250) may be moved out of droplet operations gap 214 and off of nanowells 116 of nanowell array 112 via droplet operations and/or other means and at the same time the liquid in droplet operations gap 214 may be displaced by an immiscible filler fluid, such as filler fluid 216.

At a step 272, individual partitioning of samples for bioanalysis is provided via the nanowells of the nanowell array. For example and FIG. 18E, the result is the individual partitioning of samples for bioanalysis in each of the nanowells 116 of nanowell array 112. That is, droplet operations gap 214 may be filled with filler fluid 216, while a small-volume sample of the original or starting sample may be left behind in each of the nanowells 116 because of the hydrophilic nature of each nanowell 116.

At a step 274, the dried reagent is solubilized into liquid reagent in the nanowells of the nanowell array. For example and FIG. 18F, the dried reagent 228 in each of the nanowells 116 may reconstitute (or solubilize) into liquid reagent 228.

At a step 276, reactions, such as PCR, are performed in the nanowells of the nanowell array. For example and FIG. 18E, reactions, such as PCR, may occur in each of the nanowells 116 of nanowell array 112.

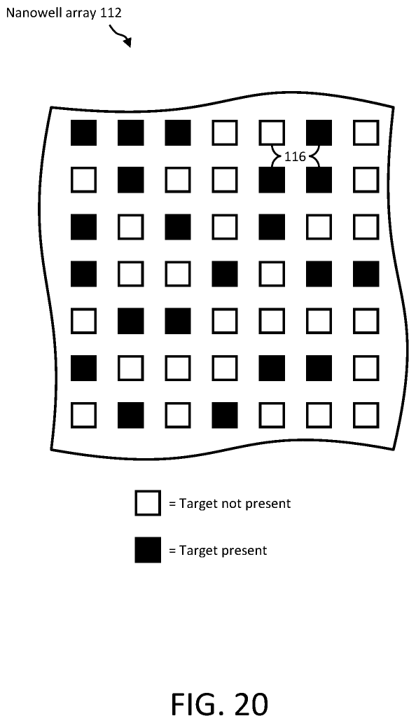

At a step 278, detection operations are performed at the nanowell array. For example and FIG. 18F, using sensors 230 and detection system 172 shown in FIG. 1, detection operations may be performed at nanowell array 112 to determine, for example, the concentration of a analyte and/or target component in the starting sample. For example, and FIG. 20, a plan view of an example of a of a nanowell array 112 shows DNA is amplified in nanowells 116 indicating the presence and quantity of each target.

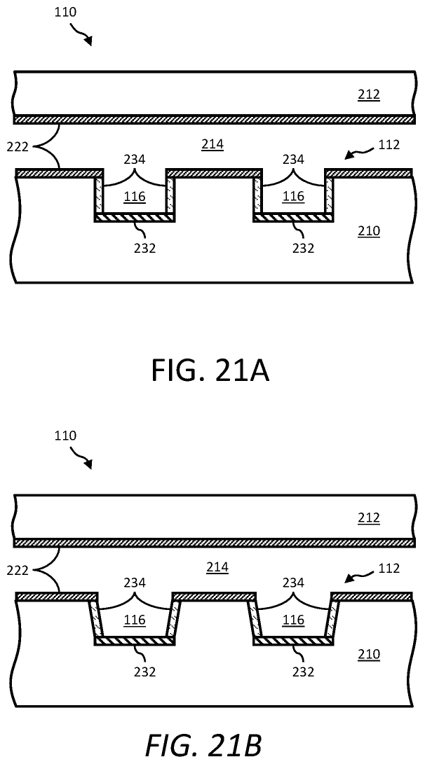

FIG. 21A and FIG. 21B is cross-sectional views of a of droplet operations device 110 and nanowell array 112 and showing more details thereof. For example, the nanowells 116 of nanowell array 112 may be engineered for optimal performance in method 260, which is an example of sample partitioning process 114. That is, the nanowells 116 of nanowell array 112 may be engineered for optimal performance with respect to drawing liquid into each nanowell 116. In particular, the nanowells 116 of nanowell array 112 may be engineered to balance the electrowetting forces versus the hydrophilic forces in such a manner as to allow the aqueous sample to be transported off the nanowell array 112 using droplet operations, while at the same time leaving behind a small-volume sample or droplet in each nanowell 116.

Nanowell array 112 is an array of hydrophilic nanowells 116 arranged with respect to droplet operations gap 214 in the otherwise hydrophobic environment of droplet operations device 110. That is, surfaces of droplet operations gap 214 may be coated with the standard hydrophobic layers 222, while at the same time the nanowells 116 include hydrophilic coatings. For example, the floor of each of the nanowells 116 may be coated with a hydrophilic layer 232. The sidewalls of each of the nanowells 116 may be coated with a hydrophilic layer 234.

The hydrophilic nanowells 116 may be engineered, for example, by coating with a material which is strongly hydrophilic (contact angle)—0° or weakly hydrophilic (contact angle slightly less than 90°) or anything in between. By contrast, the surfaces of droplet operations gap 214 may be engineered, for example, to be weakly hydrophobic (contact angle slightly more than 90°) or strongly hydrophobic (contact angle up to 180°). Examples of hydrophilic materials or coatings may include, but are not limited to, glass, silica, silicon dioxide (SiO2), and silanes.

Glass is naturally hydrophilic, therefore, in one example, bottom hydrophilic layer 232 and the side hydrophilic layer 234 may be SiO2 coatings. However, the bottom hydrophilic layer 232 and the side hydrophilic layer 234 may be engineered differently for optimal performance. For example, the bottom hydrophilic layer 232 and the side hydrophilic layer 234 may have different degrees of hydrophilicity. In one example, the bottom hydrophilic layer 232 may have a high hydrophilicity, while the side hydrophilic layer 234 may have a lower degree of hydrophilicity.

Other characteristics of nanowells 116 may be adjusted for optimal performance. For example, the aspect ratio (depth vs width), the pitch, and/or the sidewall angle (see FIG. 21B) of nanowells 116 may be adjusted for optimal performance.

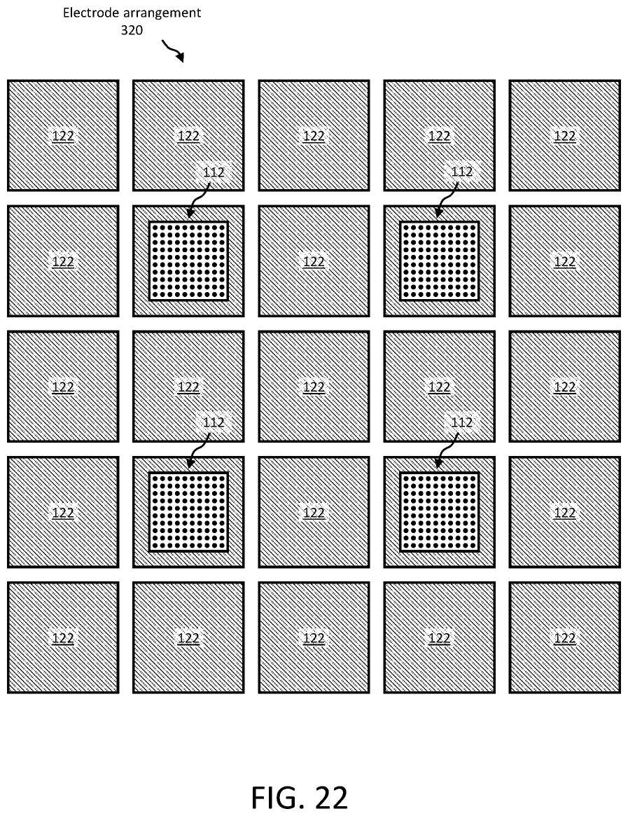

FIG. 22 is a plan view of an example of an electrode arrangement 320 including multiple nanowell arrays 112. For example, droplet operations device 110 of microfluidics system 100 may include any number of nanowell arrays 112 and wherein multiple sample partitioning processes 114 may occur separately, independently, and/or simultaneously at the respective nanowell arrays 112.

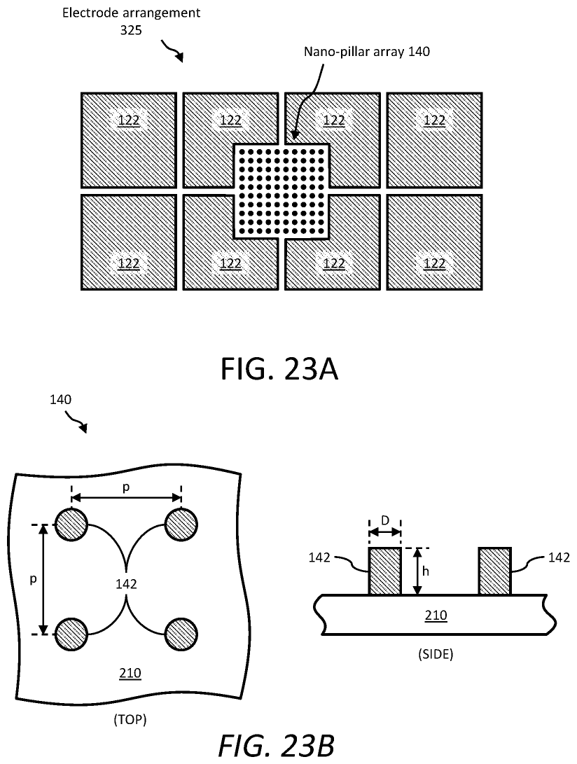

The microfluidics system 100, droplet operations device 110, and method 260 for partitioning of samples for bioanalysis is not limited to nanowell arrays 112 including nanowells 116 for processing nano-sized volumes of liquid. In another example, and FIG. 23A and FIG. 23B, microfluidics system 100, droplet operations device 110, and method 260 may include one or more nanopost arrays 140. FIG. 23A shows an example of an electrode arrangement 325 the includes a nanopost array 140 arranged with respect to droplet operations electrodes 122. FIG. 23B shows a top view and a side view of a of nanopost array 140 that may include an arrangement of nanoposts (or nano-posts) 142, which are hydrophilic nanoposts 142. In one example, nanoposts 142 may be provided on bottom substrate 210 of droplet operations device 110 and may protrude into droplet operations gap 214.

Any nanopost array 140 may include, for example, from about tens to about thousands of nanoposts 142. In one example, a nanopost array 140 may include from about 18,000 to about 20,000 nanoposts 142. In another example, a nanopost array 140 may include a 144×144 array of nanoposts 142, which is 20,736 nanoposts 142. In this example, nanopost array 140 may be designed to test for 144 different targets. In this example, nanopost array 140 may include 144 nanoposts 142 for each of the 144 different targets, which is 20,736 nanoposts 142.

In one example, nanoposts 142 may be set on the same horizontal and vertical pitch p. Also in this example, each nanopost 142 may have a diameter D and a height h. Diameter D may range, for example, from about 1 μm to about 10 μm. Height h may range, for example, from about 1 μm to about 10 μm.

In one example, nanoposts (or nano-posts) 142 may be formed on bottom substrate 210 of droplet operations device 110 by known processes, such as anisotropic etching processes. In one example, nanoposts 142 may be formed of natively hydrophilic material, such as glass (SiO2). In another example, nanoposts 142 may be formed of any material and then coated with a hydrophilic coating, such as a glass coating.

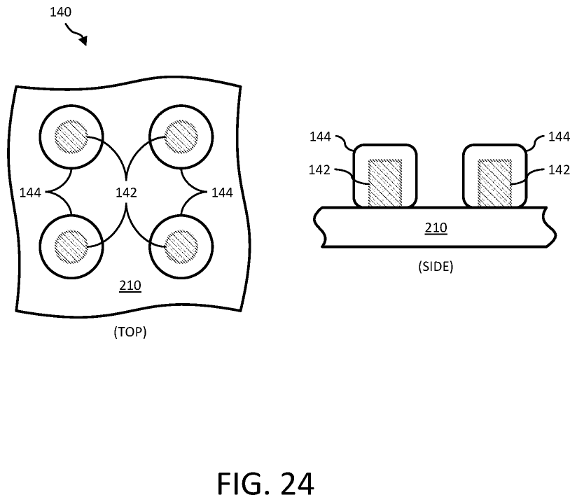

FIG. 24 shows a top view and side view of an example of using nanopost array 140 shown in FIG. 23A and FIG. 23B. For example, in microfluidics system 100 and/or droplet operations device 110, each of the one or more nanopost arrays 140 is an array of hydrophilic nanoposts 142 arranged with respect to droplet operations gap 214 in the otherwise hydrophobic environment of droplet operations device 110. Each hydrophilic nanopost 142 may be used to process a volume of, for example, from about one femtoliter to about 10 picoliters. Each hydrophilic nanopost 142 may be functionalized for a particular target. In this example, using detection system 172 shown in FIG. 1, fluorescent sensing may be used wherein excitation and emission light may be transmitted through, for example, a substantially transparent top substrate 212 of droplet operations device 110.

In microfluidics system 100 and/or droplet operations device 110, nanopost arrays 140 may operate in sample partitioning process 114 and/or method 260 substantially the same as nanowell arrays 112. For example, (1) an aqueous sample may be transported across nanopost array 140 using droplet operations; (2) the aqueous sample may be transported off of nanopost array 140 using droplet operations and/or other means and leaving behind a small-volume sample or droplet 144 bound or “stuck” to each hydrophilic nanopost 142; (3) the aqueous sample atop nanopost array 140 may be displaced with an immiscible filler fluid (e.g., filler fluid 216); (4) PCR may be performed at each hydrophilic nanopost 142 of nanopost array 140; and (5) detection operations may be performed at nanopost array 140 to determine, for example, the concentration of a analyte and/or target component in the starting sample.

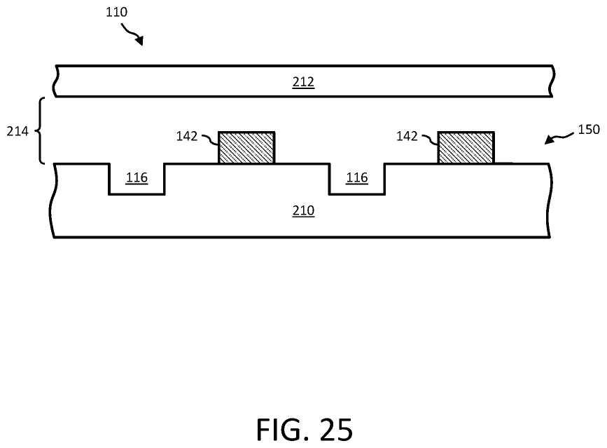

In some embodiments, disclosure provides arrays that may include an arrangement of both hydrophilic nanowells 116 and hydrophilic nanoposts 142. For example, FIG. 25 is a side view showing an example of a of a nano-array 150 that includes both hydrophilic nanowells 116 and hydrophilic nanoposts 142 arranged in alternating fashion.

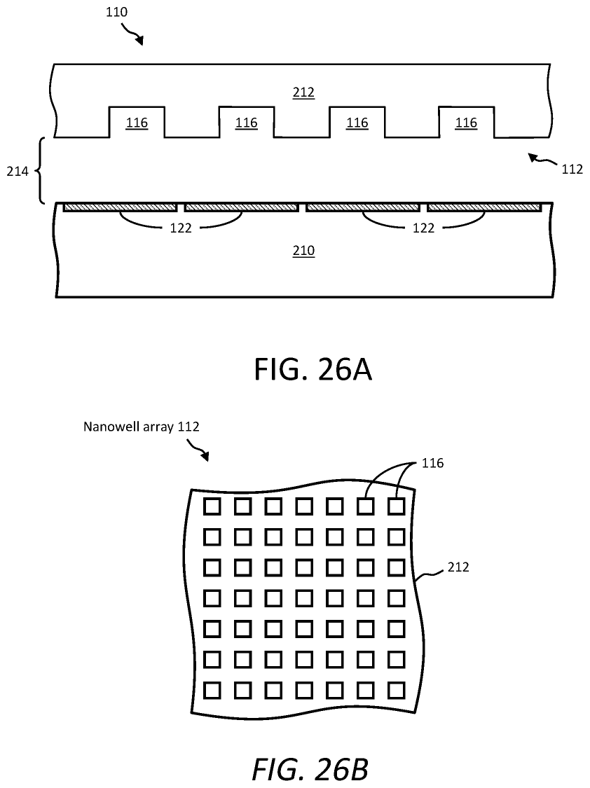

Droplet operations device 110 is not limited to providing nanowell arrays 112 in bottom substrate 210 only. For example, FIG. 26A and FIG. 26B show (not to scale) a side view and a plan view of a of droplet operations device 110 and an example of a nanowell array 112 installed in the top substrate thereof. For example, nanowell array 112 may be provided in top substrate 212 of droplet operations device 110 that includes, for example, the ITO ground reference electrode 218 (not shown) that is substantially transparent to light. In this example, nanowell array 112 is installed on the surface of droplet operation gap 214 that is opposite the droplet operations electrodes 122 instead of on the same surface as droplet operations electrodes 122.

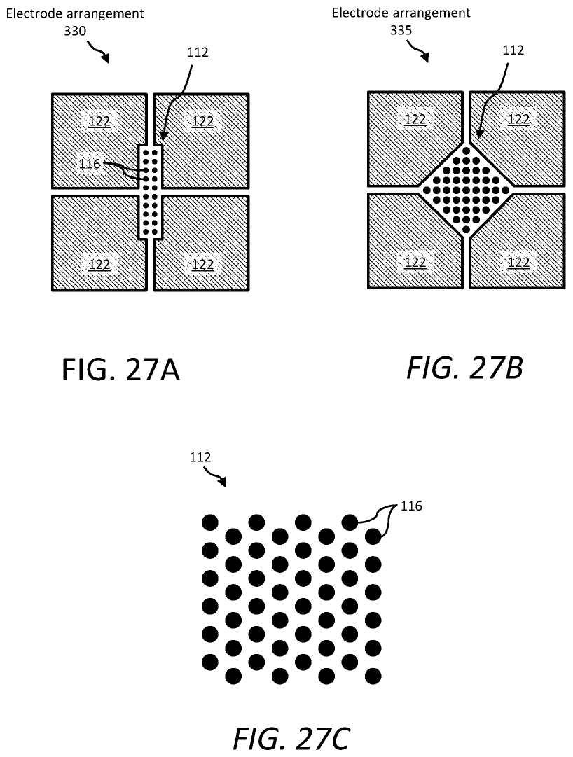

In microfluidics system 100, droplet operations device 110, sample partitioning process 114, and/or method 260, nanowell arrays 112 and/or nanopost arrays 140 are not limited to two-dimensional and/or symmetrical arrangements or configurations. Other arrangements or configurations are possible, as shown for example in FIG. 27A, FIG. 27B, and FIG. 27C. In one example, FIG. 27A shows a plan view of an example of an electrode arrangement 330 including a substantially 1D nanowell array 112. In this example, nanowell array 112 may include one or two columns of nanowells 116. For example, nanowell array 112 may be a 1×144 array or a 2×144 array or a 1×1000 array, and so on. In another example, FIG. 27B shows an example of an electrode arrangement 335 including a nanowell array 112 arranged in a diamond shape with respect to droplet operations electrodes 122. In another example, FIG. 27C shows a plan view of an example of nanowell array 112 in which the rows and columns may be arranged in staggered or offset fashion.

### 6.5. Hydrophilic Guiding and/or Wicking Features

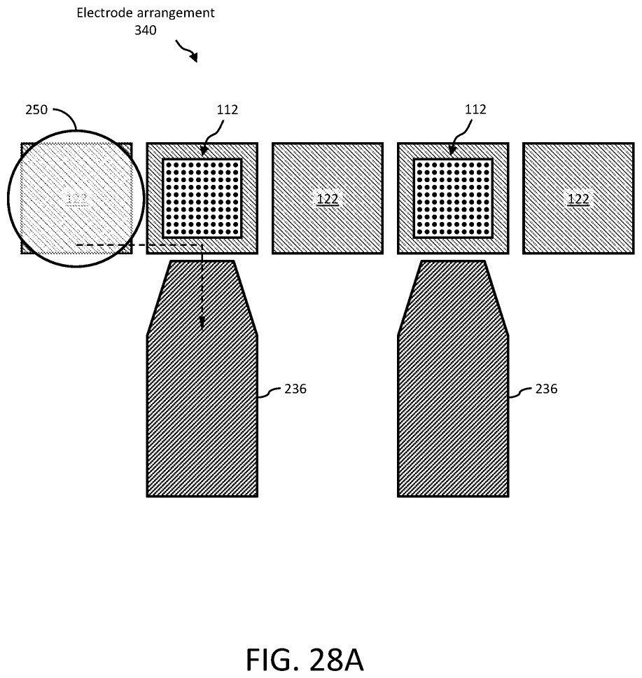

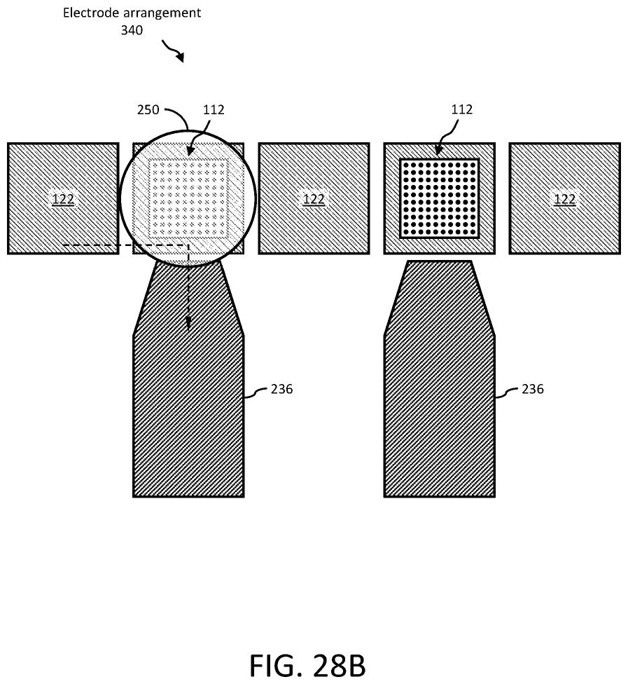

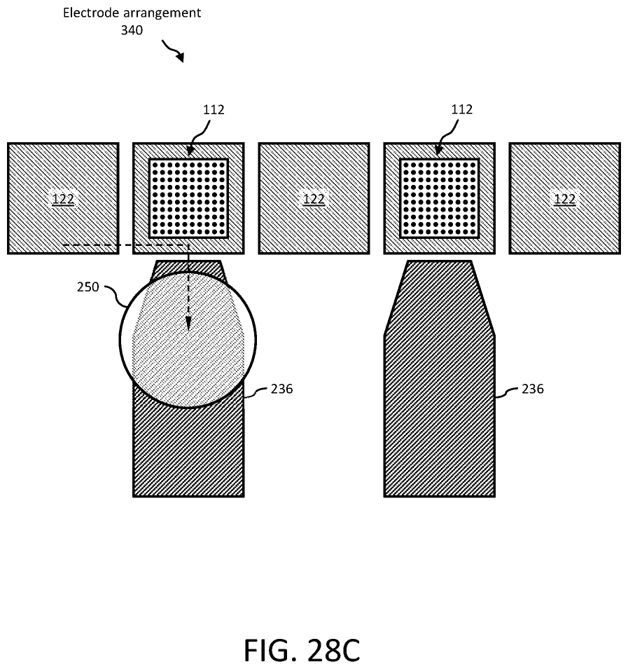

Because the operation of microfluidics system 100, droplet operations device 110, sample partitioning process 114, and/or method 260 may rely on striking a proper balance between the electrowetting forces of droplet operations electrodes 122 and the hydrophilic forces of the nanowell array 112, other features may be provided in droplet operations device 110 to help assist and/or ensure good operation. For example, a balance of forces that allows the aqueous sample to be transported off the nanowell array 112 (or nanopost array 140) using droplet operations, while at the same time leaving behind a small-volume sample or droplet at each hydrophilic nanowell 116 (or nanopost 142). By way of example, FIG. 28A through FIG. 31B below show example features that may be provided in droplet operations device 110 to assist and/or help ensure good operation.

FIG. 28A, FIG. 28B, and FIG. 28C are plan views of an example of an electrode arrangement 340 including an example of hydrophilic wicking features (or hydrophilic sinks) in relation to nanowell arrays 112. In this example, electrode arrangement 340 may include a line of droplet operations electrodes 122 that includes multiple nanowell arrays 112. Then, a capillary wicking feature 236 may be provided in close proximity to any droplet operations electrode 122 that includes a nanowell array 112.

In one example, capillary wicking feature 236 may be a hydrophilic feature or pad that may provide passive capillary forces that may be used to wick the sample off the droplet operations electrodes 122 (after filling the nanowell array 112). The passive capillary forces of capillary wicking feature 236 may be used instead of or together with droplet operations to pull the sample away from nanowell array 112. By way of example, FIG. 28A shows droplet 250 approaching the nanowell array 112 via droplet operations, FIG. 28B shows droplet 250 atop the nanowell array 112, and FIG. 28C shows capillary wicking feature 236 being used to assist pulling droplet 250 off of and away from the nanowell array 112. That is, when droplet 250 comes into contact with capillary wicking feature 236, droplet 250 may be automatically pulled onto capillary wicking feature 236.

The relative size, shape, number, and contact angle of the features of nanowell array 112 with respect to the features of capillary wicking feature 236 may be designed to achieve the best effect. The material of capillary wicking feature 236 may vary from the hydrophilic material of nanowell array 112. For example, capillary wicking feature 236 may be more hydrophilic than nanowell array 112 to ensure complete removal of the bulk liquid from nanowell array 112.

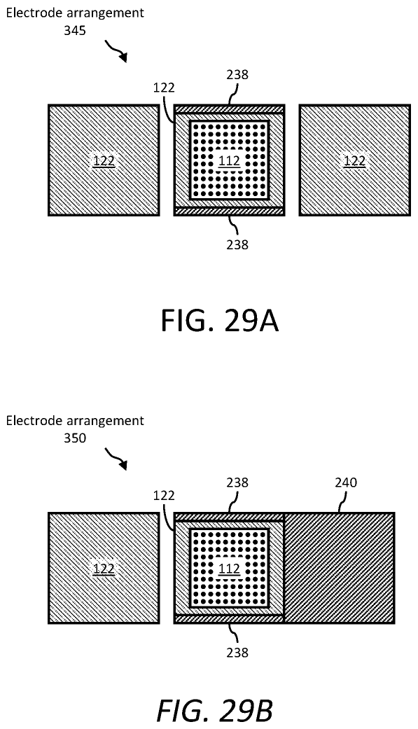

FIG. 29A is a plan view of an example of an electrode arrangement 345 including hydrophilic guiding features in relation to nanowell array 112. In this example, electrode arrangement 345 may include a line of droplet operations electrodes 122 that includes a nanowell array 112. Electrode arrangement 345 further includes a pair of hydrophilic guiderails 238 arranged at two opposite edges of the droplet operations electrodes 122 that includes the nanowell array 112. The pair of hydrophilic guiderails 238 are arranged in parallel with the flow or transport path of droplet 250. The hydrophilic nature of the pair of hydrophilic guiderails 238 may be used to help pull the volume of droplet 250 along and past nanowell array 112 from the leading to the trailing droplet operations electrode 122.

FIG. 29B is a plan view of an example of an electrode arrangement 350 including hydrophilic guiding and/or wicking features in relation to nanowell array 112. In this example, electrode arrangement 350 may include the pair of hydrophilic guiderails 238 described in FIG. 29A. However, instead of exiting droplet 250 off of nanowell array 112 and onto the next droplet operations electrodes 122, droplet 250 may exit off of nanowell array 112 and onto a hydrophilic wicking feature, such as a capillary wicking feature 240. Capillary wicking feature 240 may be substantially the same as the capillary wicking feature 236 described in FIG. 28A, FIG. 28B, and FIG. 28C. Here, the passive capillary forces of capillary wicking feature 240 may be used to assist pulling droplet 250 off of and away from the nanowell array 112. That is, when droplet 250 comes into contact with capillary wicking feature 240, droplet 250 may be automatically pulled onto capillary wicking feature 240.

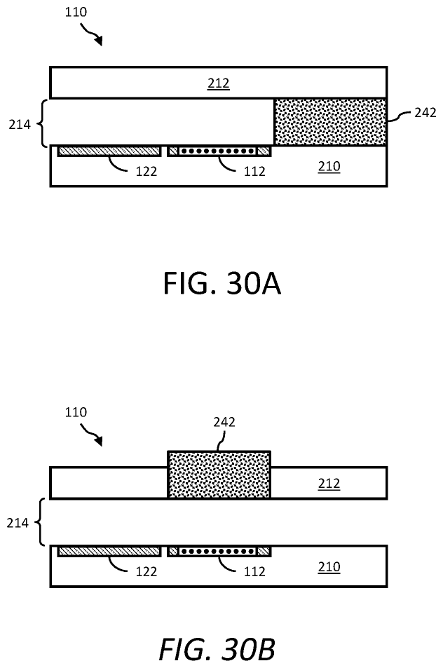

FIG. 30A, shows a three-dimensional (3D) wicking device 242 may be provided in droplet operations gap 214 of droplet operations device 110 and in close proximity to nanowell array 112. 3D wicking device 242 may be, for example, a 3D block of hydrophilic material that may act like a sponge to absorb the aqueous droplet 250 (not shown) and pull it off of and away from nanowell array 112 in sample partitioning process 114 and/or method 260. That is, when droplet 250 comes into contact with 3D wicking device 242, droplet 250 may be automatically pulled into 3D wicking device 242. The hydrophilic 3D wicking device 242 may be formed, for example, of hydrogel.

Similarly, FIG. 30B shows 3D wicking device 242 located in top substrate 210 above nanowell array 112, instead of in droplet operations gap 214 of droplet operations device 110. when droplet 250 contacts 3D wicking device 242, droplet 250 may be automatically pulled into 3D wicking device 242. In FIG. 30A and FIG. 30B, 3D wicking device 242 may be sized to at least hold about the same volume of droplet 250, but may be sized to hold a greater volume than droplet 250.

By tailoring the wicking speed of 3D wicking device 242, the 3D wicking device 242 may provide a way to control the wicking process. For example, 3D wicking device 242 may be tailored such that it wicks at a slower rate than the nanowells 116 of nanowell array 112 fill.

In one example, the 3D wicking device 242 shown in In FIG. 30A and FIG. 30B may be held in a fixed position. In another example, the 3D wicking device 242 shown in In FIG. 30A and FIG. 30B may be moveable. For example, the 3D wicking device 242 may be moved in close proximity to nanowell array 112 when needed. Then, pulled away and drained after use. Then moved back when needed and so on.

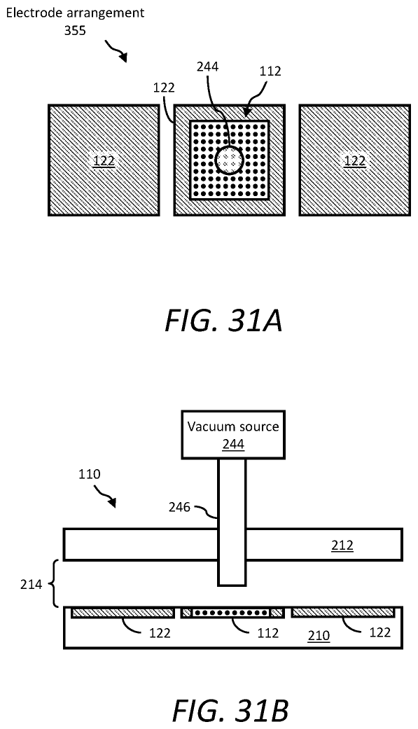

FIG. 31A and FIG. 31B is a top view and a side view of an example of a vacuum source 244 arranged in relation to a nanowell array 112. In this example, vacuum source 244 may be fluidly coupled to droplet operations gap 214 of droplet operations device 110 through a tube 246 passing through top substrate 212. Vacuum source 244 may be used to pull droplet 250 off and away from nanowell array 112 in sample partitioning process 114 and/or method 260. Vacuum source 244 may provide a way to control the liquid removal process. For example, vacuum source 244 may be controlled such that it removes the liquid at a slower rate than the nanowells 116 of nanowell array 112 fill. In another example, vacuum source 244 may be fluidly coupled to droplet operations gap 214 from the side of droplet operations device 110 rather than through top substrate 212.

### 6.6. Processes and/or Forces for Aiding Partitioning

In addition, other types of processes and/or forces may be employed to remove excess liquid from nanowell arrays 112 when partitioning the sample. In one example, because nanowell array 112 may interfere with the electrowetting operations of droplet operations electrodes 122, reducing or eliminating its effectiveness, the transfer of the liquid may be assisted by the use of dielectrophoresis (DEP). DEP is a phenomenon in which a force is exerted on a dielectric particle when it is subjected to a non-uniform electric field. This force does not require the particle to be charged. All particles exhibit dielectrophoretic activity in the presence of electric fields. Here, DEP-based liquid actuation can be achieved using droplet operations electrodes 122 but with different voltages and frequencies than used with standard droplet operations. Importantly, DEP acts at the bulk of the liquid, unlike electrowetting which acts at the surface and therefore is more tolerant of the interference of surface features, such as nanowell arrays 112 as described herein.

In another example, a flow field may be created in the filler fluid in order to provide hydrodynamic forces to assist removal of the liquid. This flow field may be generated using traditional means such vacuum or displacement pumping. Another technique uses electrolysis to quickly generate gas bubbles in a controlled manner to displacement excess liquid. In yet another technique, acoustic forces, or forces generated by intense light may be used.

In yet another example, magnetically responsive beads may be used to assist in the removal of excess liquid. For example, hydrophilic (i.e., silica) magnetically responsive beads within the sample droplet may be used to pull away excess sample liquid using a moving external permanent magnet.

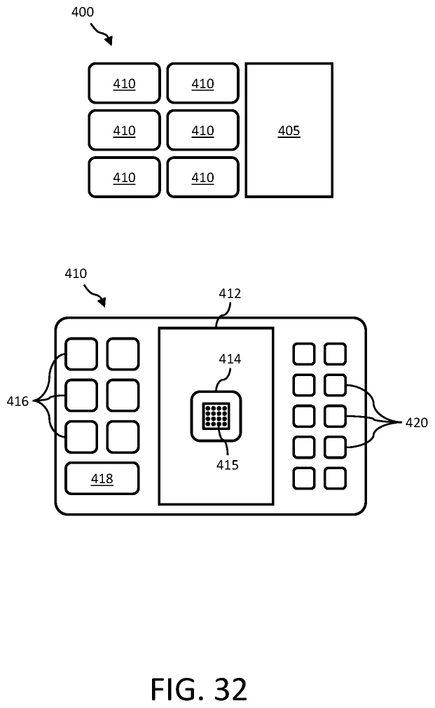

FIG. 32 is a simplified block diagram of an example of a point of care (POC) instrument 400 for processing consumable DMF cartridges (or devices) 410 that may be used for processes of partitioning samples for bioanalysis. POC instrument 400 may include a control unit 405. Each DMF cartridge 410 may include, for example, a DMF substrate 412 (e.g., PCB), a CMOS DMF device (or chip) 414 mounted on DMF substrate 412, a plurality of reagent reservoirs 416 for holding standard/bulk reagents, a sample reservoir 418 for holding a quantity of sample liquid to be processed, and other reagent reservoirs 420 for holding custom reagents. CMOS DMF device 414 may include an array or any arrangement of microwells 415. CMOS DMF device 414 may be an example of CMOS DMF device 198 shown in FIG. 1 and FIG. 2.

Features of POC instrument 400 may include, for example, fully integrated upfront sample processing, single sample per DMF cartridge 410, extensible random-access cartridge bays for flexible capacity, and FDA cleared and CLIA waived. Features of DMF cartridges 410 may include, for example, all cartridges use the same CMOS chip, common cartridge but different reagent loadout per test, all reagents preloaded on each DMF cartridge 410.

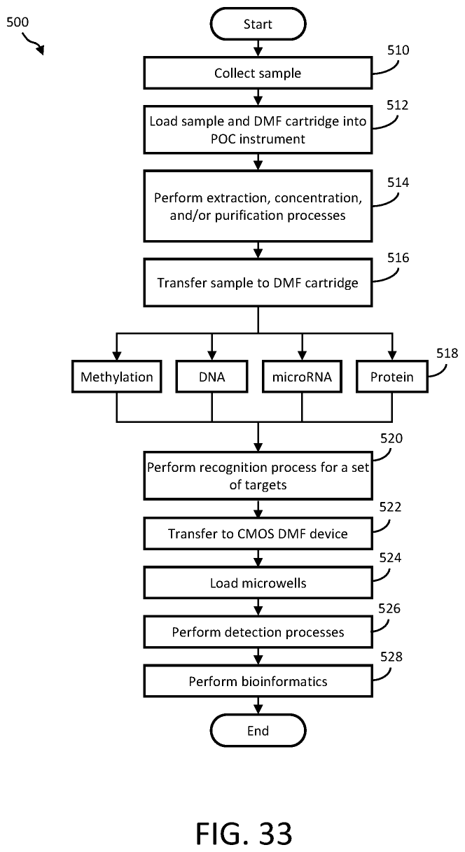

FIG. 33 is a flow diagram of an example of a sample-to-answer workflow 500 for partitioning sample volumes for bioanalysis of a set of targets in the sample. In one example, sample-to-answer workflow 500 may be performed using POC instrument 400 and the consumable DMF cartridges (or devices) 410 shown in FIG. 32. Sample-to-answer workflow 500 may include, but is not limited to, the following steps.

At a step 510, a sample is collected. For example, a blood or saliva sample may be collected.

At a step 512, both the sample and the DMF cartridge is loaded into the instrument. For example, both the sample and one of the DMF cartridges 410 may be loaded into POC instrument 400.

At a step 514, extraction, concentration, and/or purification processes are performed. For example, extraction, concentration, and/or purification processes are performed on the sample at POC instrument 400.

At a step 516, the processed sample liquid is transferred into the DMF cartridge. For example, the processed sample liquid may be transferred from a container in POC instrument 400 to the DMF substrate 412 (e.g., PCB) of DMF cartridge 410.

At steps 518, methylation, DNA, miRNA, and/or protein is processed with respect to the sample to provide a set of target analytes (“targets”). For example, using droplet operations at the DMF substrate 412 (e.g., PCB) of DMF cartridge 410, methylation, DNA, microRNA, and protein is processed with respect to the sample. The set of targets may, for example, be extracellular nucleic acids such as wild-type and mutated DNA (e.g., genetic variants of a sequence of interest), DNA fragments selected for methylation analysis, or microRNA (miRNA). The set of targets may, for example, be proteins.

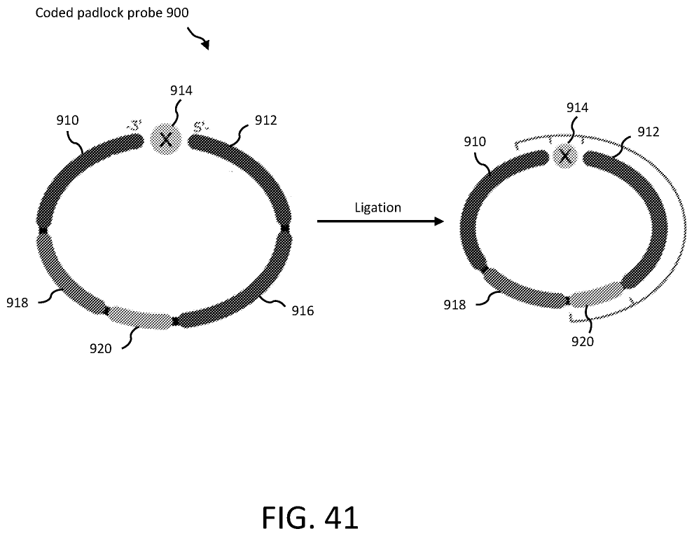

At a step 520, a recognition process for the set of targets is performed. The recognition process may use a set of recognition elements, wherein each target in the set of targets is uniquely recognized by and bound to a recognition element and wherein the recognition element is associated with a code. In one example, the set of targets is a set of DNA targets, and the recognition process for the DNA targets uses a panel of coded padlock probes. For example, using droplet operations at the DMF substrate 412 (e.g., PCB) of DMF cartridge 410, a padlock probe panel is processed with respect to the set of DNA targets in the sample. The use of coded padlock probes for detecting targets of interest is described in more detail below with reference to FIG. 41 through 48.

At a step 522, the sample liquid is transferred into the DMF device. For example, the sample liquid may be transferred from the DMF substrate 412 (e.g., PCB) of DMF cartridge 410 to CMOS DMF device 414 that includes an array or arrangement of microwells 415.

At a step 524, microwells of the CMOS DMF device are loaded with sample droplets. For example, microwells of CMOS DMF device 414 of DMF cartridge 410 are loaded with sample droplets.

At a step 526, detection processes are performed with respect to the microwells of the CMOS DMF device. For example, detection processes may be performed with respect to the microwells 415 of CMOS DMF device 414 of DMF cartridge 410.

At a step 528, using detection information from step 526, bioinformatics may be performed. For example, using detection information from step 526, bioinformatics may be performed by control unit 405 of POC instrument 400.

FIG. 34 is a plan view of an example of CMOS DMF device 198 of the microfluidics system 100. CMOS DMF device 198 may be used, for example, as a digital assay processor. In this example, nanowells (or microwells) may be provided in the spaces between the droplet operations electrodes of CMOS DMF device 198.

CMOS DMF device 198 may include, for example, a DMF electrode array 610 formed by an n×n arrangement of droplet operations electrodes 612. Regions of active circuitry 614 may be provided around the periphery of DMF electrode array 610. Arrangements of fluid I/O reservoirs 616 and bond pads 618 may be provided around the periphery of DMF electrode array 610. An expanded view A of FIG. 34 shows that the droplet operations electrodes 612 may form a high voltage 620 of CMOS DMF device 198. By contrast, a space between the droplet operations electrodes 612 may form a low voltage 622 of CMOS DMF device 198. More specifically, an expanded view B of FIG. 34 shows arrangements of nanowells 624 (or microwells 624) may be provided within the low voltage portions 622 of CMOS DMF device 198. Each of the nanowells 624 may include a photodiode (not visible).

The CMOS DMF device 198 shown in FIG. 34 may be, for example, a 10.5 mm×10.5 mm CMOS Die including 64×150 μm×150 μm bond pads on 2 sides and 24×450 μm×450 μm fluid reservoirs on 2 sides. DMF electrode array 610 may be, for example, a 58×64 DMF electrode array, which is 3,712 total electrodes. DMF electrode array 610 may include a 150 μm pitch with 135 μm electrode and 15 μm spacing. The DMF area may be 8.7 mm×9.6 mm. Nanowells 624 with photodiodes may be located within 15 μm spacing between droplet operations electrodes 612. In an example, the nanowells are on a μm pitch and have a 2.5 μm diameter.

FIG. 35 is a plan view of another example of CMOS DMF device 198 of the microfluidics system 100. CMOS DMF device 198 may be used as a digital assay processor. In this example, an array of nanowells 624 (or microwells 624) may be provided within each of the droplet operations electrodes 612 of CMOS DMF device 198. An expanded view A of FIG. 35 shows that the droplet operations electrodes 612 may form a high voltage 620 of CMOS DMF device 198. By contrast, nanowells 624 (or microwells 624) within each of the droplet operations electrodes 612 may form a low voltage 622 of CMOS DMF device 198. More specifically, an expanded view B of FIG. 34 shows an array of nanowells 624 (or microwells 624) may be provided within each of the droplet operations electrodes 612 of CMOS DMF device 198. Each of the nanowells 624 may include a photodiode (not visible).

The CMOS DMF device 198 shown in FIG. 35 may be, for example, a 10.5 mm×10.5 mm CMOS Die including 64×150 μm×150 μm bond pads on 2 sides and 24×450 μm×450 μm fluid reservoirs on 2 sides. DMF electrode array 610 may be, for example, a 58×64 DMF electrode array, which is 3,712 total electrodes. DMF electrode array 610 may include a 150 μm pitch with 135 μm electrode and 15 μm spacing. The DMF area may be 8.7 mm×9.6 mm. Nanowells 624 with photodiodes may be located within each of the droplet operations electrodes 612.

Compared with the layout of CMOS DMF device 198 shown in FIG. 34, the layout of CMOS DMF device 198 shown in FIG. 35 doubles the allowed pitch of nanowells 624 to 7 μm and still achieves substantially the same total number of photodiodes. The larger pitch allows more options for photodiode device choices and layout. In the layout of CMOS DMF device 198 shown in FIG. 35, processing of the DNA can occur with the droplet in place over the droplet operations electrode 612, if desired. It may be easier to center a droplet over a droplet operations electrode 612 than to hold it between droplet operations electrodes 612.

FIG. 36 is a block diagram of an example of the microfluidics system 700 including a DMF flip-chip cartridge (or module) 705. Microfluidics system 700 including DMF flip-chip cartridge 705 may be used as a digital assay processor. Microfluidics system 700 may be substantially the same as microfluidics system 100 shown in FIG. 1 except that droplet operations device 110 further includes a DMF flip-chip 710. DMF flip-chip 710 installed on droplet operations device 110 forms DMF flip-chip cartridge 705. DMF flip-chip 710 may be any flip-chip technology including any insulating material having patterned conductors, such as a semiconductor chip, such as Si, SiC, or GaN, a glass chip, a multilayer laminate substrate, or Low-Temperature Co-fired Ceramic (LTCC) substrate.

Droplet operations device 110 of DMF flip-chip cartridge 705 may include and/or support sample partitioning process 114 that may use one or more nanowell arrays 112, the direct detection of single molecules using molecular sensors 192, PCB-based DMF 194, active matrix-based DMF 196 (e.g., CMOS DMF device 198), and/or any other processes of droplet operations device 110 that are described herein with reference to FIG. 1 through FIG. 36. DMF flip-chip 710 may also include any processes and/or components 712 that may be used to support sample partitioning process 114 that may use one or more nanowell arrays 112, the direct detection of single molecules using molecular sensors 192, PCB-based DMF 194, active matrix-based DMF 196 (e.g., CMOS DMF device 198), and/or any other processes of droplet operations device 110.

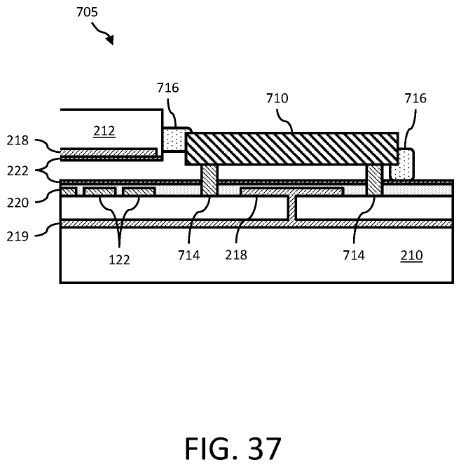

FIG. 37 is a side view of a of an example of DMF flip-chip cartridge 705 of microfluidics system 700 shown in FIG. 36. In this example, the base structure of DMF flip-chip cartridge 705 may still be DMF structure 200 shown FIG. 3A and FIG. 3B but with the addition of DMF flip-chip 710 mounted atop bottom substrate 210 and alongside of top substrate 212. DMF flip-chip 710 may be an example of CMOS DMF device 198 (see FIG. 34 and FIG. 35).

In this example, bottom substrate 210 may be a PCB. The PCB may include, for example, a set of DMF control lines (i.e., electrical signals and/or electrowetting voltages) as well as a ground reference plane and/or lines. Droplet operations may be performed on the PCB. The PCB may serve as the mechanical substrate for DMF flip-chip cartridge 705.

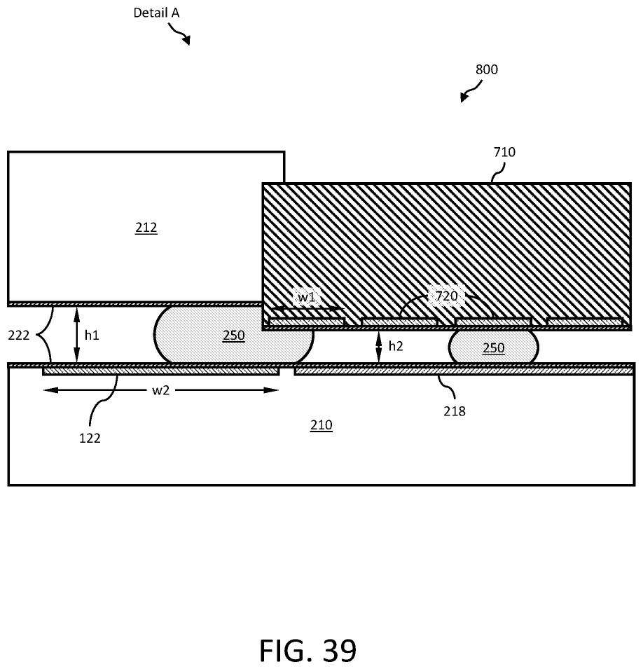

DMF flip-chip 710 may be mounted atop bottom substrate 210 using, for example, copper pillars 714. In addition to the mechanical fastening function of copper pillars 714, the copper pillars 714 may be used to provide a controlled standoff spacing between DMF flip-chip 710 and bottom substrate 210 for performing droplet operations (see FIG. 39). Copper pillars 714 may also be used for connection of electrical signals from the PCB to the chip 710. A seal 716 may be provided around the perimeter of DMF flip-chip 710. In one example, seal 716 may be a silicone seal. One function of seal 716 is to prevent evaporation at the droplet operations surface. Another function of seal 716 is to contain filler fluid and/or other liquids inside the sealed region. Top substrate 212 may abut and/or overlap DMF flip-chip 710 to form a seal for the fluids in combination with seal 716.

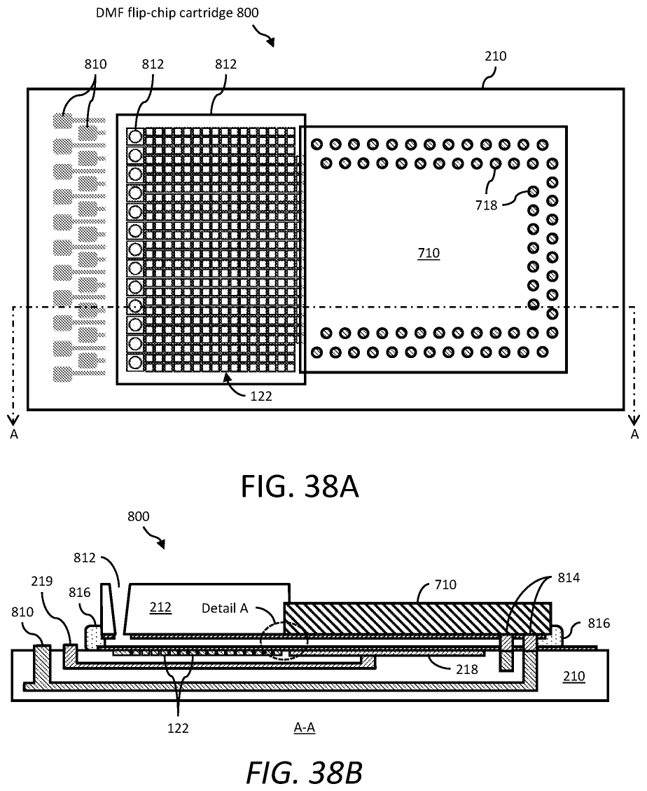

FIG. 38A and FIG. 38B is a plan view and a cross-sectional view of a DMF flip-chip cartridge 800, which is another example of DMF flip-chip cartridge 705 of microfluidics system 700 shown in FIG. 36. In this example, DMF flip-chip cartridge 800 may include one top substrate 212. FIG. 38B shows a cross-section taken along line AA of FIG. 38A. In this example, top substrate 212 is provided with respect to one of bottom substrate 210 and DMF flip-chip 710 is provided with respect to another of bottom substrate 210.

In this example, an array of droplet operations electrodes 122 may be provided at the of DMF flip-chip cartridge 800 including bottom substrate 210 and top substrate 212. Bottom substrate 210 (the PCB) may include an arrangement of DMF control lines 810 (i.e., electrical signals and/or electrowetting voltages). Top substrate 212 may include an arrangement of loading ports 812 for loading liquid to be processed on DMF flip-chip cartridge 800. FIG. 38A shows that DMF flip-chip 710 has a plurality of input/output (I/O) pads 718. DMF flip-chip 710 may be mounted atop bottom substrate 210 using, for example, copper pillars 814 that may provide a standoff spacer as well as electrical connection to I/O pads 718 of DMF flip-chip 710. A seal 816 may be provided around the perimeter of DMF flip-chip 710.

In this example, the of DMF flip-chip cartridge 800 including bottom substrate 210 and top substrate 212 may be used to perform bulk DMF, as is well known. However, in DMF flip-chip cartridge 800, using droplet operations, liquid may be transferred from the bulk DMF of bottom substrate 210 to DMF flip-chip 710. Additional droplet operations and/or sensing operations may be performed at DMF flip-chip 710.

FIG. 38B shows that a ground reference electrode 218 may be provided on bottom substrate 210 and opposite DMF flip-chip 710. This ground reference electrode 218 may provide the ground reference for DMF operations of DMF flip-chip 710 and may be supplied by a ground reference line 219. By contrast, top substrate 212 also includes a ground reference electrode 218 (not shown) for performing the bulk DMF that is separate from the DMF operations of DMF flip-chip 710.

High electrowetting voltages (e.g., 10s to 100s of volts) may be present at the bulk DMF of DMF flip-chip cartridge 800 (i.e., the of DMF flip-chip cartridge 800 including bottom substrate 210 and top substrate 212). By contrast, low voltages (e.g., from about 80 volts to about 200 volts) may be used to perform the DMF operations at DMF flip-chip 710.

FIG. 39 is a side view of a Detail A of FIG. 38A and FIG. 38B and showing more details of the transition of DMF flip-chip cartridge 800 from the bulk DMF to the DMF operations of DMF flip-chip 710. In this example, droplet operations electrodes 720 may be provided on the surface of DMF flip-chip 710 that is opposite bottom substrate 210, and thus the need for ground reference electrode 218 on bottom substrate 210. Droplet operations electrodes 112 are atop bottom substrate 210 in the bulk DMF of DMF flip-chip cartridge 800.

In one example, droplet operations electrodes 720 at DMF flip-chip 710 may be smaller than the droplet operations electrodes 112 atop bottom substrate 210. For example, droplet operations electrodes 720 may have a width w1 of from about 50 μm to about 1000 μm. Droplet operations electrodes 122 may have a width w2 of from about 800 μm to about 8000 μm.

A droplet (e.g., droplet 250) may move via droplet operations from droplet operations electrodes 122 atop bottom substrate 210 to droplet operations electrodes 720 of DMF flip-chip 710. In one example, there may be a gap height h1 between bottom substrate 210 and top substrate 212 and a smaller gap height h2 between bottom substrate 210 and DMF flip-chip 710. Gap height h1 may be, for example, from about 200 μm to about 400 μm. Gap height h2 may be, for example, from about 10 μm to about 150 μm.

In this example, droplet 250 may be exposed to high voltage (e.g., 10s to 100s of volts) on droplet operations electrodes 122 of bottom substrate 210 as it transitions to DMF flip-chip 710. DMF flip-chip 710 need only to tolerate the high voltage at the first droplet operations electrode 720 at the edge of DMF flip-chip 710, and wherein the chip interior is not required to tolerate the high voltage. This is because, once droplet 250 moves off the droplet operations electrode 122 leading to DMF flip-chip 710 and onto the droplet operations electrodes 720 of DMF flip-chip 710, the voltage potential of the droplet drops to from about 80 volts to about 200 volts on droplet operations electrode 720.

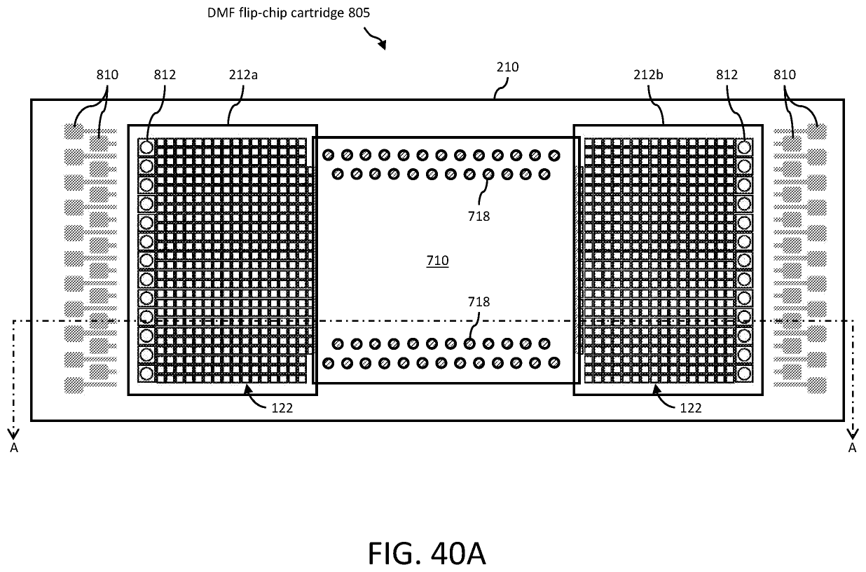

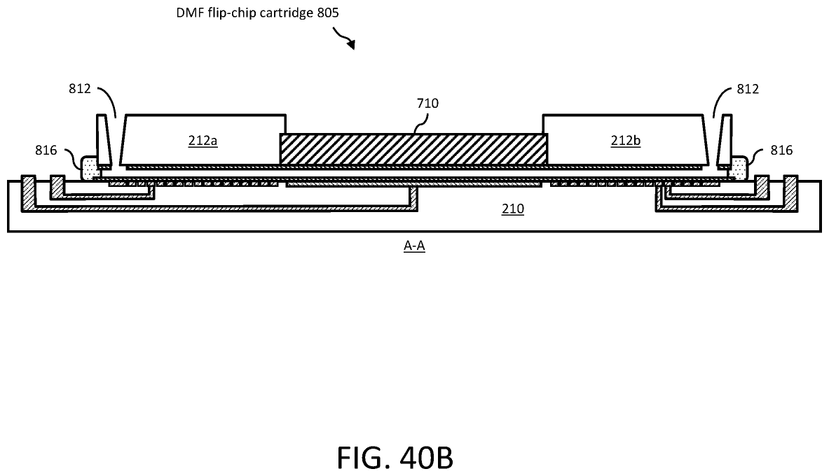

FIG. 40A and FIG. 40B is a plan view and a cross-sectional view of a DMF flip-chip cartridge 805, which is another example of DMF flip-chip cartridge 705 of microfluidics system 700 shown in FIG. 36. In this example, DMF flip-chip cartridge 805 may include two top substrates 212. DMF flip-chip cartridge 805 may be substantially the same as DMF flip-chip cartridge 800 shown in FIG. 38A and FIG. 38B except that DMF flip-chip 710 may be flanked on each side by a bulk DMF portion. For example, a top substrate 212a in relation to bottom substrate 210 may be provided on one side of DMF flip-chip 710 and wherein a droplet may transition from top substrate 212a to one side of DMF flip-chip 710. A top substrate 212b in relation to bottom substrate 210 may be provided on the opposite side of DMF flip-chip 710 and wherein a droplet may transition from top substrate 212b to opposite side of DMF flip-chip 710.

DMF flip-chip cartridges, such as DMF flip-chip cartridges 800 and 805, are not limited to one or two bulk DMF portions feeding one or two sides of one DMF flip-chip 710. In another embodiment, a DMF flip-chip cartridge may include three bulk DMF portions (e.g., including three top substrates 212) feeding three of the four sides of one DMF flip-chip 710. In yet another embodiment, a DMF flip-chip cartridge may include four bulk DMF portions (e.g., including four top substrates 212) feeding four of the four sides of one DMF flip-chip 710.

If a transparent chip with electrodes is used as top substrate(s) 212, then optical sensing of reactions due to DMF processing through top substrate(s) 212 is enabled. This provides the option of optically sensing outside of the cartridge.

### 6.7. Coded Padlock Probes

Bioanalysis of a set of targets in a sample may be performed using target-specific encoded probes. An encoded probe may include a target-specific recognition element that is associated with a code. At a high level, in an assay using an encoded probe, a target analyte (“target”) is detected based on association of the target with the code and detection of the code is used as a surrogate for detection of the analyte. In one example, the encoded probe is a coded padlock probe.

An assay using encoded probes (i.e., an encoded assay) may include (i) a recognition event, in which a target is uniquely recognized by a recognition element associated with a code (e.g., a coded padlock probe); (ii) a transformation event, in which a molecular transformation of the recognition element produces a modified recognition element comprising the code; and (iii) a detection event, which detects the code as a surrogate for detection of the target analyte, e.g., by recognizing or determining the sequence of the code (and optionally other elements). The detection event may include an amplification step in which the code is amplified.

FIG. 41 is a schematic diagram of an example of a coded padlock probe 900 that may be used in an encoded assay performed using the microfluidics systems 100, 700.

By contrast, the benefits of coding may include, for example, target sequence mapped to a target-specific code (i.e., a locus code) plus variant of interest, rolling circle amplification (RCA) or hyberbranched (HRCA) amplification, very short sequencing (e.g., 30 bases), and telecoms-inspired known sequences. As a result, and as compared with traditional sequencing coding may provide flexible and easily updateable content; simultaneous multi-omic target detection; improved conversion efficiency; low amplification bias; allows molecular signal processing including target plus sample multiplexing, error correction, and interference cancellation; improved TAT; and lower cost.

Each coded padlock probe 900 may include a pair of target-specific oligonucleotide “arms”, arm 910 and arm 912, located at the ends of the coded padlock probe. Oligonucleotide arm 910 and arm 912 are complementary to a target sequence of interest. The two ends of the coded padlock probe may be synthesized to be a perfect complement to the target sequence of interest and flank a variant of interest 914. For example, arm 910 and arm 912 are complementary to each side of a variant 914 of interest (indicated here as “x”). Coded padlock probe 900 may include a locus specific code 916 that is associated with the target sequence of interest. Coded padlock probe 900 may also include an amplification primer sequence 918. In one example, primer sequence 918 is a universal amplification primer sequence. Coded padlock probe 900 may also include a sample index sequence 920. Correct hybridization of arms 910 and 912 to the target sequence of interest effectively circularizes coded padlock probe 900. A ligation reaction may then be used to form a closed circular coded padlock probe 900. The closed circular coded padlock probe 900 may then be amplified. In one example, a rolling circle amplification reaction may be performed using primer sequence 918 to amplify coded padlock probe 900. A detection event, which detects locus-specific code 920 as a surrogate for detection of the target analyte may then be performed, e.g., by recognizing or determining the sequence of the locus-specific code (and optionally other elements).

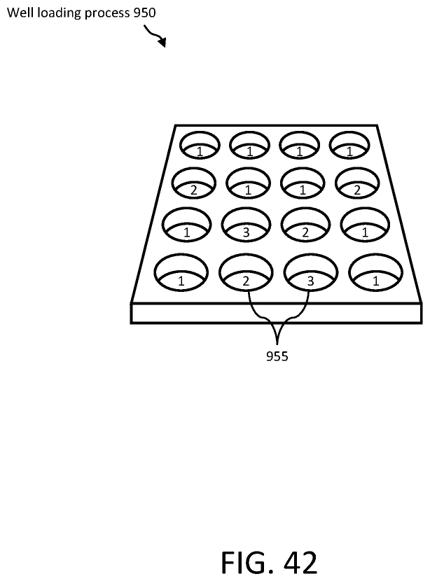

FIG. 42 is a perspective view of an example of a simplified well loading process 950 using DMF and coding that may be performed using the microfluidics systems 100, 700. Drawbacks of traditional methods of well loading may include, for example, loading molecules into wells is governed by Poisson Distribution, and only about 67% well loading efficiency because not all wells are loaded and cannot detect multi-loaded wells.

By contrast, the benefits of using DMF and coding in well loading process 950 may include, for example, >100% well loading efficiency because there are no empty wells and are able to detect individual molecules in multi-loaded wells 955. In well loading process 950, DMF provides optimal loading and coding provides optimal detection. That is, coding enables all molecules to be uniquely identified.

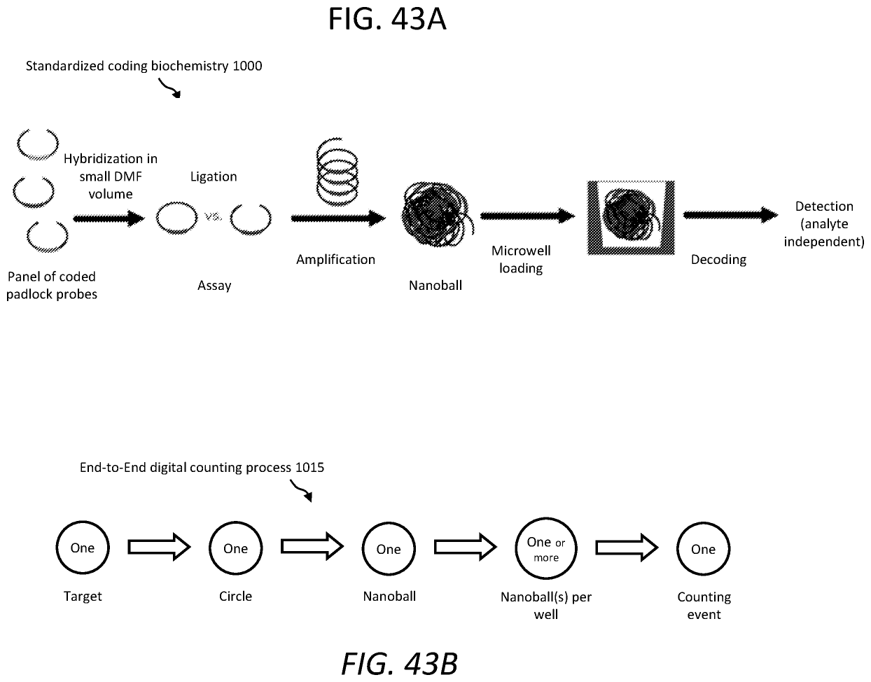

FIG. 43A is a schematic diagram of an example of standardized coding biochemistry 1000 that may be performed using the microfluidics systems 100, 700. Coding biochemistry process 1000 uses a panel of coded padlock probes that is specific for a set of targets that may be present in a sample. The panel of coded padlock probes may be selected based on the assay to be performed. Examples of assays that may be performed include, but are not limited to, genotyping assays, methylation specific assays, proteomics, and gene expression assays. The panel of coded padlock probes may be hybridized to target sequences in a DMF hybridization reaction (e.g., a capture hybridization reaction). In one example, the hybridization reaction may be performed in about 60 minutes. A gap-fill ligation reaction may then be performed to ligate the ends of a padlock probe that has correctly hybridized to a target of interest to form a closed circular coded padlock probe. In one example, the ligation reaction may be performed in about 30 minutes. An amplification reaction may be performed to amplify the closed circular coded padlock probes. In one example, the amplification reaction is a rolling circle amplification reaction (RCA). In one example, RCA may be performed in about 30 minutes. The RCA reaction generates a nanoball which includes multiple copies of a single original assay target. The nanoballs formed may then be loaded into microwells of the DMF device. One or more nanoballs may be loaded per microwell. In one example, the nanoball loading process may be performed in about 10 minutes. A detection process may be performed to decode the encoded padlock probe that is associated with the target sequence of interest. The detection process detects the code as a surrogate for detection of the target analyte, e.g., by recognizing or determining the sequence of the code (and optionally other elements). In one example, the detection process (e.g., determining the sequence of the code and other elements, and analysis) may be performed in about 10 minutes.

The number of detection events can be counted to provide a determination on the status of the targeted DNA sequences of interest. FIG. 43B is a schematic diagram of an example of an end-to-end digital counting process 1015. For example, correct hybridization of a coded padlock probe to a target of interest generates one circular coded padlock probe is amplified to produce one nanoball. One or more nanoball(s) per microwell provides one counting event.

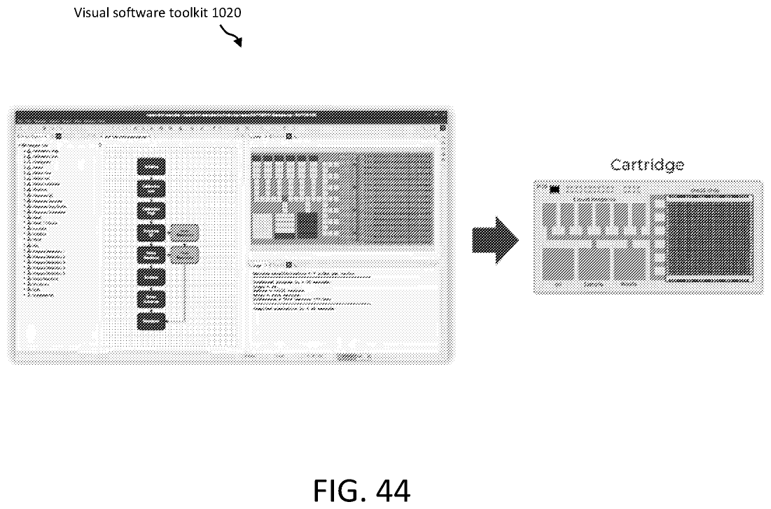

FIG. 44 is a block diagram of an example of a visual software toolkit 1020 that may be used in an assay development environment of the microfluidics systems 100, 700. For example, visual software toolkit 1020 may be cloud based and may support research-to-clinical assay development. Visual software toolkit 1020 may support script generation, simulation, execution, droplet routing, assay scheduling, and runtime constraints.

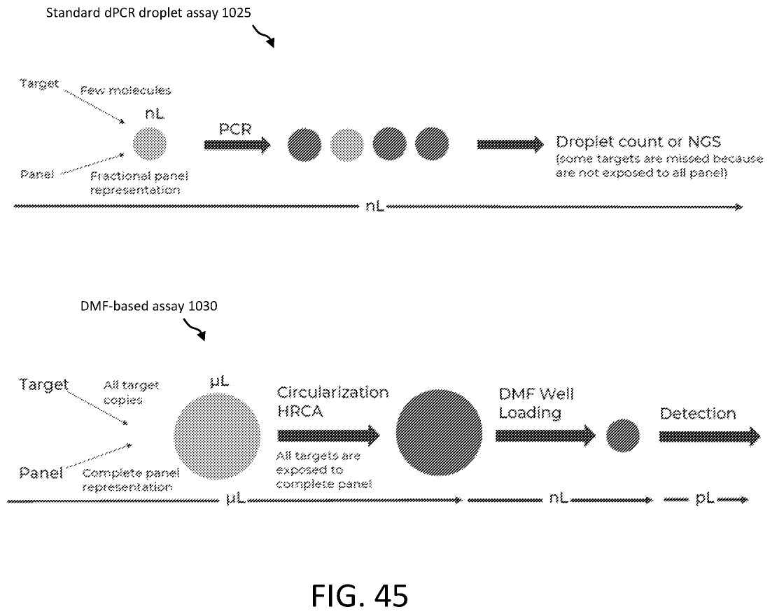

FIG. 45 is schematic diagrams comparing a standard digital PCR (dPCR) droplet assay 1025 with a DMF-based assay 1030 that may be performed using the microfluidics systems 100, 700. In the standard dPCR droplet assay, nL droplet volumes are typically used. Because the droplet volumes are relatively large throughout the process, an individual droplet may only include few molecules and a fraction of the panel of encoded probes. In DMF-based assay 1030, the DMF-based prep (i.e., going from μL droplet volumes to pL droplet volumes for detection) ensures full panel representation when exposed to panel.

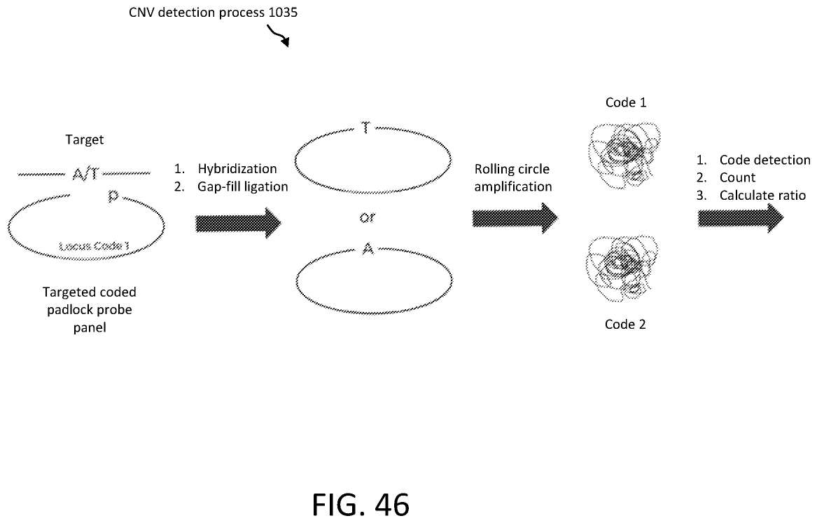

FIG. 46 is a schematic diagram of an example of a copy number variation (CNV) detection process 1035 that may be performed using the microfluidics systems 100, 700. CNV detection process 1035 uses targeted SNP genotyping and allelic ratio determination. In CNV detection process 1035, the panel sensitivity and specificity can be further increased by designing multiple padlock probes for each target site and using degenerate hypercodes.

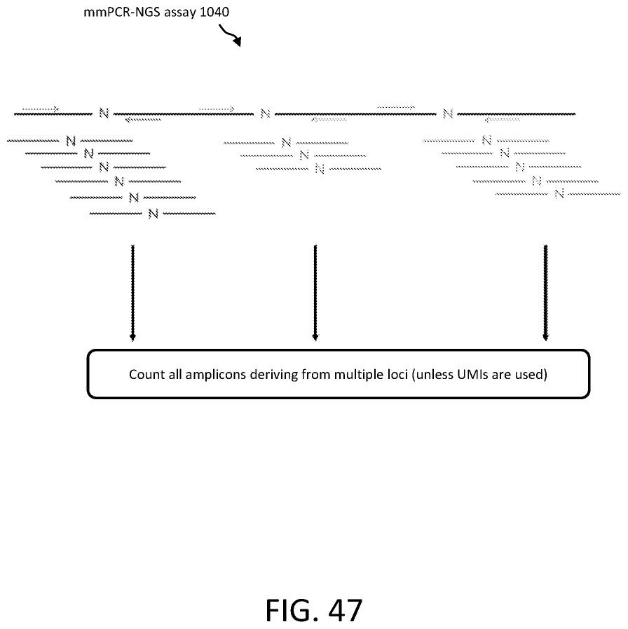

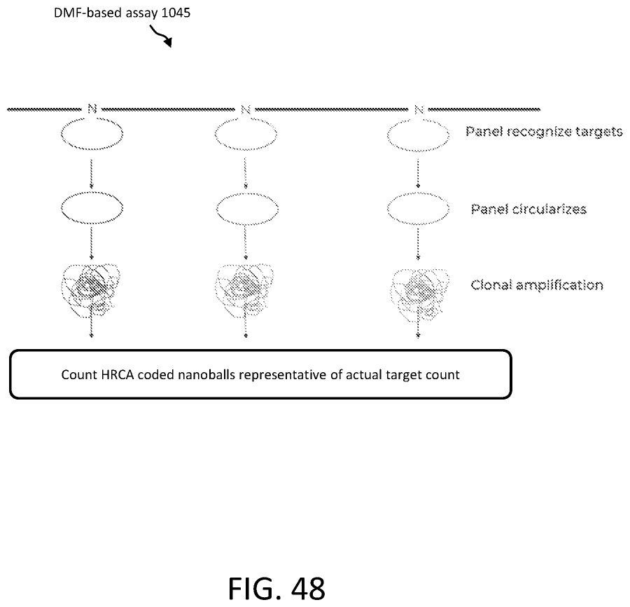

FIG. 47 is a schematic diagram of an example of a standard massively multiplexed PCR-NGS (mmPCR-NGS) assay 1040. An mmPCR-NGS assay may, for example, be used to detect multiple target sequences (e.g., SNPs, CNVs) of interest in a sample. In the standard mmPCR-NGS assay, all amplicons deriving from multiple loci are typically counted and unique molecular identification sequence (UMIs) must be used to distinguish the amplicons. By contrast, FIG. 48 shows a schematic diagram of an example of an equivalent DMF-based assay 1045 that may be performed using the microfluidics systems 100, 700. In the DMF-based assay, the code associated with each amplified target sequence (e.g., each HRCA nanoball) is used to provide a representative count of the actual target count.

### 6.8. Molecular Sensors

The disclosure provides a molecular sensor (e.g., molecular sensor 192) for direct detection of a single molecule target in a sample. For example, multiple molecular sensors may be arrayed on a substrate surface of a droplet operations device (e.g., droplet operations device 110 of FIG. 1 and FIG. 2) in a one-dimensional (1D) or two-dimensional (2D) array. The same substrate may contain droplet operations electrodes (e.g., droplet operations electrodes 122) for performing sample preparation steps and for delivery of sample and/or reagent droplets to the molecular sensor for analysis.

In some embodiments, a molecular sensor may include a first contact electrically coupled to a first electrode and a second contact electrically coupled to a second electrode that are separated by a gap, wherein the gap is spanned by a bridge molecule such that interaction of the bridge molecule with a single molecule target generates a detectable change in an electrical signal and/or measurement between the first and second electrodes.

In some embodiments, the bridge molecule of a molecular sensor may be a protein, such as an alpha helix. The protein bridge molecule may, for example, be attached to the first and second contacts of the molecular sensor through an antigen-antibody or a streptavidin-biotin linkage.

In some embodiments, the bridge molecule of a molecular sensor may be a biopolymer, such as double-stranded DNA (dsDNA). The DNA bridge molecule may, for example, be attached to the first and second contacts of the molecular sensor through a thiol-gold linkage.

In some embodiments, the bridge molecule of the molecular sensor may be attached to a probe molecule. The probe molecule may, for example, be attached to the bridge molecule through a streptavidin-biotin linkage. The probe molecule is selected based on the molecule to be detected or the biochemical reaction to be monitored by the molecular sensor. For example, for DNA detection, the probe molecule may be a ssDNA molecule containing a sequence that is complementary to the sequence to be detected. Hybridization of the target sequence to the probe is detected by a change in electrical current (or other electrical property) of the sensor device. Other types of probes may include enzymes, ribozymes, and other molecules. Any molecule or complex that exhibits a change in physical, chemical, or electrical properties in response to binding or processing of a target molecule may be used as a probe.

In various embodiments, the invention provides molecular sensors for the detection of modified nucleotides in specific sequences in a DNA sample.

Modified nucleotides, such as methylated bases, may induce a conformational change during the template-dependent reaction. This conformational change in turn can modulate an electrical signal that can be analyzed to infer the presence of the modified base. In some embodiments, a conformational change in an enzyme (i.e., a polymerase) catalyzing template-dependent incorporation of nucleotide bases may be used to determine the methylation status of a targeted DNA sequence.

In some embodiments, a DNA probe may be used to detect the presence of a complementary DNA target sequence through a hybridization event. In a subsequent step, the methylation status of a particular base within the sequence is determined by the addition of a molecule (i.e., a methylation probe) that binds to or interacts specifically with methylated bases. The methylation status may then be determined by analyzing electrical characteristics (e.g., resistance, current flow) of the molecular sensors. The interaction of the methylation probe with the methylated base may be transient or non-transient.

In some embodiments, the methylated bases may be chemically modified prior to detection in order to produce a characteristic electrical signal after hybridizing to the DNA probes. The methylation probes may be added to the target molecules before, during, or after the presentation of the sample to the molecular sensor or array of molecular sensors.

In some embodiments, the bridge molecule and the probe molecule may be the same molecule. In other embodiments, the bridge molecule and the probe molecule may be separate molecules linked together or otherwise forming a complex.

FIG. 49A through FIG. 56, the microfluidics system 100 including molecular sensors 192 for direct detection of single molecules may be used to detect specific DNA sequences and determine epigenetic modifications such as methylation of cytosine in CpG dinucleotides in a methylation marker detection assay.

FIG. 49A and FIG. 49B is schematic diagrams of an example, of a molecular sensor 192 of the microfluidics systems 100, 700. In this example, molecular sensor 192 may include a pair of contacts 1140 (contacts 1140a, 1140b) electrically coupled to a pair of electrodes 1142 (electrodes 1142a, 1142b), respectively. Electrodes 1142a, 1142b may be separated by a sensor gap 1144. Contacts 1140 may, for example, be grown using an electrodeposition process in which the time or intensity (i.e., electrical current) may be tuned to achieve a particular size of sensor gap 1144. For example, sensor gap 1144 may have a dimension from about 5 nm to about 30 nm. A bridge (or probe) molecule 1146 may be provided between contacts 1140a, 1140b, wherein bridge (or probe) molecule 1146 spans sensor gap 1144. In one example, molecular sensors 192 may be provided on the PCB-based bottom substrate 210 of droplet operations device 110. In another example, molecular sensors 192 may be provided on top substrate 212 of droplet operations device 110.

In one example, contacts 1140 and electrodes 1142 may be formed, for example, of a metal, such as platinum, palladium, rhodium, gold, or titanium. In one example, electrodes 1142 may be formed of the same material that that forms droplet operations electrodes 122 of droplet operations device 110.

In molecular sensor 192, the configuration of bridge (or probe) molecule 1146 between contacts 1140a, 1140b has electrical characteristics (e.g., resistance, current flow) that may be measurable. For example, the configuration of bridge (or probe) molecule 1146 between contacts 1140a, 1140b may have a resistance. The resistance of and/or the current flow through molecular sensor 192 may be measurable using, for example, detection system 172 shown in FIG. 1.

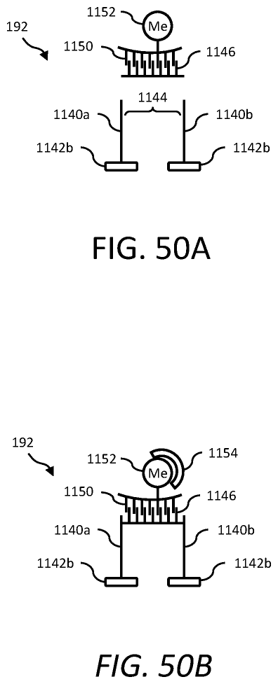

FIG. 50A and FIG. 50B is schematic diagrams showing an example of a process of using molecular sensor 192 shown in FIG. 49A and FIG. 49B. For example, FIG. 50A and FIG. 50B shows a process of using molecular sensor 192 to detect a methylation marker (e.g., methylated cytosine) in a targeted DNA sequence.

In this example, a sample droplet (not shown) that includes a DNA fragment 1150 (e.g., a ssDNA molecule) having a methylation marker (Me) 1152 is transported to molecular sensor 192. Then, DNA fragment 1150 may be immobilized on bridge (or probe) molecule 1146, as shown in FIG. 50A. For example, a hybridization reaction may be used to bind DNA fragment 1150 to bridge (or probe) molecule 1146.

Absent DNA fragment 1150, molecular sensor 192 may have a resistance or current measurement. However, hybridization of DNA fragment 1150 to bridge (or probe) molecule 1146 may be detected by a change in, for example, the resistance or current measurement of molecular sensor 192.

In a subsequent step shown in FIG. 50B, the methylation status of a particular base in DNA fragment 1150 may be determined. For example, a reagent droplet (not shown) that includes a methylation-specific probe 1154 may be transported to molecular sensor 192. Then, methylation-specific probe 1154 may bind to or interact specifically with methylation marker 1152. In one example, methylation-specific probe 1154 may be a methyl-binding protein (MBP). The methylation status may then be determined by analyzing a change in, for example, the resistance or current measurement of molecular sensor 192. The interaction of methylation-specific probe 1154 with methylation marker 1152 may be transient or non-transient.

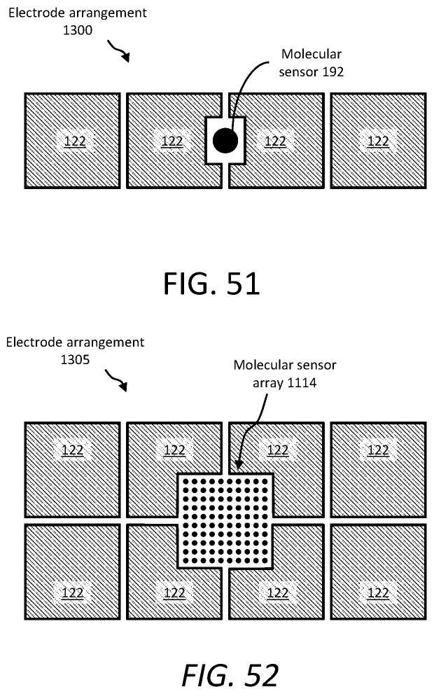

FIG. 51 is a plan view of an example of an electrode configuration 1300 that may include an arrangement of droplet operations electrodes 122 with respect to a single molecular sensor 192. In this example, a single molecular sensor 192 is placed along a line of droplet operations electrodes 122 such that a droplet (not shown) may be transported via droplet operations in direct contact with molecular sensor 192. In one example, an amount of clearance may be provided within adjacent droplet operations electrodes 122 to allow placement of molecular sensor 192. In another example, the molecular sensor 192 may be fitted in the space between two droplet operations electrodes 122.

FIG. 52 is a plan view of an example of an electrode configuration 1305 that may include an arrangement of droplet operations electrodes 122 with respect to an array of molecular sensors 192. In this example, an array of molecular sensors 192 (e.g., a molecular sensor array 1114) may be placed among an array of droplet operations electrodes 122 such that a droplet (not shown) may be transported via droplet operations in direct contact with molecular sensors 192 of molecular sensor array 1114. In this example, molecular sensor array 1114 may be a 1D array, such as a 1×n array, or a 2D array, such as any n×n array. Examples of 2D molecular sensor arrays 1114 may include a 144×144 array and a 300×300 array. Any molecular sensor array 1114 may include from about tens to about thousands of molecular sensors 192. An amount of clearance may be provided within nearby droplet operations electrodes 122 to allow placement of molecular sensor array 1114.

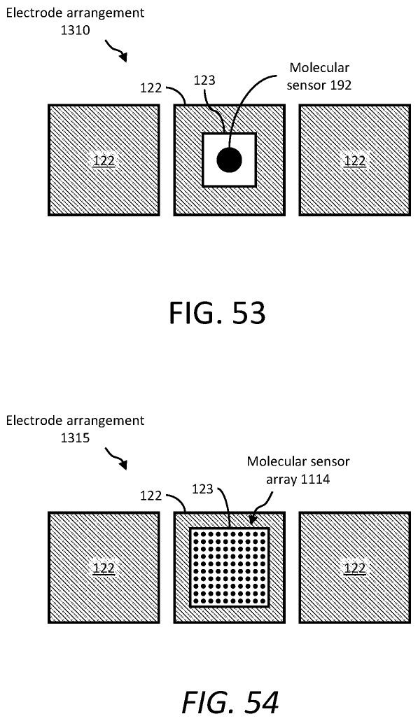

FIG. 53 is a plan view of an example of an electrode configuration 1310 that may include a single molecular sensor 192 arranged with respect to a single droplet operations electrode 122. In this example, a droplet operations electrode 122 has a clearance window or region 123. Then, a single molecular sensor 192 may be placed with this clearance window or region 123. A droplet (not shown) may be transported via droplet operations in direct contact with molecular sensor 192.

FIG. 54 is a plan view of an example of an electrode configuration 1315 that may include an array of molecular sensors 192 (e.g., a molecular sensor array 1114) with respect to a single droplet operations electrode 122. In this example, molecular sensor array 1114 may be a 1D array, such as a 1×n array, or a 2D array, such as any n×n array, placed within clearance window or region 123 of the droplet operations electrode 122. Here, any molecular sensor array 1114 may include from about tens to about thousands of molecular sensors 192. A droplet (not shown) may be transported via droplet operations in direct contact with molecular sensors 192 of molecular sensor array 1114.

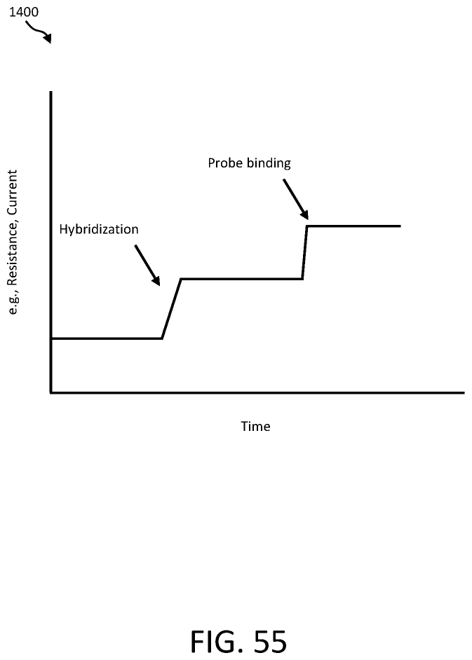

FIG. 55 is a plot 1400 showing an example of the electrical response of a molecular sensor 192 in a process of detecting a methylation marker (e.g., methylated cytosine) in a targeted DNA sequence as described with reference to FIG. 50A and FIG. 50B. In this example, determination of a hybridization event (i.e., binding of DNA fragment 1150 to bridge (or probe) molecule 1146) is made in a first step (“Hybridization”) and determination of a methylation-specific binding event (i.e., binding or interaction of methylation-specific probe 1154 to methylation marker 1152 of probe fragment 1150) is made in a second step (“Probe binding”). At each step, a change in electrical characteristics (e.g., resistance, current flow) of molecular sensor 192 may be detected. The ratio of methylated to unmethylated sequences can then be determined by counting the number of events and the ratio used to provide a determination on the methylation status of DNA fragment 1150.

### 6.9. Methylation Analysis Assays

The invention makes use of methylation-specific binding proteins (“reader” proteins) as probes to detect epigenetically modified cytosines at one or more targeted locations in a DNA sample (e.g., a cfDNA sample). A methylation-specific binding protein (reader protein) may, for example, be selected to bind hemi-methylated DNA or fully methylated DNA. The use of methylation-specific binding proteins to detected methylated cytosines obviates the need to perform chemical (e.g., bisulfite conversion) or enzymatic reactions typically performed to distinguish between methylated and unmethylated cytosines in a DNA sample.

Methylated DNA can be specifically recognized by a set of proteins referred to as methyl-binding proteins (MBPs) (Mahmood, N., and Rabbani, S. A., Oncology (2019) 9:489, which is incorporated herein by reference in its entirety). Proteins with methyl-CpG binding abilities are broadly classified into three families based on the functional domains used for binding to methylated DNA. For example, MBD-containing proteins are characterized by a conserved methyl-CpG-binding domain (MBD). Methyl-CpG binding zinc finger proteins are characterized by zinc finger motifs which allow them to bind both methylated and unmethylated DNA. SRA domain-containing proteins are characterized by a “SET- and RING-associated” (SRA) domain which recognizes hemi-methylated regions of DNA. The use of MBPs and/or specific domains (e.g., SAR and MDB domains) thereof for detection and determination of methylation status in DNA has been described (Taka, N., et aal., Analytical Letters (2018) DOI: 10.1080/00032719.2018.1533022; Unoki, M., et al., Oncogene (2004) 23:7601-7610; Frauer C., et al., PLoS ONE 6(6): e21306. doi:10.1371/journal.pone.0021306; Baba, Y., et al., Analytical Letters (2018) doi:10.1080/00032719.2018.1494739; and Yoshida, W. Y., et al., Analytical Chemistry 88 (18):9264-9268, doi:10.1021/acs.analchem.6b02565, which are incorporated herein by reference in their entirety).

In various embodiments, the invention provides a homogenous assay for methylation analysis of a DNA sample. The homogenous methylation analysis assay of the invention provides a simple mix and read out procedure for determining the methylation status of a DNA sample.

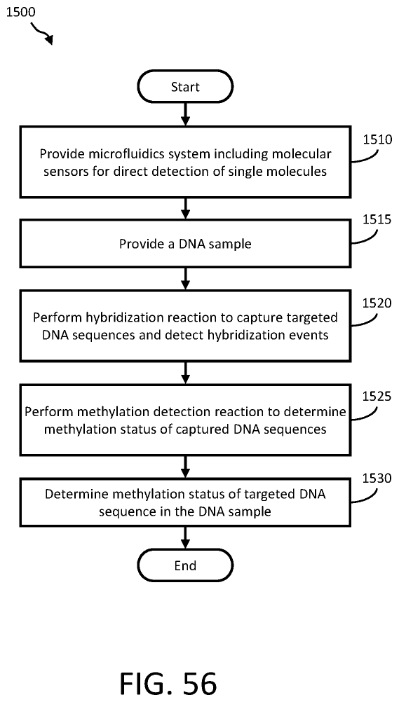

FIG. 56 is a flow diagram of an example of a methylation analysis workflow 1500 for determining the methylation status of a DNA sample using molecular sensors 192 of the microfluidics systems 100, 700. Methylation analysis workflow 1500 is an example of a method of using microfluidics systems 100, 700, droplet operations device 110, and/or molecular sensors 192 for direct detection of single molecules. Workflow 1500 may include, but is not limited to, the following steps.

At a step 1510, a microfluidics system including molecular sensors for the direct detection of single molecules is provided. For example, the microfluidics system 100 including molecular sensors 192 for the direct detection of single molecules is provided, as described herein with reference to FIG. 1 through FIG. 55.

At a step 1515, a DNA sample is provided. For example, a DNA sample (e.g., a cfDNA sample) is provided in a sample reservoir of droplet operations device 110 for subsequent dispensing and transporting to an array of molecular sensors 192 configured for performing a methylation detection assay. In this example, bridge (or probe) molecules 1146 of molecular sensors 192 may be ssDNA probe molecules that are specific for a single DNA target sequence of interest.

At a step 1520, a target-specific hybridization reaction is performed to capture the targeted DNA sequence of interest and detect a hybridization event. For example, a DNA sample droplet is dispensed and transported using droplet operations to the array of molecular sensors 192 and a hybridization reaction is performed. The hybridization reaction may include a denaturation step to produce single-stranded DNA molecules for hybridization to the ssDNA probe molecules (i.e., bridge (or probe) molecule 1146). A hybridization event may be detected by a change in electrical characteristics (e.g., resistance, current flow) of molecular sensors 192 and recorded for subsequent determination of the methylation status of the target sequence in the DNA sample.

At a step 1525, a methylation detection reaction is performed to detect methylated cytosines in the captured DNA sequences. For example, a reagent droplet that includes a methylation-specific probe for detection of methylated cytosines is transported to the array of molecular sensors 192. In one example, the methylation-specific probe includes an SRA domain which recognizes and binds hemi-methylated cytosine sites in DNA. A methylation probe binding event is detected by a change in electrical characteristics (e.g., resistance, current flow) of molecular sensors 192 and recorded for subsequent determination of the methylation status of the targeted sequence in the DNA sample.

At a step 1530, the methylation status of the targeted DNA sequence in the DNA sample is determined. For example, the number of hybridization events (i.e., step 1520) and the number of methylation probe binding events (i.e., step 1525) are counted and used to generate a ratio that can be used to provide a determination on the methylation status of the targeted DNA sequence.

In another embodiment, an array of molecular sensors 192 may be configured for performing a multiplexed methylation detection assay. For example, the array of molecular sensors 192 may include a panel of different ssDNA probe molecules that are specific for a plurality of different DNA target sequences of interest. In this embodiment, a DNA sample droplet may be dispensed and the process steps of method 1500 of FIG. 56 (i.e., steps 1520, 1525, and 1530) may be performed for each targeted sequence of interest to provide a comprehensive assessment of the methylation status of the DNA sample.

The microfluidics systems 100, 700, droplet operations device 110, molecular sensors 192, and/or methods such as methylation analysis workflow 1500, may, for example, be used for early detection of cancer.

### 6.10. DMF Device Including Both PCB Technology and Active-Matrix Technology

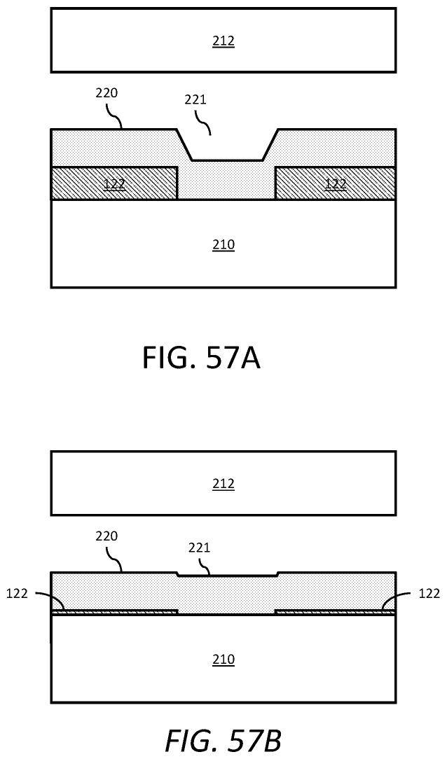

FIG. 57A and FIG. 57B are side views comparing the topology of PCB technology with active-matrix technology. In order to improve the reliability of DMF devices, such as droplet operations device 110 of microfluidics systems 100, 700, there exists a need for better control of features sizes and surface planarity. For example, FIG. 57A shows an example of DMF structure 200 that may be formed using PCB technology. In this example, dielectric layer 220 (e.g., parylene coating) and the metal forming droplet operations electrodes 122 may have about the same thickness (e.g., both about 5 μm thick). A step feature 221 (i.e., cross-sectional view) may occur in dielectric layer 220 at, for example, the gap between two droplet operations electrodes 122. In this example, step feature 221 may have about a 1:1 dielectric-to-metal ratio. The result is a droplet operations surface that may not be particularly planar and uniform and therefore lending to poor reliability of droplet operations. That is, the result may be channels, trenches, areas, regions, and/or steps that may have the deep 1:1 step feature 221 shown in FIG. 57A.

By contrast, a much more planar and uniform surface may be achieved by forming the electrode features from a deposited metal film that is substantially thinner than the dielectric. For example, FIG. 57B shows an example of DMF structure 200 that may be formed using active-matrix technology. In this example, the electrode features (e.g., droplet operations electrodes 122) may be formed in a metal layer, such as chromium (Cr), that may be about 0.1 μm thick while the dielectric layer (e.g., dielectric layer 220) may be a relatively thicker material, such as parylene, that may be about 5 μm thick. In this example, step feature 221 may have about a 50:1 dielectric-to-metal ratio. The result is a droplet operations surface that may be highly planar and uniform and therefore lending well to reliable droplet operations. That is, the result may be channels, trenches, areas, regions, and/or steps that may have the shallow 50:1 step feature 221 shown in FIG. 57B.

DMF devices fabricated using thin films on glass or silicon substrates may use either “active” or “passive” control. In passive control, the electrodes are driven using externally supplied voltages typically via contact pads. Such systems are passive in the sense that electrical control circuitry is not integrated with the DMF device. On the other hand, active devices combine the DMF control electrodes with circuitry on the same substrate. Importantly, active devices may incorporate a storage bit at each electrode location to store the current status (“on” or “off”) of each electrode so as to allow for row-column addressing schemes. This in turn reduces the number and complexity of electrical connections that must be made to the device. This enables greater quantity and independence of the electrodes to support more complicated and reconfigurable systems.

One potential limitation of active devices is that the circuitry used to generate and transmit the actuation voltages is often limited to, for example, from about 15V to about 20V. While operation at these relatively lower voltages is feasible it does narrow the available types and thicknesses of materials that may be used. This in turn may result in diminished reliability because thinner materials are less reliable than thicker materials owing to relative impact of small defects as well as the higher electric fields that are required for electrowetting (EW) actuation in thinner materials. Consequently, there may be a trade-off between the use of active control methods and device reliability. In fact, reduction in the EW force strength itself may reduce reliability by making droplet operations, such as splitting and dispensing, less consistent or by failing to overcome the trapping of droplets by small defects or imperfections on the DMF surface. In general, the greatest forces are required for any operation that creates new surface area, including especially droplet dispensing and droplet splitting. In some cases, the voltage required for these operations may be from about 2 to about 3 times greater than that required for droplet transport or merging. This translates to from about 4 to about 9 times greater EW forces.

In one aspect of the claimed invention, two different control systems may be combined to enable dispensing and splitting operations to be performed using higher voltages than are available in the active subsystems. For example, an array of electrodes for transporting and mixing droplets using active methods with up to about 20V may be provided and a separate set of passive electrodes on the same substrate may be controlled using externally supplied signals with a larger voltage (for example, up to about 100V). The subset of passive electrodes is selected based on the required function of each type of electrode. For example, dispenser electrodes are typically unique in their shape and location with respect to transport or array electrodes. These electrodes may be passively controlled using the higher voltages demanded for dispensing operations. Similarly, dedicated droplet splitters may be designed to accept the passively provided higher voltage signals.

In one embodiment, a large arbitrary number of array electrodes may be provided and controlled through an active matrix (e.g., the one or more TFT active matrixes 140). For example, using row-column addressing techniques, a 64×64 array can be controlled using a small number of input signals. The active matrix is combined with passive controls (16, 32, 64, 128 or more controls) capable of providing a voltage boost for dispense and split operations.

The use of active-matrix approaches enables greater reliability and performance than PCB-based approaches through several different mechanisms, including:
(i) Active-matrix devices have much tighter control over feature dimensions and layer thicknesses than is possible using PCB-based manufacturing approaches, which results in more consistent device operation with fewer defects. Importantly, small defects or irregularities tend to magnify non-idealities such as inhomogeneous electrical fields.
(ii) Active-matrix devices are capable of performing sensing directly at each electrode location. For example, impedance sensors or photodiodes located underneath droplet operations electrodes may be used to detect the presence or absence of a droplet at that particular electrode position. This can be used to detect and even recover from faults or errors that would not otherwise be detected in passive PCB-based devices.
(iii) Active-matrix devices on glass or silicon substrates have a much wider range of materials available for dielectrics, surface coatings, and so on, compared with PCB-based devices. Devices fabricated on PCB and similar lower cost substrates are limited with respect to the temperatures they can withstand which in turn limits the types of materials and deposition technologies than be used. For example, processes, such as PECVD, are only compatible with materials and substrate that can withstand high temperatures.

Even given all of these advantages of active-matrix glass and silicon devices over PCB-based devices, PCB remains less expensive on the basis of cost per unit area.

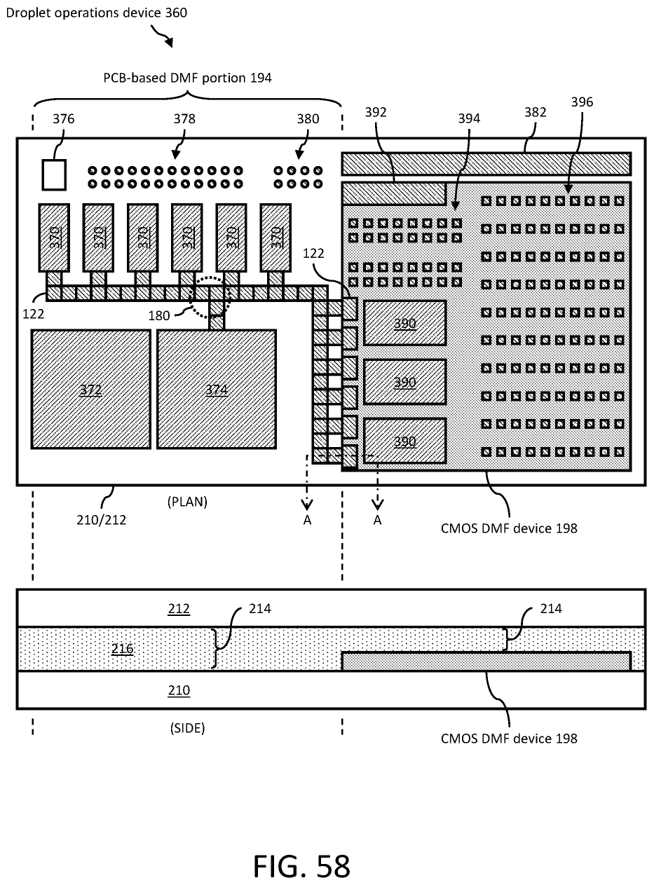

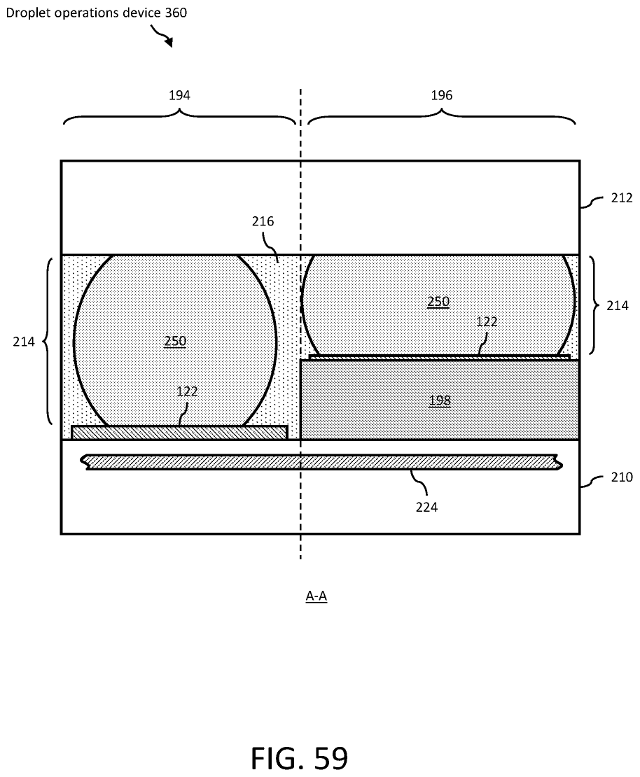

FIG. 58 is a plan view and a side view of a specific example of a droplet operations device 360 including both PCB-based DMF 194 and CMOS DMF device 198, which is an example of active matrix-based DMF 196. FIG. 59 shows a cross-sectional view taken along ling A-A of droplet operations device 360 shown in FIG. 58. Droplet operations device 360 may be one example of droplet operations device 110 shown in FIG. 1 and FIG. 2.

Droplet operations device 360 may be formed substantially using the DMF structure 200 shown in FIG. 3A and FIG. 3B. For example, droplet operations device 360 may include the PCB-based bottom substrate 210 and top substrate 212. An electrode arrangement of droplet operations device 360 may include multiple liquid reagent reservoirs 370, an oil storage reservoir 372, and a sample port reservoir 374 that may be fluidly connected via various lines or paths of droplet operations electrodes 122. A magnet 180 may be provided with respect to droplet operations electrodes 122 of droplet operations device 360. droplet operations device 360 may include an EEPROM 376, a set of high voltage (HV) EW pads 378, a set of digital pads 380, and a waste reservoir 382.

Droplet operations device 360 may include a CMOS DMF device 198 mounted atop the PCB-based bottom substrate 210. CMOS DMF device 198 is one example of active matrix-based DMF 196 of droplet operations device 360, while everything outside of CMOS DMF device 198 may be considered the PCB-based DMF 194 of droplet operations device 360. In one example, the overall dimensions of droplet operations device 360 may be about 25 mm×about 50 mm, while CMOS DMF device 198 may be about 22 mm square.

CMOS DMF device 198 may be formed via active-matrix technology. In one example, CMOS DMF device 198 may include any arrangements of droplet operations electrodes 122. For example, droplet operations electrodes 122 may be provided along the edge of CMOS DMF device 198 that substantially align with droplet operations electrodes 122 of PCB-based DMF 194. CMOS DMF device 198 may include input reservoirs 390 and a waste electrode 392. Waste electrode 392 may be used to offload liquid from CMOS DMF device 198 to waste reservoir 382 of PCB-based DMF 194. CMOS DMF device 198 may include a set of EW pads 394 as well as other input/output (I/O) pads 396.

FIG. 59 shows that bottom substrate 210 of droplet operations device 360 may include a wiring layer 224 for providing electrical connections between PCB-based DMF 194 and CMOS DMF device 198. CMOS DMF device 198 may be mounted to bottom substrate 210 by any conventional means, such as ball grid array (BGA) technology.

Droplet operations device 360 demonstrates one example of the hybrid approach that combines the advantages of both CMOS (i.e., active-matrix technology) and PCB technology. For example, PCB-based DMF 194 of droplet operations device 360 may be used for gross fluid manipulation and sample/reagent delivery while CMOS DMF device 198 of droplet operations device 360 may be used for fine fluid manipulation and execution of complex assay protocols. For example, PCB-based DMF 194 may be used to deliver various liquids or reagents to fluidic input reservoirs 390 of CMOS DMF device 198. Precise dispensing or aliquoting is performed on CMOS DMF device 198 so that the precision required of PCB-based DMF 194 may be greatly reduced. PCB-based DMF 194 may be only required to ensure that the amount of liquid in input reservoirs 390 of CMOS DMF device 198 is maintained between a minimum and a maximum volume. The requirement to store and have continual access to relatively large liquid volumes (i.e., 10's to 100's μL) potentially consumes large amounts of chip real-estate (i.e., several cm²) so that shifting this functionality to PCB-based DMF 194 reduces the required size of CMOS DMF device 198 and therefore the cost of the entire device as CMOS real-estate may be from about 10- to about 100-fold more expensive than PCB real-estate.

In one example, CMOS DMF device 198 may include unit-sized droplet operations electrodes 122 that may be about 500 μm square and with a gap spacing of about 150 μm (see FIG. 59). By contrast, PCB-based DMF 194 may include droplet operations electrodes 122 that may be about 1 mm square and with gap spacing of about 300 μm (see FIG. 59). Therefore, a unit droplet on PCB-based DMF 194 may be about 240 nL in volume while a unit droplet on CMOS DMF device 198 may be about 30 nL n volume. Therefore, each gross droplet delivered by PCB-based DMF 194 to CMOS DMF device 198 can be finely subdivided in 8 precisely dispensed droplets. The input reservoirs 390 of CMOS DMF device 198 should be sized to accommodate, for example, any volume from about 0 nL to about 500 nL. the precision of the droplets dispensed on CMOS DMF device 198 does not depend on the precision of the droplets dispensed at PCB-based DMF 194.

“Refilling” of the input reservoirs 390 of CMOS DMF device 198 may be performed using a variety of different approaches. In one approach, a simple accounting may be performed wherein after a number of droplets have been dispensed from the input reservoir 390 of CMOS DMF device 198, then the input reservoir 390 is reloaded with a droplet from PCB-based DMF 194. This approach works well when the total number reloading cycles is relatively small. However, if numerous reloads are required then the lack of precision or accuracy of the PCB dispensed droplets may lead to an accumulation of errors that leaves the input reservoir 390 of CMOS DMF device 198 either under-filled or over-filled. In contrast to this “blind” approach the fluid level within the input reservoir 390 of CMOS DMF device 198 may be actively monitored so that a “refill” is only performed when the actual liquid level drops below a threshold.

In one embodiment, this monitoring may be performed using impedance sensing (e.g., sensing circuitry 162 shown in FIG. 1 and/or sensing mechanisms 126 shown in FIG. 2) to determine either the total volume or the extent of liquid within the input reservoir 390 of CMOS DMF device 198. For example, there may be an impedance detector located away from the dispenser which when covered by liquid indicates that the input reservoir 390 is “full” and should not be refilled further until the liquid recedes past this point. In another embodiment, the liquid level may be measured optically either using imaging to determine the total volume or using photodetectors arranged to indicate whether the liquid is spread beyond a predetermined extent. In yet another embodiment, a conductivity sensor may be used to indicate whether the liquid is spread beyond a predetermined extent. In still another embodiment, a thermal sensor that detects differences in thermal conductivity may be used to indicate whether the liquid has spread beyond a predetermined extent.

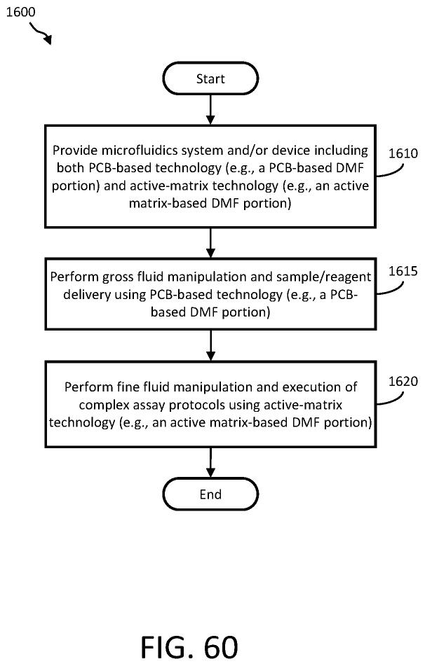

FIG. 60 is a flow diagram of an example of a method 1600 of using the microfluidics system 100 and droplet operations device 110 including active-matrix technology for improved reliability and performance. Method 1600 may include, but is not limited to, the following steps.

At a step 1610, a microfluidics system and/or device including both PCB-based technology (e.g., a PCB-based DMF portion) and active-matrix technology (e.g., an active matrix-based DMF portion) is provided. For example, and FIG. 1 through FIG. 59, microfluidics system 100 may be provided including droplet operations device 110 that further includes both PCB-based DMF 194 and active matrix-based DMF 196 (e.g., CMOS DMF device 198).

At a step 1615, gross fluid manipulation and sample/reagent delivery is performed using the PCB-based technology (e.g., a PCB-based DMF portion). For example, at droplet operations device 110, gross fluid manipulation and sample/reagent delivery may be performed using PCB-based DMF 194.

At a step 1620, fine fluid manipulation and execution of complex assay protocols is performed using the active-matrix technology (e.g., an active matrix-based DMF portion). For example, at droplet operations device 110, fine fluid manipulation and execution of complex assay protocols may be performed using active matrix-based DMF 196 (e.g., CMOS DMF device 198).

### 6.11. Integration of CMOS Sensors with Droplet Operations Devices

The disclosure provides methods of integrating a CMOS-based sensor with a droplet operations device, such as the aforementioned droplet operations device 110 of microfluidics systems 100, 700. In some embodiments, both the DMF and CMOS components may be fabricated in a common process on a common die (i.e., monolithic integration). However, in other embodiments, it may be advantageous to fabricate the DMF and CMOS components using separate processes, techniques, and materials. Then, after fabrication integrate them in a final packaging step. For example, CMOS may preferably be fabricated on a silicon die and the DMF device may preferably be fabricated on a glass die.

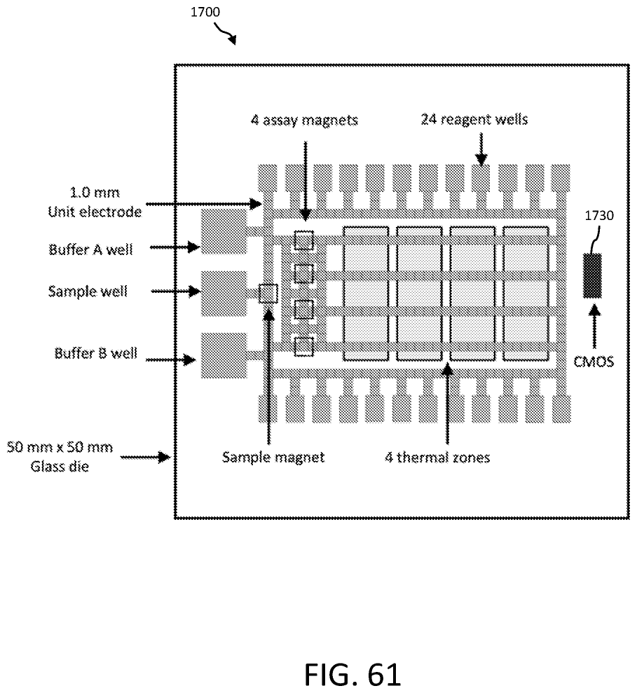

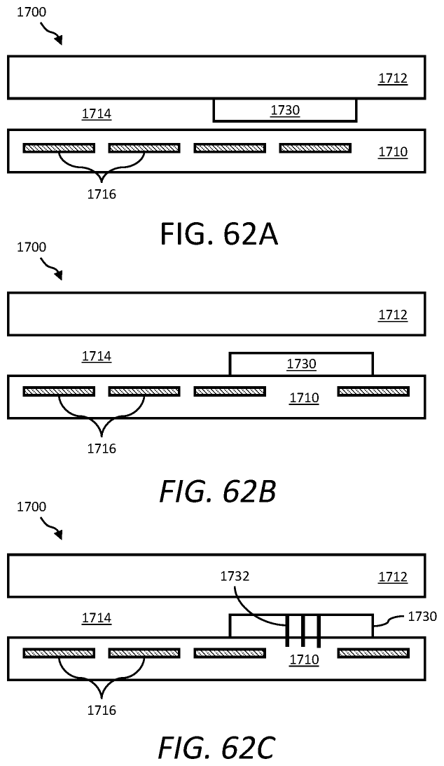

By way of example, FIG. 61 is a plan view of an example of droplet operations device 1700 combined with a CMOS sensor 1730. In this example, the DMF of droplet operations device 1700 performs sample preparation steps and then delivers the final sample to CMOS sensor 1730 for detection/analysis. FIG. 62A, FIG. 62B, and FIG. 62C is side views of example methods of integrating droplet operations device 1700 and CMOS sensor 1730. In these examples, droplet operations device 1700 may include a bottom substrate 1710 and a top substrate 1712 separated by a droplet operations gap 1714. Bottom substrate 1710 may include an arrangement of droplet operations electrodes 1716.

In FIG. 62A, CMOS sensor 1730 may be mounted on top substrate 1712 which is opposite the droplet operations electrodes 1716. Droplet operations electrodes 1716 deliver the sample liquid (not shown) into the relatively narrower gap formed between CMOS sensor 1730 and bottom substrate 1710. Wires (not shown) for connecting to CMOS sensor 1730 are provided in a region that is outside of the DMF processing area. These wires may connect to either the bottom substrate 1710 or top substrate 1712.

In FIG. 62B, CMOS sensor 1730 and droplet operations electrodes 1716 are provided on the same substrate, which is bottom substrate 1710. In this example, CMOS sensor 1730 potentially interferes with the operation of droplet operations electrodes 1716, which must be moved to the periphery of CMOS sensor 1730 for loading and unloading of liquid across the face of CMOS sensor 1730.

In FIG. 62C, CMOS sensor 1730 may be mounted on bottom substrate 1710 that has the droplet operations electrodes 1716, but electrical connections 1732 are made through the CMOS sensor 1730 to bottom substrate 1710.

1. A droplet manipulation device comprising:
a) a first substrate comprising:
i) a first layer comprising a first array of electrowetting electrodes and a printed circuit board; and
ii) a second layer superior to a region of the first layer, wherein the second layer comprises a second array of electrowetting electrodes and a semiconductor layer; and
b) a second substrate separated from the first substrate, forming a droplet operations gap between the first substrate and the second substrate.

2. (canceled)

3. (canceled)

4. (canceled)

5. The droplet manipulation device of claim 1, wherein the semiconductor layer comprises a CMOS layer.

6. (canceled)

7. (canceled)

8. (canceled)

9. (canceled)

10. (canceled)

11. (canceled)

12. The droplet manipulation device of claim 1, wherein the first array of electrowetting electrodes is larger than the second array of electrowetting electrodes.

13. The droplet manipulation device of claim 12, wherein the first array of electrowetting electrodes is at least about 1.5 times larger than the second array of electrowetting electrodes.

14. (canceled)

15. (canceled)

16. The droplet manipulation device of claim 1, wherein the first array of electrowetting electrodes comprises thin-film transistors.

17. (canceled)

18. (canceled)

19. The droplet manipulation device of claim 5, wherein the CMOS layer comprises an array of nanofeatures.

20. The droplet manipulation device of claim 19, wherein the nanofeatures of the array of nanofeatures are selected from the group consisting of indentations, wells, protrusions, domes, posts, beads, beads-in-wells, spots, hydrophilic spots, and any combination thereof.

21. The droplet manipulation device of claim 19, wherein the nanofeatures of the array of nanofeatures comprises nanowells.

22. The droplet manipulation device of claim 19, wherein the nanofeatures of the array of nanofeatures comprises nanoposts overlapping an array of nanowells.

23. The droplet manipulation device of claim 22, wherein the array of nanofeatures comprises one or more hydrophilic guiding features or hydrophilic wicking features arranged to assist in transporting aqueous media from the array of nanowells.

24. The droplet manipulation device of claim 19, wherein the array of nanofeatures comprises at least 1,000 nanofeatures.

25. (canceled)

26. The droplet manipulation device of claim 19, wherein the array of nanofeatures comprises at least 100,000 nanofeatures.

27. (canceled)

28. The droplet manipulation device of claim 19, wherein
the array of nanofeatures comprises wells, wherein
each of the wells is capable of holding from about one femtoliter to about 10 picoliters of liquid.

29. The droplet manipulation device of claim 19, wherein a nanofeature of the array of nanofeatures is associated with a sensor, wherein the sensor is fabricated in the second layer.

30. The droplet manipulation device of claim 19, wherein
a nanofeature of the array of nanofeatures comprises a well, wherein
the well is associated with a sensor, wherein a sensor is fabricated in the second layer.

31. (canceled)

32. (canceled)

33. (canceled)

34. (canceled)

35. (canceled)

36. (canceled)

37. (canceled)

38. (canceled)

39. A molecular sensor for direct detection of a single molecule target, the molecular sensor comprising a substrate surface comprising:
a) a first contact electrically coupled to a first electrode; and
b) a second contact electrically coupled to a second electrode;
wherein (i) the first and second electrodes are separated by a sensor gap, and (ii) the sensor gap is spanned by a bridge molecule such that interaction of the bridge molecule with the single molecule target generates a detectable electrical signal, and
wherein the substrate surface comprises a digital microfluidic device.

40. (canceled)

41. (canceled)

42. (canceled)

43. (canceled)

44. (canceled)

45. The molecular sensor of claim 39, wherein the bridge molecule comprises a protein, wherein the protein comprises an alpha helix protein, and wherein the protein is attached to the first and second contacts through an antigen-antibody linkage or through a streptavidin-biotin linkage.

46. (canceled)

47. (canceled)

48. (canceled)

49. The molecular sensor of claim 39, wherein the bridge molecule comprises a biopolymer, wherein the biopolymer comprises double-stranded DNA, and wherein the double-stranded DNA is attached to the first and second contacts through a thiol-gold linkage.

50. (canceled)

51. (canceled)

52. The molecular sensor of claim 39, wherein the bridge molecule comprises a probe molecule that is specific for the single molecule target and wherein the probe molecule comprises a molecule that exhibits a change in physical, chemical, and/or electrical properties in response to binding the single molecule target.

53. (canceled)

54. (canceled)

55. The molecular sensor of claim 52, wherein the probe molecule is a single-stranded nucleic acid molecule, and wherein the nucleic acid molecule is a DNA molecule.

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)
